(19) United States
(12) Patent Application Publication
(10) Pub. No.: US 2019/0297887 A1
(43) Pub. Date: Oct. 3, 2019

(54) BICYCLIC COMPOUNDS AS PESTICIDES

(71) Applicant: Bayer CropScience Aktiengesellschaft, Monheim am Rhein (DE)

(72) Inventors: Peter JESCHKE, Bergisch Gladbach (DE); Silvia CEREZO-GALVEZ, Langenfeld (DE); Martin FUESSLEIN, Duesseldorf (DE); Kerstin ILG, Koeln (DE); Daniela PORTZ, Vettweiss (DE); Peter LOESEL, Leverkusen (DE); Donald BIERER, Haan (DE); Robert Alan WEBSTER, Lyon (FR)

(21) Appl. No.: 16/316,455

(22) PCT Filed: Jul. 10, 2017
(86) PCT No.: PCT/EP2017/067202

§ 371 Date: Jan. 9, 2019

(30) Foreign Application Priority Data
Jul. 12, 2016 (EP) 16179030.8

(51) Int. Cl. A01N 43/56; A01N 43/707; A01N 43/653; A01N 43/90

(52) U.S. Cl. CPC A01N 43/56; A01N 43/90; A01N 43/653; A01N 43/707

(57) ABSTRACT

The present application relates to novel bicyclic compounds, to compositions comprising these compounds, to the use thereof for control of animal pests and to processes and intermediates for the preparation thereof.

The present application relates to novel bicyclic compounds, to compositions comprising these compounds, to their use for controlling animal pests and to processes and intermediates for their preparation.

There are already known bicyclic compounds that have insecticidal properties (WO 2015/038503 A1, WO 2016/087363 A1, WO 2016/087368 A1, WO 2016/087421 A1, WO 2016/087422 A1).

Modern crop protection compositions have to meet many demands, for example in relation to extent, persistence and spectrum of their action and possible use. Questions of toxicity and of combinability with other active ingredients or formulation auxiliaries play a role, as does the question of the cost and complexity involved in the synthesis of an active ingredient. In addition, resistances can occur. For all these reasons alone, the search for novel crop protection compositions cannot be considered complete, and there is a constant need for novel compounds having improved properties compared to the known compounds, at least in relation to individual aspects.

It was an object of the present invention to provide compounds which widen the spectrum of the pesticides under various aspects.

The object, and further objects which are not stated explicitly but can be discerned or derived from the connections discussed herein, are achieved by compounds of the formula (I)

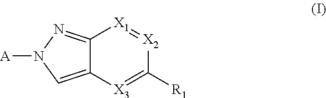

in which
A is an A radical from the group of (A-b) to (A-f)

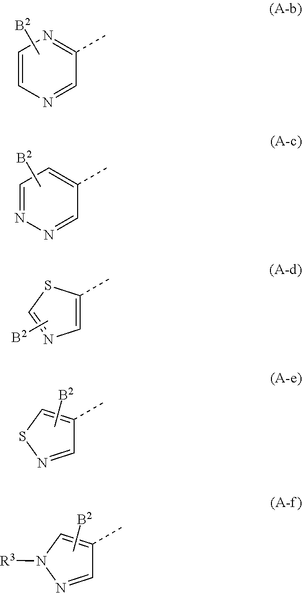

in which the broken line denotes the bond to the carbon atom of the bicyclic system of the formula (I) and
B² is a radical from the group of hydrogen, halogen, cyano, nitro, alkyl, haloalkyl, alkoxy, haloalkoxy and in each case optionally substituted cycloalkyl and cycloalkenyl,
X₁ is nitrogen (N) or CH,
X₂ is nitrogen or CH,
X₃ is nitrogen or CH, where either none or only one of the variables X₁, X₂ and X₃ is nitrogen,
R₁ is a B radical from the group of

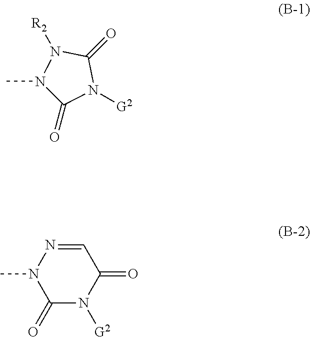

in which the broken line denotes the bond to the carbon atom of the bicyclic system of the formula (I),
R₂ is a radical from the group of hydrogen, alkyl, haloalkyl, alkenyl, alkynyl, alkoxyalkyl, alkyl-S-alkyl, alkyl-S(O)-alkyl, alkyl-S(O)₂-alkyl, cycloalkyl, halocycloalkyl and cycloalkenyl,
G² is a radical from the group of hydrogen, alkyl, haloalkyl, alkenyl, alkynyl, alkoxyalkyl, alkyl-S-alkyl, alkyl-S(O)-alkyl, alkyl-S(O)₂-alkyl, cycloalkyl, halocycloalkyl, cycloalkenyl, halocycloalkenyl, cycloalkylalkyl, cycloalkenylalkyl, halocycloalkenylalkyl and in each case optionally substituted aryl, arylalkyl, pyridyl and pyridylalkyl,
   and compounds of the formula (I) in which
A is the radical (A-a)

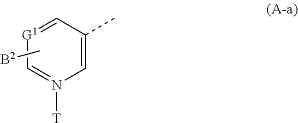

in which the broken line denotes the bond to the carbon atom of the bicyclic system of the formula (I) and
G¹ is N or C—B¹,
B¹ is a radical from the group of hydrogen, halogen, cyano, nitro, alkyl, haloalkyl, alkoxy, haloalkoxy and in each case optionally substituted cycloalkyl and cycloalkenyl,
B² is a radical from the group of hydrogen, halogen, cyano, nitro, alkyl, haloalkyl, alkoxy, haloalkoxy and in each case optionally substituted cycloalkyl and cycloalkenyl,
T is oxygen or an electron pair,
X₁ is nitrogen or CH,
X₂ is nitrogen or CH,
X₃ is nitrogen or CH, where either none or only one of the variables X₁, X₂ and X₃ is nitrogen,
R₁ is one of the following B radicals:

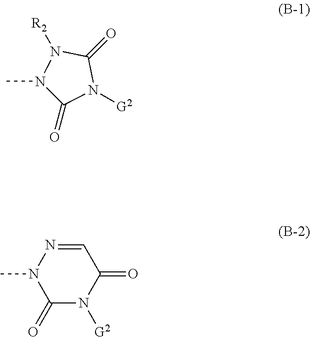

in which the broken line denotes the bond to the carbon atom of the bicyclic system of the formula (I) in which
R₂ is a radical from the group of hydrogen, alkyl, haloalkyl, alkenyl, alkynyl, alkoxyalkyl, alkyl-S-alkyl, alkyl-S(O)-alkyl, alkyl-S(O)₂-alkyl, cycloalkyl, halocycloalkyl and cycloalkenyl,
G² is a radical from the group of hydrogen, alkyl, haloalkyl, alkenyl, alkynyl, alkoxyalkyl, alkyl-S-alkyl, alkyl-S(O)-alkyl, alkyl-S(O)₂-alkyl, cycloalkyl, halocycloalkyl, cycloalkenyl, halocycloalkenyl, cycloalkylalkyl, cycloalkenylalkyl, halocycloalkenylalkyl and in each case optionally substituted aryl, arylalkyl, pyridyl and pyridylalkyl.

It has been additionally found that the compounds of the formula (I) have good efficacy as pesticides, for example against arthropods and especially insects, and additionally generally have very good compatibility with plants, especially crop plants, and/or have favourable toxicological and/or favourable environmentally relevant properties.

Range of preference (1): Preference is given to compounds of the formula (I) in which
A is one of the following A radicals:

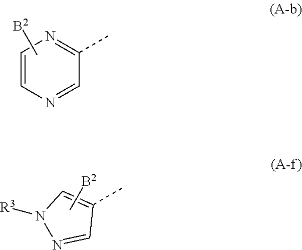

in which the broken line denotes the bond to the carbon atom of the bicyclic system of the formula (I), and
B² is a radical from the group of hydrogen, halogen, C₁-C₆-alkyl and C₁-C₄-haloalkyl,
X₁ is CH,
X₂ is CH,
X₃ is CH,
R₁ is one of the following B radicals:

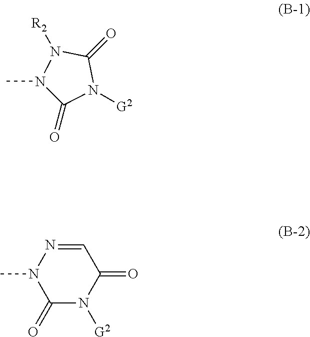

in which the broken line denotes the bond to the carbon atom of the bicyclic system of the formula (I) in which
R₂ is hydrogen or C₁-C₆-alkyl,
G² is a radical from the group of hydrogen, C₁-C₆-alkyl, halo-C₁-C₆-alkyl, C₃-C₆-cycloalkyl, halo-C₃-C₆-cycloalkyl, C₃-C₆-cycloalkenyl, halo-C₃-C₆-cycloalkenyl, phenyl or benzyl (where phenyl and benzyl themselves may in turn be substituted by halogen, cyano, nitro, C₁-C₆-alkyl, halo-C₁-C₆-alkyl and C₃-C₆-cycloalkyl), pyridyl or pyridylmethyl (where pyridyl and pyridylmethyl themselves may in turn be substituted by halogen, cyano, nitro, C₁-C₆-alkyl, halo-C₁-C₆-alkyl and C₃-C₆-cycloalkyl), and
   compounds of the formula (I) in which
A is the following A radical:

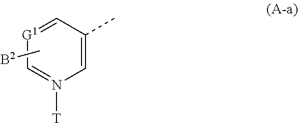

in which the broken line denotes the bond to the carbon atom of the bicyclic system of the formula (I), and
G¹ is N or C—B¹,
B¹ is a radical from the group of hydrogen, halogen, C₁-C₆-alkyl and C₁-C₄-haloalkyl,
B² is a radical from the group of hydrogen, halogen, C₁-C₆-alkyl and C₁-C₄-haloalkyl,
T is oxygen or an electron pair,
X₁ is CH,
X₂ is CH,
X₃ is CH,
R₁ is one of the following B radicals:

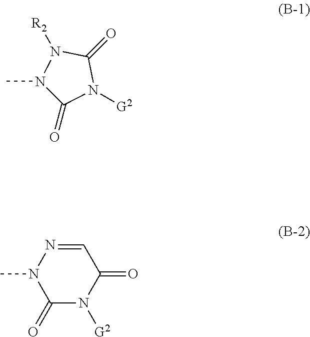

where the broken line denotes the bond to the carbon atom of the bicyclic system of the formula (I), where
R₂ is hydrogen or C₁-C₆-alkyl,
G² is a radical from the group of hydrogen, C₁-C₆-alkyl, halo-C₁-C₆-alkyl, C₃-C₆-cycloalkyl, halo-C₃-C₆-cycloalkyl, C₃-C₆-cycloalkenyl, halo-C₃-C₆-cycloalkenyl, phenyl or benzyl (where phenyl and benzyl themselves may in turn be substituted by halogen, cyano, nitro, C₁-C₆-alkyl, halo-C₁-C₆-alkyl and C₃-C₆-cycloalkyl), pyridyl or pyridylmethyl (where pyridyl and pyridylmethyl themselves may in turn be substituted by halogen, cyano, nitro, C₁-C₆-alkyl, halo-C₁-C₆-alkyl and C₃-C₆-cycloalkyl).

Range of preference (2): Particular preference is given to compounds of the formula (I) in which
A is an A radical from the group of (A-b) and (A-f)

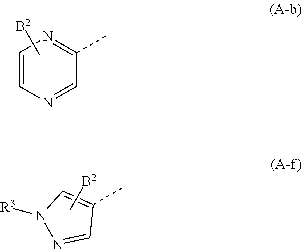

in which the broken line denotes the bond to the carbon atom of the bicyclic system of the formula (I),
B² is a radical from the group of hydrogen, halogen, C₁-C₆-alkyl and C₁-C₄-haloalkyl,
X₁ is CH,
X₂ is CH,
X₃ is CH,
R₁ is a B radical from the group of

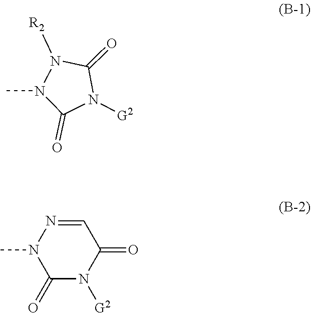

in which the broken line denotes the bond to the carbon atom of the bicyclic system of the formula (I) in which
R₂ is hydrogen or C₁-C₆-alkyl,
G² is a radical from the group of hydrogen, C₁-C₆-alkyl, halo-C₁-C₆-alkyl, C₃-C₆-cycloalkyl, halo-C₃-C₆-cycloalkyl, C₃-C₆-cycloalkenyl and halo-C₃-C₆-cycloalkenyl, and compounds of the formula (I) in which
A is the A radical

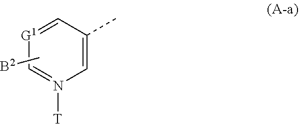

in which the broken line denotes the bond to the carbon atom of the bicyclic system of the formula (I),
G¹ is N or C—B¹,
B¹ is a radical from the group of hydrogen, halogen, C₁-C₆-alkyl and C₁-C₄-haloalkyl,
B² is a radical from the group of hydrogen, halogen, C₁-C₆-alkyl and C₁-C₄-haloalkyl,
T is oxygen or an electron pair,
X₁ is CH,
X₂ is CH,
X₃ is CH,
R₁ is a B radical from the group of

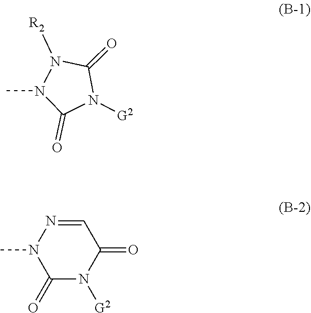

where the broken line denotes the bond to the carbon atom of the bicyclic system of the formula (I), where
R₂ is hydrogen or C₁-C₆-alkyl,
G² is a radical from the group of hydrogen, C₁-C₆-alkyl, halo-C₁-C₆-alkyl, C₃-C₆-cycloalkyl, halo-C₃-C₆-cycloalkyl, C₃-C₆-cycloalkenyl and halo-C₃-C₆-cycloalkenyl.

Range of preference (3): Very particular preference is given to compounds of the formula (I) in which
A is one of the following A radicals:

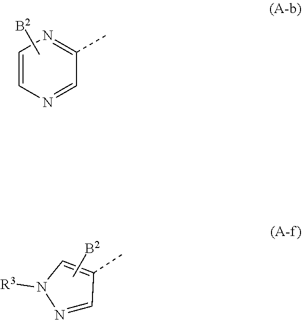

in which the broken line denotes the bond to the carbon atom of the bicyclic system of the formula (I),
B² is hydrogen,
X₁ is CH,
X₂ is CH,
X₃ is CH,
R₁ is a B radical from the group of

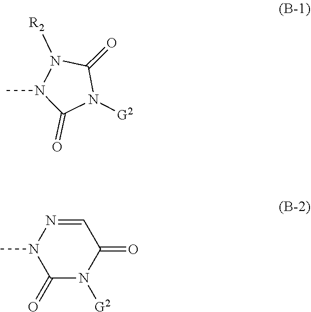

in which the broken line denotes the bond to the carbon atom of the bicyclic system of the formula (I) in which
R₂ is hydrogen or C₁-C₆-alkyl,
G² is a radical from the group of hydrogen, C₁-C₆-alkyl, halo-C₁-C₆-alkyl and C₃-C₆-cycloalkyl, and
   compounds of the formula (I) in which
A is the A radical

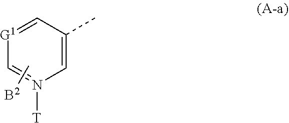

in which the broken line denotes the bond to the carbon atom of the bicyclic system of the formula (I),
G¹ is N or C—B¹,
B¹ is a radical from the group of hydrogen and fluorine,
B² is hydrogen,
T is oxygen or an electron pair,
X₁ is CH,
X₂ is CH,
X₃ is CH,
R₁ is a B radical from the group of

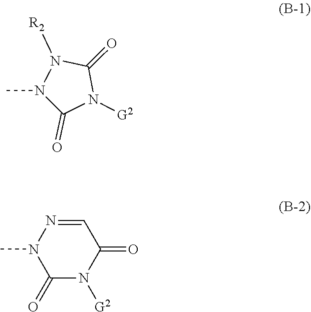

where the broken line denotes the bond to the carbon atom of the bicyclic system of the formula (I), where
R₂ is hydrogen or C₁-C₆-alkyl,
G² is a radical from the group of hydrogen, C₁-C₆-alkyl, halo-C₁-C₆-alkyl and C₃-C₆-cycloalkyl.

Range of preference (4): A particular group of compounds of the formula (I) is that of those in which
A is

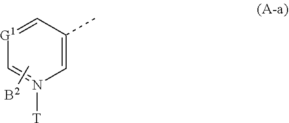

in which the broken line denotes the bond to the carbon atom of the bicyclic system of the formula (I),
G¹ is C—B¹,
B¹ is hydrogen or fluorine,
B² is hydrogen,
T is an electron pair,
X₁ is CH,
X₂ is CH,
X₃ is CH,
R₁ is the (B-1) radical

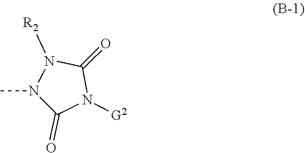

in which the broken line denotes the bond to the carbon atom of the bicyclic system of the formula (I) in which
R₂ is hydrogen or C₁-C₆-alkyl and
G² is a radical from the group of hydrogen, C₁-C₆-alkyl, halo-C₁-C₆-alkyl and C₃-C₆-cycloalkyl.

Range of preference (5): A further particular group of compounds of the formula (I) is that of those in which
A is the A radical

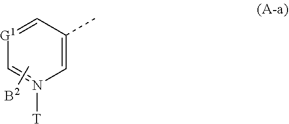

in which the broken line denotes the bond to the carbon atom of the bicyclic system of the formula (I),
G¹ is N or C—B¹,
B¹ is hydrogen or fluorine,
B² is hydrogen,
T is an electron pair,
X₁ is CH,
X₂ is CH,
X₃ is CH,
R₁ is the (B-2) radical

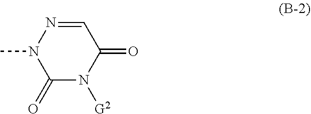

where the broken line denotes the bond to the carbon atom of the bicyclic system of the formula (I), where
G² is a radical from the group of hydrogen, C₁-C₆-alkyl, halo-C₁-C₆-alkyl and C₃-C₆-cycloalkyl.

Range of preference (1a): Preferred compounds of the formula (I) are also those in which
A is one of the following A radicals:

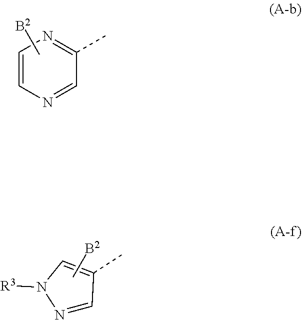

in which the broken line denotes the bond to the carbon atom of the bicyclic system of the formula (I), and
B² is a radical from the group of hydrogen, halogen, C₁-C₆-alkyl and C₁-C₄-haloalkyl,
X₁ is CH,
X₂ is CH,
X₃ is CH,
R₁ is one of the following B radicals:

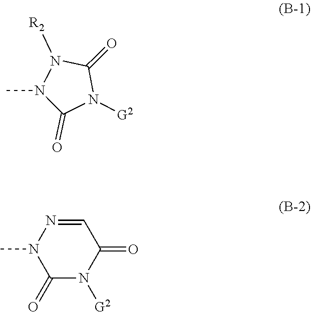

where the broken line denotes the bond to the carbon atom of the bicyclic system of the formula (I), where
R₂ is hydrogen or C₁-C₆-alkyl,
G² is a radical from the group of hydrogen, C₁-C₆-alkyl, halo-C₁-C₆-alkyl, C₃-C₆-cycloalkyl, halo-C₃-C₆-cycloalkyl, C₃-C₆-cycloalkenyl, halo-C₃-C₆-cycloalkenyl, phenyl or benzyl (where phenyl and benzyl themselves may in turn be substituted by halogen, cyano, nitro, C₁-C₆-alkyl, halo-C₁-C₆-alkyl and C₃-C₆-cycloalkyl), pyridyl or pyridylmethyl (where pyridyl and pyridylmethyl themselves may in turn be substituted by halogen, cyano, nitro, C₁-C₆-alkyl, halo-C₁-C₆-alkyl and C₃-C₆-cycloalkyl), and

compounds of the formula (I) in which
A is the following A radical:

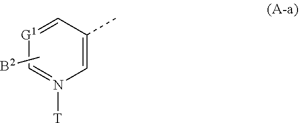

in which the broken line denotes the bond to the carbon atom of the bicyclic system of the formula (I), and
G¹ is N or C—B¹,
B¹ is a radical from the group of hydrogen, halogen, C₁-C₆-alkyl and C₁-C₄-haloalkyl,
B² is a radical from the group of hydrogen, halogen, C₁-C₆-alkyl and C₁-C₄-haloalkyl,
T is oxygen or an electron pair,
X₁ is N or CH,
X₂ is CH,
X₃ is CH,
R₁ is one of the following B radicals:

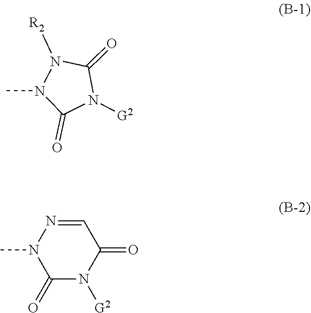

where the broken line denotes the bond to the carbon atom of the bicyclic system of the formula (I), where
R₂ is hydrogen, C₁-C₆-alkyl or halo-C₁-C₆-alkyl, and G² is a radical from the group of hydrogen, C₁-C₆-alkyl, halo-C₁-C₆-alkyl, C₁-C₆-alkoxy-C₁-C₆-alkyl, C₁-C₆-alkyl-S—C₁-C₆-alkyl, C₁-C₆-alkyl-S(O)—C₁-C₆-alkyl, C₁-C₆-alkyl-S(O₂)—C₁-C₆-alkyl, C₃-C₆-cycloalkyl, C₃-C₆-cycloalkyl-C₁-C₆-alkyl, halo-C₃-C₆-cycloalkyl, C₃-C₆-cycloalkenyl, halo-C₃-C₆-cycloalkenyl, phenyl or benzyl (where phenyl and benzyl themselves may in turn be substituted by halogen, cyano, nitro, C₁-C₆-alkyl, halo-C₁-C₆-alkyl and C₃-C₆-cycloalkyl), pyridyl or pyridylmethyl (where pyridyl and pyridylmethyl themselves may in turn be substituted by halogen, cyano, nitro, C₁-C₆-alkyl, halo-C₁-C₆-alkyl and C₃-C₆-cycloalkyl).

Range of preference (2a): Particular preference is also given to compounds of the formula (I) in which
A is an A radical from the group of (A-b) and (A-f)

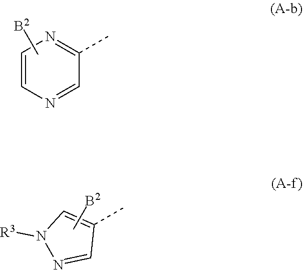

in which the broken line denotes the bond to the carbon atom of the bicyclic system of the formula (I),
B² is a radical from the group of hydrogen, halogen, C₁-C₆-alkyl and C₁-C₄-haloalkyl,
X₁ is CH,
X₂ is CH,
X₃ is CH,
R₁ is a B radical from the group of

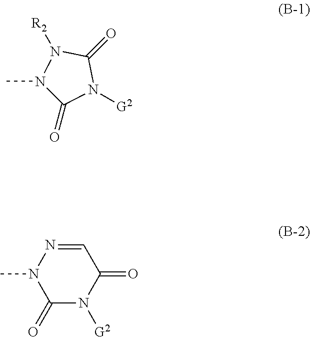

where the broken line denotes the bond to the carbon atom of the bicyclic system of the formula (I), where
R₂ is hydrogen or C₁-C₆-alkyl,
G² is a radical from the group of hydrogen, C₁-C₆-alkyl, halo-C₁-C₆-alkyl, C₃-C₆-cycloalkyl, halo-C₃-C₆-cycloalkyl, C₃-C₆-cycloalkenyl and halo-C₃-C₆-cycloalkenyl, and

compounds of the formula (I) in which
A is the A radical

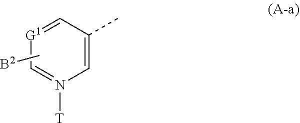

in which the broken line denotes the bond to the carbon atom of the bicyclic system of the formula (I),
G¹ is N or C—B¹,
B¹ is a radical from the group of hydrogen, halogen, C₁-C₆-alkyl and C₁-C₄-haloalkyl,
B² is a radical from the group of hydrogen, halogen, C₁-C₆-alkyl and C₁-C₄-haloalkyl,
T is oxygen or an electron pair,
X₁ is N or CH,
X₂ is CH,
X₃ is CH,
R₁ is a B radical from the group of

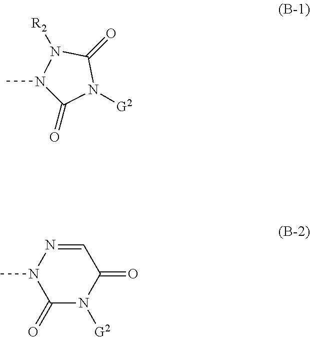

where the broken line denotes the bond to the carbon atom of the bicyclic system of the formula (I), where
R₂ is hydrogen, C₁-C₆-alkyl or halo-C₁-C₆-alkyl,
G² is a radical from the group of hydrogen, C₁-C₆-alkyl, halo-C₁-C₆-alkyl, C₁-C₆-alkoxy-C₁-C₆-alkyl, C₁-C₆-alkyl-S—C₁-C₆-alkyl, C₁-C₆-alkyl-S(O)—C₁-C₆-alkyl, C₁-C₆-alkyl-S(O₂)—C₁-C₆-alkyl, C₃-C₆-cycloalkyl, C₃-C₆-cycloalkyl-C₁-C₆-alkyl, phenyl or benzyl (where phenyl and benzyl themselves may in turn be substituted by halogen, cyano, nitro, C₁-C₆-alkyl, halo-C₁-C₆-alkyl and C₃-C₆-cycloalkyl), pyridylmethyl which may be substituted by halogen, and halo-C₃-C₆-cycloalkyl, C₃-C₆-cycloalkenyl and halo-C₃-C₆-cycloalkenyl.

Range of preference (3a): Very particular preference is also given to compounds of the formula (I) in which
A is one of the following A radicals:

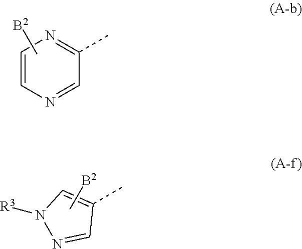

in which the broken line denotes the bond to the carbon atom of the bicyclic system of the formula (I),
B² is hydrogen,
X₁ is CH,
X₂ is CH,
X₃ is CH,
R₁ is a B radical from the group of

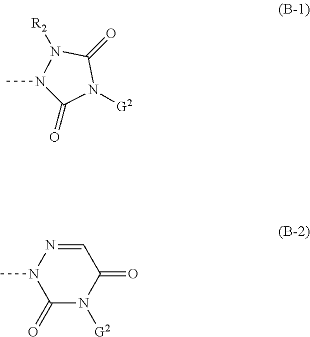

where the broken line denotes the bond to the carbon atom of the bicyclic system of the formula (I), where
R₂ is hydrogen or C₁-C₆-alkyl,
G² is a radical from the group of hydrogen, C₁-C₆-alkyl, halo-C₁-C₆-alkyl and C₃-C₆-cycloalkyl, and

compounds of the formula (I) in which
A is the A radical

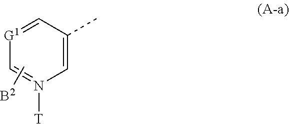

in which the broken line denotes the bond to the carbon atom of the bicyclic system of the formula (I),
G¹ is N or C—B¹,
B¹ is a radical from the group of hydrogen and fluorine,
B² is hydrogen,
T is oxygen or an electron pair,
X₁ is N or CH,
X₂ is CH,
X₃ is CH,
R₁ is a B radical from the group of

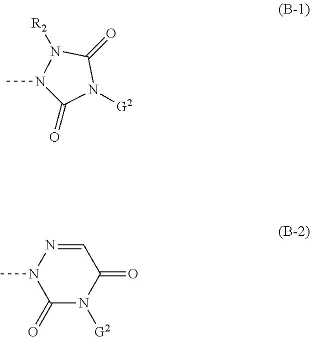

where the broken line denotes the bond to the carbon atom of the bicyclic system of the formula (I), where
R₂ is hydrogen, C₁-C₆-alkyl or halo-C₁-C₆-alkyl,
G² is a radical from the group of C₁-C₄-alkyl, halo-C₁-C₄-alkyl, C₁-C₄-alkoxy-C₁-C₄-alkyl, C₁-C₄-alkyl-S—C₁-C₄-alkyl, C₁-C₄-alkyl-S(O)—C₁-C₄-alkyl, C₁-C₄-alkyl-S(O₂)—C₁-C₄-alkyl, C₃-C₆-cycloalkyl, C₃-C₆-cycloalkyl-C₁-C₄-alkyl, phenyl or benzyl (where phenyl and benzyl themselves may in turn be substituted by halogen and cyano), pyridylmethyl which may be substituted by halogen.

Range of preference (4a): A particular group of compounds of the formula (I) is that of those in which
A is

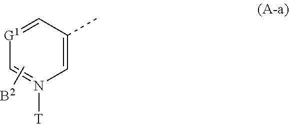

in which the broken line denotes the bond to the carbon atom of the bicyclic system of the formula (I),
G¹ is C—B¹,
B¹ is hydrogen,
B² is hydrogen,
T is an electron pair,
X₁ is N or CH,
X₂ is CH,
X₃ is CH,
R₁ is the (B-1) radical

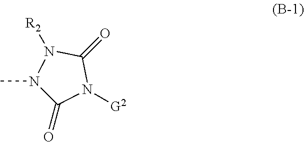

where the broken line denotes the bond to the carbon atom of the bicyclic system of the formula (I), where
R₂ is hydrogen, C₁-C₄-alkyl or halo-C₁-C₄-alkyl and
G² is a radical from the group of C₁-C₄-alkyl, halo-C₁-C₄-alkyl, C₁-C₄-alkoxy-C₁-C₄-alkyl, C₁-C₄-alkyl-S—C₁-C₄-alkyl, C₁-C₄-alkyl-S(O)—C₁-C₄-alkyl, C₃-C₆-cycloalkyl, C₃-C₆-cycloalkyl-C₁-C₄-alkyl, phenyl, benzyl and pyridylmethyl (where phenyl, benzyl and pyridylmethyl themselves may in turn be substituted by halogen).

Range of preference (5a): A further particular group of compounds of the formula (I) is that of those in which
A is the A radical

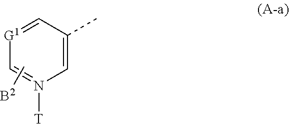

in which the broken line denotes the bond to the carbon atom of the bicyclic system of the formula (I),
G¹ is C—B¹,
B¹ is hydrogen,
B² is hydrogen,
T is an electron pair,
X₁ is N or CH,
X₂ is CH,
X₃ is CH,
R₁ is the (B-2) radical

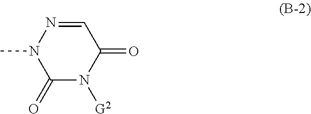

where the broken line denotes the bond to the carbon atom of the bicyclic system of the formula (I), where
G² is a radical from the group of C₁-C₄-alkyl, halo-C₁-C₄-alkyl, C₃-C₆-cycloalkyl-C₁-C₄-alkyl, phenyl or benzyl (where phenyl and benzyl themselves may in turn be substituted by halogen).

In the definitions adduced above, unless stated otherwise, halogen is selected from the group of fluorine, chlorine, bromine and iodine, preferably in turn from the group of fluorine, chlorine and bromine.

Halogen-substituted radicals, for example haloalkyl, are mono- or polyhalogenated, up to the maximum number of possible substituents. In the case of polyhalogenation, the halogen atoms may be identical or different. Halogen here is fluorine, chlorine, bromine or iodine, especially fluorine, chlorine or bromine.

Saturated or unsaturated hydrocarbon radicals, such as alkyl or alkenyl, may each be straight-chain or branched if possible, including in combination with heteroatoms, as, for example, in alkoxy.

Unless stated otherwise, optionally substituted radicals may be mono- or polysubstituted, where the substituents in the case of polysubstitutions may be the same or different.

If T in the radical A of the formula (A-a)

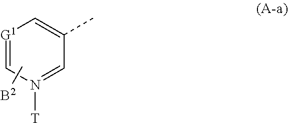

is an electron pair, the radical takes the form of a pyridine derivative of the formula

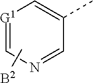

If T in the radical A of the formula (A-a)

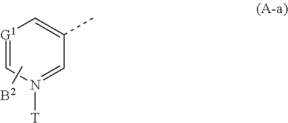

is oxygen, the radical takes the form of a pyridine N-oxide derivative of the formula

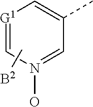

The representation of the formal charges (+ at nitrogen and − at oxygen) was omitted here.

The radical definitions or illustrations given in general terms or listed within ranges of preference apply correspondingly to end products and to starting materials and intermediates. These radical definitions can be combined with one another as desired, i.e. including combinations between the respective ranges of preference.

Preference is given in accordance with the invention to compounds of the formula (I) in which there is a combination of the definitions listed above as being preferred (range of preference (1)).

Particular preference is given in accordance with the invention to compounds of the formula (I) in which there is a combination of the definitions listed above as being particularly preferred (range of preference (2)).

Very particular preference is given in accordance with the invention to compounds of the formula (I) in which there is a combination of the definitions listed above as being very particularly preferred (range of preference (3)).

Especial preference is given in accordance with the invention to compounds of the formula (I) in which there is a combination of the definitions listed as particular definitions (range of preference (4)).

Especial preference is also given in accordance with the invention to compounds of the formula (I) in which there is a combination of the definitions listed as particular definitions (range of preference (5)).

Preference is also given in accordance with the invention to compounds of the formula (I) in which there is a combination of the definitions listed above as being preferred (range of preference (1a)).

Particular preference is also given in accordance with the invention to compounds of the formula (I) in which there is a combination of the definitions listed above as being particularly preferred (range of preference (2a)).

Very particular preference is also given in accordance with the invention to compounds of the formula (I) in which there is a combination of the definitions listed above as being very particularly preferred (range of preference (3a)).

Especial preference is also given in accordance with the invention to compounds of the formula (I) in which there is a combination of the definitions listed as particular definitions (range of preference (4a)).

Especial preference is also given in accordance with the invention to compounds of the formula (I) in which there is a combination of the definitions listed as particular definitions (range of preference (5a)).

A preferred embodiment of the invention relates to compounds of the formula (I) in which A is the radical of the formula (A-a)

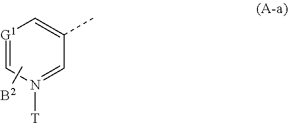

A further preferred embodiment of the invention relates to compounds of the formula (I) in which A is pyridin-3-yl.

A further preferred embodiment of the invention relates to compounds of the formula (I) in which A is 5-fluoropyridin-3-yl.

A further preferred embodiment of the invention relates to compounds of the formula (I) in which A is pyrimidin-5-yl.

A further preferred embodiment of the invention relates to compounds of the formula (I) in which A is pyridazin-4-yl.

The radical definitions or elucidations given above in general terms or within areas of preference apply correspondingly to the end products (including the compounds of the formulae (I-A) to (I-P) shown later) and to the starting materials and intermediates. These radical definitions can be combined with one another as desired, i.e. including combinations between the respective ranges of preference.

In a preferred embodiment, the invention relates to compounds of the formula (I-A)

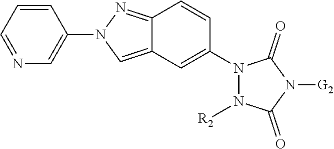

In a further preferred embodiment, the invention relates to compounds of the formula (I-B)

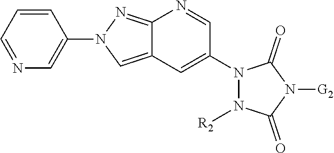

In a further preferred embodiment, the invention relates to compounds of the formula (I-C)

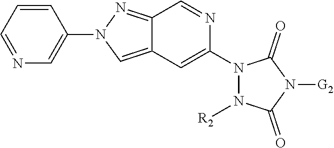

In a further preferred embodiment, the invention relates to compounds of the formula (I-D)

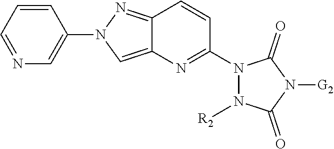

In a further preferred embodiment, the invention relates to compounds of the formula (I-E)

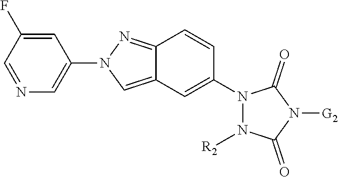

In a further preferred embodiment, the invention relates to compounds of the formula (I-F)

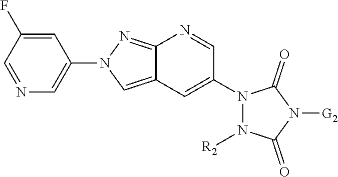

In a further preferred embodiment, the invention relates to compounds of the formula (I-G)

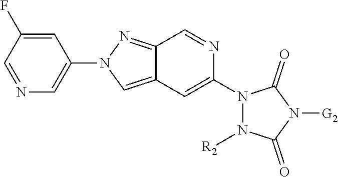

In a further preferred embodiment, the invention relates to compounds of the formula (I-H)

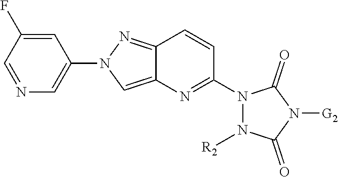

In a further preferred embodiment, the invention relates to compounds of the formula (I-I)

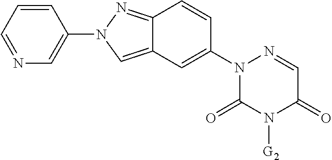

In a further preferred embodiment, the invention relates to compounds of the formula (I-J)

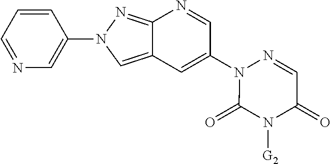

In a further preferred embodiment, the invention relates to compounds of the formula (I-K)

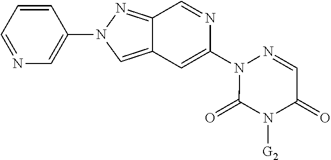

In a further preferred embodiment, the invention relates to compounds of the formula (I-L)

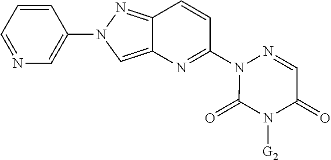

In a further preferred embodiment, the invention relates to compounds of the formula (I-M)

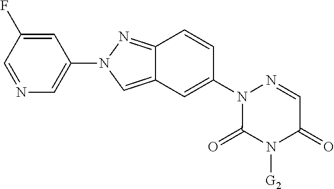

In a further preferred embodiment, the invention relates to compounds of the formula (I-N)

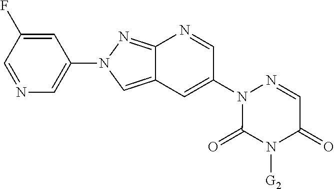

In a further preferred embodiment, the invention relates to compounds of the formula (I-O)

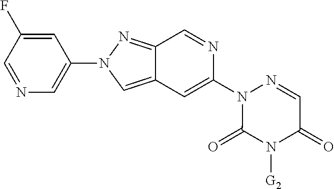

In a further preferred embodiment, the invention relates to compounds of the formula (I-P)

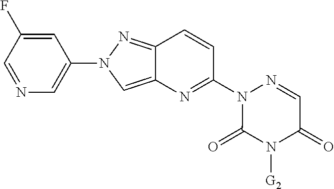

In the formulae (I-A) to (I-P), the variables have the definitions given above, including in the areas of preference.

The compounds of the formula (I) and their acid addition salts and metal salt complexes have good efficacy, especially for control of animal pests including arthropods and especially insects.

Suitable salts of the compounds of the formula (I) which may be mentioned are customary nontoxic salts, i.e. salts with appropriate bases and salts with added acids. Preference is given to salts with inorganic bases, such as alkali metal salts, for example sodium, potassium or caesium salts, alkaline earth metal salts, for example calcium or magnesium salts, ammonium salts, salts with organic bases and with inorganic amines, for example triethylammonium, dicyclohexylammonium, N,N′-dibenzylethylenediammonium, pyridinium, picolinium or ethanolammonium salts, salts with inorganic acids, for example hydrochlorides, hydrobromides, dihydrosulphates, trihydrosulphates, or phosphates, salts with organic carboxylic acids or organic sulphonic acids, for example formates, acetates, trifluoroacetates, maleates, tartrates, methanesulphonates, benzenesulphonates or para-toluenesulphonates, salts with basic amino acids, for example arginates, aspartates or glutamates, and the like.

The compounds of the formula (I) may possibly also, depending on the nature of the substituents, be in the form of stereoisomers, i.e. in the form of geometric and/or optical isomers or isomer mixtures of varying compositions. This invention provides both the pure stereoisomers and any desired mixtures of these isomers, even though it is generally only compounds of the formula (I) that are discussed here.

The invention therefore relates both to the pure enantiomers and diastereomers and to mixtures thereof for controlling animal pests, including arthropods and particularly insects.

However, preference is given in accordance with the invention to using the optically active, stereoisomeric forms of the compounds of the formula (I) and salts thereof.

The terms “synthesis example” and “use example” are used synonymously here, unless stated otherwise and unless anything else is apparent from the context.

The precursors (A-4) for the compounds of the formula (I) in which the heterocycle A is optionally B² radical-substituted pyrimidin-5-yl (A-a; G¹=N), pyridin-3-yl (A-a; G¹=C—B¹), pyrazin-2-yl (A-b), pyridazin-3-yl (A-c), thiazol-5-yl (A-d), isothiazol-4-yl (A-e) and pyrazol-4-yl (A-f), X₁ is CH, X₂ and X₃ are each independently nitrogen or CH can, for example, be prepared according to Reaction Scheme I in two steps.

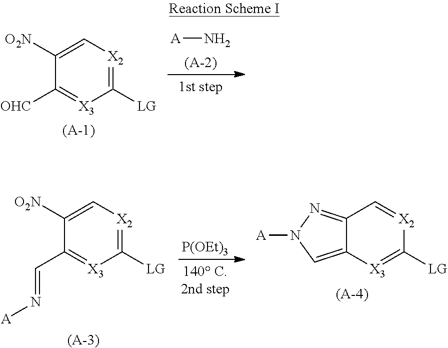

In Reaction Scheme I, A, X₂ and X₃ have the definitions given further up and LG is a nucleofugic leaving group, preferably halogen.

For example, substituted 2-nitrobenzaldehydes of the formula (A-1; e.g. X₂, X₃═CH) can be reacted with the appropriate 3-amino-substituted heterocycles of the formula (A-2) in the presence of acidic reaction auxiliaries in a first reaction step to give compounds of the formula (A-3; e.g. X₂, X₃═CH), which are then, in a second reaction step, subjected to reductive cyclization in the presence of a suitable phosphorus(III) reagent, for example triethyl phosphite, to form the compounds (A-4; e.g. X₂, X₃═CH).

If, for example, for preparation of the precursors (A-4; e.g. X₂, X₃═CH), the compound of the formula (A-1) used is 5-bromo-2-nitrobenzaldehyde (LG=Br) and the compound of the formula (A-2) is 3-pyridineamine (A-a=pyridin-3-yl), what is at first formed is N-[(5-bromo-2-nitrophenyl)methylene]-3-pyridineamine of the formula (A-3) (A-a=pyridin-3-yl, X₂, X₃═CH LG=Br). Subsequent reduction and cyclization then leads to 5-bromo-2-(pyridin-3-yl)-2H-indazole (A-4, A-a=pyridin-3-yl, X₂, X₃═CH, LG=Br) (cf. starting material for Preparation Examples 1 and 2).

Some of the compounds of the formula (A-1) are known and commercially available or they can be obtained by preparation processes known in principle (for X₂, X₃═CH, LG=Br; 5-bromo-2-nitrobenzaldehyde (WO 2014/121416 A1)).

Some of the compounds of the formula (A-2) are known and commercially available or they can be obtained by preparation processes known in principle; cf., for example, for A=5-fluoropyridin-3-yl (A-a; B²═H, G¹=C—F; T=electron pair) (WO 2011/123751 A2); pyrazin-2-yl (A-b; B²═H) (WO 2012/151567 A1); pyridazin-4-yl (A-c; B²═H) (WO 2011/038572 A1); thiazol-5-yl (A-d; B²═H) (JP 4600 6049 B4); isothiazol-4-yl (A-e; B²═H) (U.S. Pat. No. 2,839,529) or 1-methyl-1H-pyrazol-4-yl (A-f; B²═H, R³═CH₃).

The precursors (A-4) can be obtained by synthesis methods known in principle; cf., for example, for A=pyridin-3-yl (A-a; B²═H, G¹=CH; T=electron pair; R₁, R₂═H) (S. Ostrowski, A. M. Wolniewicz, Chem. Het. Compd. (New York) (Transl. Khim. Geterotsikl. Soedin.) 2000, 36(6), 705-713) or for A=pyrimid-2-yl (A-b; B², R₁, R₂═H) (A. L. El-Ansary et al., Egypt. J. Chem. 1991, 33(2), 129-145).

A selection of precursors (A-4) for the compounds of the formula (I) is cited by way of example:
5-Bromo-2-(3-pyridinyl)-2H-indazole (A-a=pyridin-3-yl; X₁, X₂, X₃═CH; LG=Br) (cf. WO 2016/071499 A1 and WO 2016/087421 A1), and
5-Bromo-2-(3-pyridinyl)-2H-pyrazolo[3,4-b]pyridine (A-a=pyridin-3-yl; X₁═N, X₂, X₃═CH; LG=Br) (cf. WO 2016087368 A1).

Finally, the ortho-iminonitrobenzene precursors (A-3) can be obtained in the second reaction step by means of a reductive cyclization, for example by the Candogan indazole synthesis in the presence of triethyl phosphite (cf. J. I. G. Candogan et al., J. Chem. Soc. 1965, 4831).

Alternatively, it is also possible to utilize modified reductive cyclization reaction conditions according to Candogan et al. or to use corresponding alternative reaction conditions, for example the transition metal-catalysed reductive cyclization of iminonitroaromatics and the thermal transition metal-catalysed cyclization of 2-azidoimines (cf. N. E. Genung et al., Org. Lett. 2014, 16, 3114-3117 and the literature cited therein).

Alternatively, the 2-halogen-substituted 3-pyridinecarboxaldehydes of the formula (A-5; X₁═N) can be converted in a first reaction step with sodium azide to the corresponding 2-azido-3-pyridinecarboxyaldehydes of the formula (A-6; X₁═N), which then react with 3-amino-substituted heterocycles of the formula (A-2) in a second reaction step to give compounds of the formula (A-7; X₁═N), called “Schiff bases”, and, in a third reaction step, these can be cyclized at reflux temperature in a suitable solvent to form the precursors (A-8; X₁═N) (cf., for example, for 5-bromo-2-(3-pyridyl)pyrazolo[3,4-b]pyridine (A-a; B²═H; X₁═N, X₂, X₃═CH; G¹=C—H; T=electron pair; Reaction Scheme II).

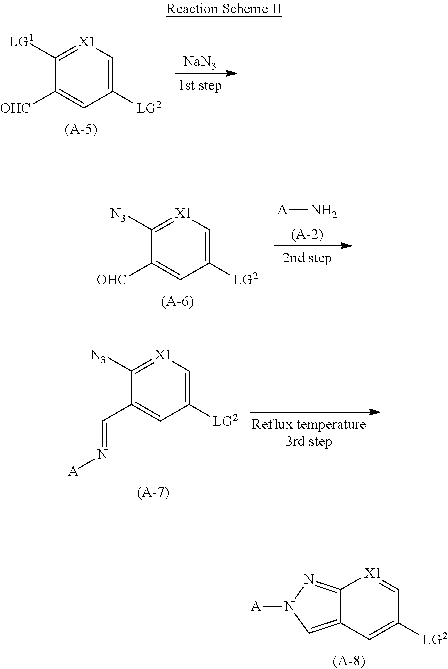

In Reaction Scheme II, A and X₁ have the definition given further up and LG¹ and LG² are suitable nucleofugic leaving groups, preferably halogen.

Compounds of the formula (I) in which A, X₁, X₂, X₃ and R₁ have the definition given further up can be obtained according to Reaction Scheme III from the corresponding precursors (A-4) and (A-8).

For example, the compounds of the formula (I) in which A, G², R₂, X₁, X₂ and X₃ have the definition given further up and R₁ is a (B-1) and (B-2) radical can be obtained according to Reaction Scheme III (cf. also Preparation Examples 1 to 29).

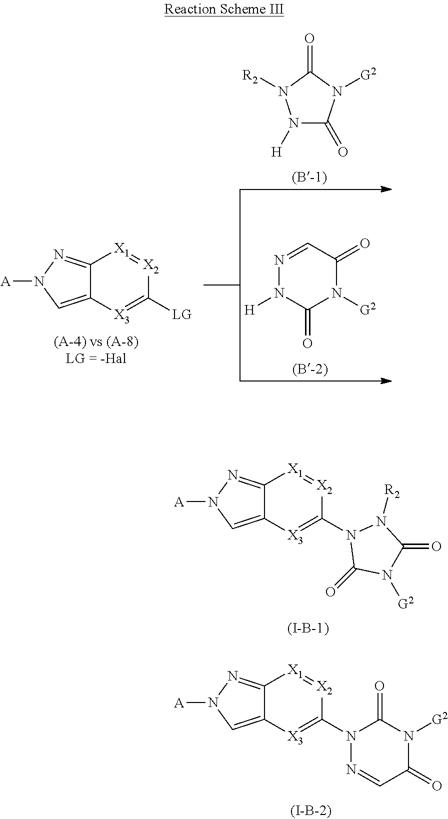

In Reaction Scheme III, the precursors (A-4) and (A-8) of the compounds (I) in which A, X₁, X₂ and X₃ have the definition given further up have a nucleofugic leaving group LG possibly generated in situ or a halogen, for example bromine.

For example, optionally 1,4-substituted 1,2,4-triazolidine-3,5-diones of the formula (B′-1) or 4-substituted 1,2,4-triazine-3,5(2H,4H)-diones of the formula (B′-2) can be reacted with the appropriate precursors (A-4) and (A-8) to give compounds of the formula (I).

Some of the compounds of the formula (B′-1) are known and commercially available or they can be obtained by preparation processes known in principle (cf. also Examples (B′-1)-1 to (B′-1)-10 in the Experimental).

The compounds of the formula (B′-1) in which R₂ and G² have the definition given further up can be obtained, for example, from corresponding N-substituted hydrazinecarboxylic esters of the formula (A-9) and isocyanates of the formula (I-10) according to Reaction Scheme IV (cf. example in WO 99/07687 with R=ethyl, R₂=methyl; G²=3-bromobenzyl).

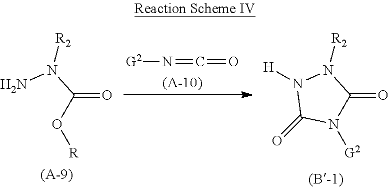

By way of example, a selection of 1,2,4-triazolidine-3,5-diones of the formula (B′-1) for use in accordance with the invention is cited, which have been described or are commercially available:
1,4-dimethyl-1,2,4-triazolidine-3,5-dione (CAS No. 34771-26-1; Apichemical (Shanghai)),
1-methyl-4-phenyl-1,2,4-triazolidine-3,5-dione (CAS No. 28538-67-2; Apichemical (Shanghai)),
1-methyl-4-(1-methylethyl)-1,2,4-triazolidine-3,5-dione (CAS No. 1641986-25-5; cf. WO 2014/202505 A1),
4-ethyl-1-methyl-1,2,4-triazolidine-3,5-dione (CAS No. 1641986-30-2; cf. WO 2014/202505 A1),
1-methyl-4-(2-propen-1-yl)-1,2,4-triazolidine-3,5-dione (CAS No. 801213-17-2; cf. WO 99/07687 A1),
4-(1,1-dimethylethyl)-1-methyl-1,2,4-triazolidine-3,5-dione (CAS No. 1641986-16-4; cf. WO 2014/202505 A1),
4-butyl-1-methyl-1,2,4-triazolidine-3,5-dione (CAS No. 10270-05-0; cf. W. S. Jr. Wadsworth, W. D. Emmons, J. Org. Chem. 1967, 32(5), 1279-85),
1-methyl-4-phenyl-1,2,4-triazolidine-3,5-dione (CAS No. 28538-67-2, Apichemical (Shanghai)),
4-[(3-bromophenyl)methyl]-1-methyl-1,2,4-triazolidine-3,5-dione (CAS No. 220464-61-9; cf. WO 99/07687 A1).

The compounds of the formula (B′-2) in which G² has the definition given further up can be obtained, for example, from the commercially available 1,2,4-triazine-3,5(2H,4H)-dione of the formula (A-11) and compounds of the formula (A-12) in which LG is a nucleofugic leaving group LG possibly generated in situ (e.g. halogen), according to Reaction Scheme V (cf. J. S. D. Kumar et al., J. Med. Chem. 2006, 49, 125-134; cf. also Examples (B′-2)-1 and (B′-2)-2 in the Experimental).

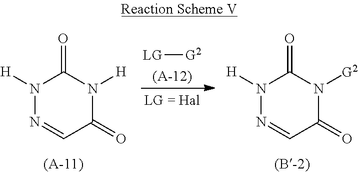

By way of example, a selection of 1,2,4-triazolidine-3,5(2H,4H)-diones of the formula (B′-2) is cited, which have been described or are commercially available:
4-methyl-1,2,4-triazine-3,5(2H,4H)-dione (CAS No. 1627-30-1; AK Scientific)
4-ethyl-1,2,4-triazine-3,5(2H,4H)-dione (CAS No. 1627-31-1; Apichemical (Shanghai)),
4-(2-propen-1-yl)-1,2,4-triazine-3,5(2H,4H)-dione (CAS No. 79944-17-5; Apichemical (Shanghai)),
4-(2-propyn-1-yl)-1,2,4-triazine-3,5(2H,4H)-dione (CAS No. 79944-18-6; cf. EP 33163 A2),
4-butyl-1,2,4-triazine-3,5(2H,4H)-dione (CAS No. 61958-55-1; Apichemical (Shanghai)),
4-(2-fluoroethyl)-1,2,4-triazine-3,5(2H,4H)-dione (CAS No. 1351411-61-4; FCH Group Reagents for Synthesis),
4-(phenylmethyl)-1,2,4-triazine-3,5(2H,4H)-dione (CAS No. 5579-47-5; Shanghai Chemhere)
4-[(4-chlorophenyl)methyl]-1,2,4-triazine-3,5(2H,4H)-dione (CAS No. 1207441-70-0; Hong Kong Chemhere).

The compounds of the formula (I) can be prepared analogously to methods known from the literature, by reaction of halides of the formula (A-4) (e.g. LG=Br) or (A-8) (e.g. LG=Br) with heterocyclic compounds of the formula (B′-1) or (B′-2).

The reaction preferably takes place through transition metal catalysis or mediation. Numerous sets of illustrative reaction conditions for the reaction of aryl bromides with triazolinones are known in the literature, for example in WO 2013/062027 A1 and WO 2015/035059 A1.

Preference is given to using copper or copper salts, for example copper(I) iodide, copper(I) oxide or copper(I) triflate, as catalyst, frequently in the presence of a ligand, for example diamine ligands such as N,N′-dimethylethylenediamine or trans-N,N′-dimethyl-1,2-cyclohexanediamine (cf., for example, WO 2013/062027 A1). As an alternative, it is possible to use 1,3-diketones, for example 2,4-pentanedione, 2,2,6,6-tetramethyl-3,5-heptanedione or dibenzoylmethane, amino acids such as, for example, L-proline or glycine (cf. WO 2015/035059 A1), or other compounds such as 8-hydroxyquinoline or bipyridine. In general, the reaction is performed in the presence of a base, frequently carbonate or phosphate bases, for example potassium carbonate, sodium carbonate, caesium carbonate or potassium phosphate, in suitable solvents, for example dioxane, toluene, dimethyl sulphoxide or N,N-dimethylformamide. It is additionally possible to use other additives, for example potassium iodide, caesium fluoride or other salts.

Alternatively, it is possible to perform reactions of this kind under palladium catalysis in analogy to literature methods, for instance using palladium-based catalysts, for example palladium acetate, tetrakis(triphenylphosphine)palladium, bis(triphenylphosphine)palladium(II) chloride, tris(dibenzylideneacetone)dipalladium(0) in the presence of ligands, for example 2,2′-bis(diphenylphosphino)-1,1′-binaphthyl (BINAP), 9,9-dimethyl-4,5-bis(diphenylphosphino)xanthene, 1,1′-bis(diphenylphosphino)ferrocene, and bases, for example potassium carbonate, sodium carbonate, caesium carbonate or potassium phosphate, in suitable solvents, for example dioxane, toluene, dimethyl sulphoxide or N,N-dimethylformamide.

Illustrative reaction conditions can be found in the literature, for example in WO 2005/085226 and WO 2006/067139 A1. The use of palladium(0) sources, for example tris(dibenzylideneacetone)dipalladium(0), in combination with ligands such as 5-(di-tert-butylphosphino)-1,3,5-triphenyl-1-H-[1,4]bipyrazole for the coupling between aryl halides and amides, preferably takes place in solvents such as ethers, e.g. dimethoxyethane, and alcohols, such as tert-butyl alcohol or tert-amyl alcohol, and is described, for example, in US 20070244178 A1, T. Ikawa, et al. J. Amer. Chem. Soc. 2007, 129, 13001-13007, and A. J. Rosenberg, et al. Org. Lett. 2012, 14, 1764-1767.

Compounds of the formula (I) can also be prepared analogously to methods known from the literature, by reaction of boronic acids of the formula (A-4 or A-8 in which LG is B(OH)₂) with heterocyclic compounds of the formula (B′-1) or (B′-2).

In general, the reactions take place under catalysis or mediation by copper(II) salts, for example copper(II) acetate, copper(II) triflate, or else by copper(I) salts, for example copper(I) chloride, copper(I) acetate, under an air or oxygen atmosphere, frequently under dehydrating conditions (for example with molecular sieve).

Bases used are, for example, triethylamine, N-ethyldiisopropylamine, pyridine, 2,6-lutidine, N-methylmorpholine or 1,8-diazabicycloundec-7-ene in suitable solvents, for example dichloromethane, dichloroethane, methanol, N,N-dimethylformamide, tetrahydrofuran, dioxane, acetonitrile, ethyl acetate or toluene. The literature describes numerous examples, including in Q. Tan Darlene, et al. Proc. Natl. Acad. Sci. USA 2011, 108 (17), 6781-6786, in WO 2005/85226 or in WO 2008/62905 A2. Comprehensive reviews can be found, for example, in J. X. Qiao, P. Y. S. Lam Synthesis 2011, 6, 829-856 or in R. Sanjeeva, T.-S. Wu Tetrahedron 2012, 68, 7735-7754.

Instead of the boronic acid, it is also possible to use other boron compounds, for instance potassium trifluoroborate, boronic esters, etc., or else other organometallic compounds, for instance stannanes, silanes or bismuthanes.

The enantiomers can also be obtained from the racemate, for example by preparative separation by means of a chiral HPLC.

### Isomers

Depending on the nature of the substituents, the compounds of the formula (I) may take the form of geometric and/or optically active isomers or corresponding isomer mixtures in different compositions. These stereoisomers are, for example, enantiomers, diastereomers, atropisomers or geometric isomers. The invention therefore encompasses pure stereoisomers and any desired mixtures of these isomers.

### Methods and Uses

The invention also relates to methods for controlling animal pests, in which compounds of the formula (I) are allowed to act on animal pests and/or their habitat. The control of the animal pests is preferably carried out in agriculture and forestry, and in material protection. This preferably excludes methods for surgical or therapeutic treatment of the human or animal body and diagnostic methods carried out on the human or animal body.

The invention further relates to the use of the compounds of the formula (I) as pesticides, especially crop protection agents.

In the context of the present application, the term “pesticide” also encompasses the term “crop protection agent”.

The compounds of the formula (I), given good plant tolerance, favourable homeotherm toxicity and good environmental compatibility, are suitable for protecting plants and plant organs against biotic and abiotic stress factors, for increasing harvest yields, for improving the quality of the harvested material and for controlling animal pests, especially insects, arachnids, helminths, nematodes and molluscs, which are encountered in agriculture, in horticulture, in animal husbandry, in aquatic cultures, in forests, in gardens and leisure facilities, in the protection of stored products and of materials, and in the hygiene sector. They can preferably be used as pesticides. They are active against normally sensitive and resistant species and also against all or specific stages of development. The abovementioned pests include:

pests from the phylum of the Arthropoda, especially from the class of the Arachnida, e.g. Acarus spp., e.g. Acarus siro, Aceria kuko, Aceria sheldoni, Aculops spp., Aculus spp., e.g. Aculus fockeui, Aculus schlechtendali, Amblyomma spp., Amphitetranychus viennensis, Argas spp., Boophilus spp., Brevipalpus spp., e.g. Brevipalpus phoenicis, Bryobia graminum, Bryobia praetiosa, Centruroides spp., Chorioptes spp., Dermanyssus gallinae, Dermatophagoides pteronyssinus, Dermatophagoides farinae, Dermacentor spp., Eotetranychus spp., e.g. Eotetranychus hicoriae, Epitrimerus pyri, Eutetranychus spp., e.g. Eutetranychus banksi, Eriophyes spp., e.g. Eriophyes pyri, Glycyphagus domesticus, Halotydeus destructor, Hemitarsonemus spp., e.g. Hemitarsonemus latus (=Polyphagotarsonemus latus), Hyalomma spp., Ixodes spp., Latrodectus spp., Loxosceles spp., Neutrombicula autumnalis, Nuphersa spp., Oligonychus spp., e.g. Oligonychus coniferarum, Oligonychus ilicis, Oligonychus indicus, Oligonychus mangiferus, Oligonychus pratensis, Oligonychus punicae, Oligonychus yothersi, Ornithodorus spp., Omithonyssus spp., Panonychus spp., e.g. Panonychus citri (=Metatetranychus citri), Panonychus ulmi (=Metatetranychus ulmi), Phyllocoptruta oleivora, Platytetranychus multidigituli, Polyphagotarsonemus latus, Psoroptes spp., Rhipicephalus spp., Rhizoglyphus spp., Sarcoptes spp., Scorpio maurus, Steneotarsonemus spp., Steneotarsonemus spinki, Tarsonemus spp., e.g. Tarsonemus confusus, Tarsonemus pallidus, Tetranychus spp., e.g. Tetranychus canadensis, Tetranychus cinnabarinus, Tetranychus turkestani, Tetranychus urticae, Trombicula alfreddugesi, Vaejovis spp., Vasates lycopersici;

from the class of the Chilopoda e.g. Geophilus spp., Scutigera spp.;

from the order or the class of the Collembola e.g. Onychiurus armatus; Sminthurus viridis;

from the class of the Diplopoda e.g. Blaniulus guttulatus;

from the class of the Insecta, for example from the order of the Blattodea e.g. Blatta orientalis, Blattella asahinai, Blattella germanica, Leucophaea maderae, Panchlora spp., Parcoblatta spp., Periplaneta spp., e.g. Periplaneta americana, Periplaneta australasiae, Supella longipalpa;

from the order of the Coleoptera e.g. Acalymma vittatum, Acanthoscelides obtectus, Adoretus spp., Agelastica alni, Agriotes spp., e.g. Agriotes linneatus, Agriotes mancus, Alphitobius diaperinus, Amphimallon solstitialis, Anobium punctatum, Anoplophora spp., Anthonomus spp., e.g. Anthonomus grandis, Anthrenus spp., Apion spp., Apogonia spp., Atomaria spp., e.g. Atomaria linearis, Attagenus spp., Baris caerulescens, Bruchidius obtectus, Bruchus spp., e.g. Bruchus pisorum, Bruchus rufimanus, Cassida spp., Cerotoma trifurcata, Ceutorrhynchus spp., e.g. Ceutorrhynchus assimilis, Ceutorrhynchus quadridens, Ceutorrhynchus rapae, Chaetocnema spp., e.g. Chaetocnema confinis, Chaetocnema denticulata, Chaetocnema ectypa, Cleonus mendicus, Conoderus spp., Cosmopolites spp., e.g. Cosmopolites sordidus, Costelytra zealandica, Ctenicera spp., Curculio spp., e.g. Curculio caryae, Curculio caryatrypes, Curculio obtusus, Curculio sayi, Cryptolestes ferrugineus, Cryptolestes pusillus, Cryptorhynchus lapathi, Cryptorhynchus mangiferae, Cylindrocopturus spp., Cylindrocopturus adspersus, Cylindrocopturus furnmissi, Dermestes spp., Diabrotica spp., e.g. Diabrotica balteata, Diabrotica barberi, Diabrotica undecimpunctata howardi, Diabrotica undecimpunctata undecimpunctata, Diabrotica virgifera virgifera, Diabrotica virgifera zeae, Dichocrocis spp., Dicladispa armigera, Diloboderus spp., Epilachna spp., e.g. Epilachna borealis, Epilachna varivestis, Epitrix spp., e.g. Epitrix cucumeris, Epitrix fuscula, Epitrix hirtipennis, Epitrix subcrinita, Epitrix tuberis, Faustinus spp., Gibbium psylloides, Gnathocerus comutus, Hellula undalis, Heteronychus arator, Heteronyx spp., Hylamorpha elegans, Hylotrupes bajulus, Hypera postica, Hypomeces squamosus, Hypothenemus spp., e.g. Hypothenemus hampei, Hypothenemus obscurus, Hypothenemus pubescens, Lachnostema consanguinea, Lasioderma serricome, Latheticus oryzae, Lathridius spp., Lema spp., Leptinotarsa decemlineata, Leucoptera spp., e.g. Leucoptera coffeella, Lissorhoptrus oryzophilus, Lixus spp., Luperomorpha xanthodera, Luperodes spp., Lyctus spp., Megascelis spp., Melanotus spp., e.g. Melanotus longulus oregonensis, Meligethes aeneus, Melolontha spp., e.g. Melolontha melolontha, Migdolus spp., Monochamus spp., Naupactus xanthographus, Necrobia spp., Niptus hololeucus, Oryctes rhinoceros, Oryzaephilus surinamensis, Oryzaphagus oryzae, Otiorhynchus spp., e.g. Otiorhynchus cribricollis, Otiorhynchus ligustici, Otiorhynchus ovatus, Otiorhynchus rugosostriarus, Otiorhynchus sulcatus, Oxycetonia jucunda, Phaedon cochleariae, Phyllophaga spp., Phyllophaga helleri, Phyllotreta spp., e.g. Phyllotreta armoraciae, Phyllotreta pusilla, Phyllotreta ramosa, Phyllotreta striolata, Popillia japonica, Premnotrypes spp., Prostephanus truncatus, Psylliodes spp., e.g. Psylliodes affinis, Psylliodes chrysocephala, Psylliodes punctulata, Ptinus spp., Rhizobius ventralis, Rhizopertha dominica, Sitophilus spp., e.g. Sitophilus granarius, Sitophilus linearis, Sitophilus oryzae, Sitophilus zeamais, Sphenophorus spp., Stegobium paniceum, Stemechus spp., e.g. Stemechus paludatus, Symphyletes spp., Tanymecus spp., e.g. Tanymecus dilaticollis, Tanymecus indicus, Tanymecus palliatus, Tenebrio molitor, Tenebrioides mauretanicus, Tribolium spp., e.g. Tribolium audax, Tribolium castaneum, Tribolium confusum, Trogoderma spp., Tychius spp., Xylotrechus spp., Zabrus spp., e.g. Zabrus tenebrioides;

from the order of the Diptera e.g. Aedes spp., e.g. Aedes aegypti, Aedes albopictus, Aedes sticticus, Aedes vexans, Agromyza spp., e.g. Agromyza frontella, Agromyza parvicornis, Anastrepha spp., Anopheles spp., e.g. Anopheles quadrimaculatus, Anopheles gambiae, Asphondylia spp., Bactrocera spp., e.g. Bactrocera cucurbitae, Bactrocera dorsalis, Bactrocera oleae, Bibio hortulanus, Calliphora erythrocephala, Calliphora vicina, Ceratitis capitata, Chironomus spp., Chrysomya spp., Chrysops spp., Chrysozona pluvialis, Cochliomya spp., Contarinia spp., e.g. Contarinia johnsoni, Contarinia nasturtii, Contarinia pyrivora, Contarinia schulzi, Contarinia sorghicola, Contarinia tritici, Cordylobia anthropophaga, Cricotopus sylvestris, Culex spp., e.g. Culex pipiens, Culex quinquefasciatus, Culicoides spp., Culiseta spp., Cuterebra spp., Dacus oleae, Dasineura spp., e.g. Dasineura brassicae, Delia spp., e.g. Delia antiqua, Delia coarctata, Delia florilega, Delia platura, Delia radicum, Dermatobia hominis, Drosophila spp., e.g. Drosphila melanogaster, Drosophila suzukii, Echinocnemus spp., Fannia spp., Gasterophilus spp., Glossina spp., Haematopota spp., Hydrellia spp., Hydrellia griseola, Hylemya spp., Hippobosca spp., Hypoderma spp., Liriomyza spp., e.g. Liriomyza brassicae, Liriomyza huidobrensis, Liriomyza sativae, Lucilia spp., e.g. Lucilia cuprina, Lutzomyia spp., Mansonia spp., Musca spp., e.g. Musca domestica, Musca domestica vicina, Oestrus spp., Oscinella frit, Paratanytarsus spp., Paralauterbomiella subcincta, Pegomya spp., e.g. Pegomya betae, Pegomya hyoscyami, Pegomya rubivora, Phlebotomus spp., Phorbia spp., Phormia spp., Piophila casei, Prodiplosis spp., Psila rosae, Rhagoletis spp., e.g. Rhagoletis cingulata, Rhagoletis completa, Rhagoletis fausta, Rhagoletis indifferens, Rhagoletis mendax, Rhagoletis pomonella, Sarcophaga spp., Simulium spp., e.g. Simulium meridionale, Stomoxys spp., Tabanus spp., Tetanops spp., Tipula spp., e.g. Tipula paludosa, Tipula simplex;

from the order of the Hemiptera e.g. Acizzia acaciaebaileyanae, Acizzia dodonaeae, Acizzia uncatoides, Acrida turrita, Acyrthosipon spp., e.g. Acyrthosiphon pisum, Acrogonia spp., Aeneolamia spp., Agonoscena spp., Aleyrodes proletella, Aleurolobus barodensis, Aleurothrixus floccosus, Allocaridara malayensis, Amrasca spp., e.g. Amrasca bigutulla, Amrasca devastans, Anuraphis cardui, Aonidiella spp., e.g. Aonidiella aurantii, Aonidiella citrina, Aonidiella inomata, Aphanostigma piri, Aphis spp., e.g. Aphis citricola, Aphis craccivora, Aphis fabae, Aphis forbesi, Aphis glycines, Aphis gossypii, Aphis hederae, Aphis illinoisensis, Aphis middletoni, Aphis nasturtii, Aphis nerii, Aphis pomi, Aphis spiraecola, Aphis vibumiphila, Arboridia apicalis, Arytainilla spp., Aspidiella spp., Aspidiotus spp., e.g. Aspidiotus nerii, Atanus spp., Aulacorthum solani, Bemisia tabaci, Blastopsylla occidentalis, Boreioglycaspis melaleucae, Brachycaudus helichrysi, Brachycolus spp., Brevicoryne brassicae, Cacopsylla spp., e.g. Cacopsylla pyricola, Calligypona marginata, Cameocephala fulgida, Ceratovacuna lanigera, Cercopidae, Ceroplastes spp., Chaetosiphon fragaefolii, Chionaspis tegalensis, Chlorita onukii, Chondracris rosea, Chromaphis juglandicola, Chrysomphalus ficus, Cicadulina mbila, Coccomytilus halli, Coccus spp., e.g. Coccus hesperidum, Coccus longulus, Coccus pseudomagnoliarum, Coccus viridis, Cryptomyzus ribis, Cryptoneossa spp., Ctenarytaina spp., Dalbulus spp., Dialeurodes citri, Diaphorina citri, Diaspis spp., Drosicha spp., Dysaphis spp., e.g. Dysaphis apiifolia, Dysaphis plantaginea, Dysaphis tulipae, Dysmicoccus spp., Empoasca spp., e.g. Empoasca abrupta, Empoasca fabae, Empoasca maligna, Empoasca solana, Empoasca stevensi, Eriosoma spp., e.g. Eriosoma americanum, Eriosoma lanigerum, Eriosoma pyricola, Erythroneura spp., Eucalyptolyma spp., Euphyllura spp., Euscelis bilobatus, Ferrisia spp., Geococcus coffeae, Glycaspis spp., Heteropsylla cubana, Heteropsylla spinulosa, Homalodisca coagulata, Hyalopterus arundinis, Hyalopterus pruni, Icerya spp., e.g. Icerya purchasi, Idiocerus spp., Idioscopus spp., Laodelphax striatellus, Lecanium spp., e.g. Lecanium corni (=Parthenolecanium corni), Lepidosaphes spp., e.g. Lepidosaphes ulmi, Lipaphis erysimi, Lycorma delicatula, Macrosiphum spp., e.g. Macrosiphum euphorbiae, Macrosiphum lilii, Macrosiphum rosae, Macrosteles facifrons, Mahanarva spp., Melanaphis sacchari, Metcalfiella spp., Metcalfa pruinosa, Metopolophium dirhodum, Monellia costalis, Monelliopsis pecanis, Myzus spp., e.g. Myzus ascalonicus, Myzus cerasi, Myzus ligustri, Myzus omatus, Myzus persicae, Myzus nicotianae, Nasonovia ribisnigri, Nephotettix spp., e.g. Nephotettix cincticeps, Nephotettix nigropictus, Nilaparvata lugens, Oncometopia spp., Orthezia praelonga, Oxya chinensis, Pachypsylla spp., Parabemisia myricae, Paratrioza spp., e.g. Paratrioza cockerelli, Parlatoria spp., Pemphigus spp., e.g. Pemphigus bursarius, Pemphigus populivenae, Peregrinus maidis, Phenacoccus spp., e.g. Phenacoccus madeirensis, Phloeomyzus passerinii, Phorodon humuli, Phylloxera spp., e.g. Phylloxera devastatrix, Phylloxera notabilis, Pinnaspis aspidistrae, Planococcus spp., e.g. Planococcus citri, Prosopidopsylla flava, Protopulvinaria pyriformis, Pseudaulacaspis pentagona, Pseudococcus spp., e.g. Pseudococcus calceolariae, Pseudococcus comstocki, Pseudococcus longispinus, Pseudococcus maritimus, Pseudococcus viburni, Psyllopsis spp., Psylla spp., e.g. Psylla buxi, Psylla mali, Psylla pyri, Pteromalus spp., Pyrilla spp., Quadraspidiotus spp., e.g. Quadraspidiotus juglansregiae, Quadraspidiotus ostreaeformis, Quadraspidiotus perniciosus, Quesada gigas, Rastrococcus spp., Rhopalosiphum spp., e.g. Rhopalosiphum maidis, Rhopalosiphum oxyacanthae, Rhopalosiphum padi, Rhopalosiphum rufiabdominale, Saissetia spp., e.g. Saissetia coffeae, Saissetia miranda, Saissetia neglecta, Saissetia oleae, Scaphoideus titanus, Schizaphis graminum, Selenaspidus articulatus, Sitobion avenae, Sogata spp., Sogatella furcifera, Sogatodes spp., Stictocephala festina, Siphoninus phillyreae, Tenalaphara malayensis, Tetragonocephela spp., Tinocallis caryaefoliae, Tomaspis spp., Toxoptera spp., e.g. Toxoptera aurantii, Toxoptera citricidus, Trialeurodes vaporariorum, Trioza spp., e.g. Trioza diospyri, Typhlocyba spp., Unaspis spp., Viteus vitifolii, Zygina spp.;

from the suborder of the Heteroptera e.g. Anasa tristis, Antestiopsis spp., Boisea spp., Blissus spp., Calocoris spp., Campylomma livida, Cavelerius spp., Cimex spp., e.g. Cimex adjunctus, Cimex hemipterus, Cimex lectularius, Cimex pilosellus, Collaria spp., Creontiades dilutus, Dasynus piperis, Dichelops furcatus, Diconocoris hewetti, Dysdercus spp., Euschistus spp., e.g. Euschistus heros, Euschistus servus, Euschistus tristigmus, Euschistus variolarius, Eurygaster spp., Halyomorpha halys, Heliopeltis spp., Horcias nobilellus, Leptocorisa spp., Leptocorisa varicomis, Leptoglossus occidentalis, Leptoglossus phyllopus, Lygocoris spp., e.g. Lygocoris pabulinus, Lygus spp., e.g. Lygus elisus, Lygus hesperus, Lygus lineolaris, Macropes excavatus, Monalonion atratum, Nezara spp., e.g. Nezara viridula, Oebalus spp., Piesma quadrata, Piezodorus spp., e.g. Piezodorus guildinii, Psallus spp., Pseudacysta persea, Rhodnius spp., Sahlbergella singularis, Scaptocoris castanea, Scotinophora spp., Stephanitis nashi, Tibraca spp., Triatoma spp.;

from the order of the Hymenoptera e.g. Acromyrmex spp., Athalia spp., e.g. Athalia rosae, Atta spp., Diprion spp., e.g. Diprion similis, Hoplocampa spp., e.g. Hoplocampa cookei, Hoplocampa testudinea, Lasius spp., Linepithema humile, Monomorium pharaonis, Sirex spp., Solenopsis invicta, Tapinoma spp., Urocerus spp., Vespa spp., e.g. Vespa crabro, Xeris spp.;

from the order of the Isopoda e.g. Armadillidium vulgare, Oniscus asellus, Porcellio scaber;

from the order of the Isoptera e.g. Coptotermes spp., e.g. Coptotermes formosanus, Comitermes cumulans, Cryptotermes spp., Incisitermes spp., Microtermes obesi, Odontotermes spp., Reticulitermes spp., e.g. Reticulitermes flavipes, Reticulitermes hesperus;

from the order of the Lepidoptera e.g. Achroia grisella, Acronicta major, Adoxophyes spp., e.g. Adoxophyes orana, Aedia leucomelas, Agrotis spp., e.g. Agrotis segetum, Agrotis ipsilon, Alabama spp., e.g. Alabama argillacea, Amyelois transitella, Anarsia spp., Anticarsia spp., e.g. Anticarsia gemmatalis, Argyroploce spp., Barathra brassicae, Borbo cinnara, Bucculatrix thurberiella, Bupalus piniarius, Busseola spp., Cacoecia spp., Caloptilia theivora, Capua reticulana, Carpocapsa pomonella, Carposina niponensis, Cheimatobia brumata, Chilo spp., e.g. Chilo plejadellus, Chilo suppressalis, Choristoneura spp., Clysia ambiguella, Cnaphalocerus spp., Cnaphalocrocis medinalis, Cnephasia spp., Conopomorpha spp., Conotrachelus spp., Copitarsia spp., Cydia spp., e.g. Cydia nigricana, Cydia pomonella, Dalaca noctuides, Diaphania spp., Diatraea saccharalis, Earias spp., Ecdytolopha aurantium, Elasmopalpus lignosellus, Eldana saccharina, Ephestia spp., e.g. Ephestia elutella, Ephestia kuehniella, Epinotia spp., Epiphyas postvittana, Etiella spp., Eulia spp., Eupoecilia ambiguella, Euproctis spp., e.g. Euproctis chrysorrhoea, Euxoa spp., Feltia spp., Galleria mellonella, Gracillaria spp., Grapholitha spp., e.g. Grapholita molesta, Grapholita prunivora, Hedylepta spp., Helicoverpa spp., e.g. Helicoverpa armigera, Helicoverpa zea, Heliothis spp., e.g. Heliothis virescens Hofmannophila pseudospretella, Homoeosoma spp., Homona spp., Hyponomeuta padella, Kakivoria flavofasciata, Laphygma spp., Leucinodes orbonalis, Leucoptera spp., e.g. Leucoptera coffeella, Lithocolletis spp., e.g. Lithocolletis blancardella, Lithophane antennata, Lobesia spp., e.g. Lobesia botrana, Loxagrotis albicosta, Lymantria spp., e.g. Lymantria dispar, Lyonetia spp., e.g. Lyonetia clerkella, Malacosoma neustria, Maruca testulalis, Mamestra brassicae, Melanitis leda, Mocis spp., Monopis obviella, Mythimna separata, Nemapogon cloacellus, Nymphula spp., Oiketicus spp., Oria spp., Orthaga spp., Ostrinia spp., e.g. Ostrinia nubilalis, Oulema melanopus, Oulema oryzae, Panolis flammea, Parnara spp., Pectinophora spp., e.g. Pectinophora gossypiella, Perileucoptera spp., Phthorimaea spp., e.g. Phthorimaea operculella, Phyllocnistis citrella, Phyllonorycter spp., e.g. Phyllonorycter blancardella, Phyllonorycter crataegella, Pieris spp., e.g. Pieris rapae, Platynota stultana, Plodia interpunctella, Plusia spp., Plutella xylostella (=Plutella maculipennis), Prays spp., Prodenia spp., Protoparce spp., Pseudaletia spp., e.g. Pseudaletia unipuncta, Pseudoplusia includens, Pyrausta nubilalis, Rachiplusia nu, Schoenobius spp., e.g. Schoenobius bipunctifer, Scirpophaga spp., e.g. Scirpophaga innotata, Scotia segetum, Sesamia spp., e.g. Sesamia inferens, Sparganothis spp., Spodoptera spp., e.g. Spodoptera eradiana, Spodoptera exigua, Spodoptera frugiperda, Spodoptera praefica, Stathmopoda spp., Stomopteryx subsecivella, Synanthedon spp., Tecia solanivora, Thermesia gemmatalis, Tinea cloacella, Tinea pellionella, Tineola bisselliella, Tortrix spp., Trichophaga tapetzella, Trichoplusia spp., e.g. Trichoplusia ni, Tryporyza incertulas, Tuta absoluta, Virachola spp.;

from the order of the Orthoptera or Saltatoria e.g. Acheta domesticus, Dichroplus spp., Gryllotalpa spp., e.g. Gryllotalpa gryllotalpa, Hieroglyphus spp., Locusta spp., e.g. Locusta migratoria, Melanoplus spp., e.g. Melanoplus devastator, Paratlanticus ussuriensis, Schistocerca gregaria;

from the order of the Phthiraptera e.g. Damalinia spp., Haematopinus spp., Linognathus spp., Pediculus spp., Phylloxera vastatrix, Phthirus pubis, Trichodectes spp.;

from the order of the Psocoptera e.g. Lepinotus spp., Liposcelis spp.;

from the order of the Siphonaptera e.g. Ceratophyllus spp., Ctenocephalides spp., e.g. Ctenocephalides canis, Ctenocephalides felis, Pulex irritans, Tunga penetrans, Xenopsylla cheopis;

from the order of the Thysanoptera e.g. Anaphothrips obscurus, Baliothrips biformis, Drepanothrips reuteri, Enneothrips flavens, Frankliniella spp., e.g. Frankliniella fusca, Frankliniella occidentalis, Frankliniella schultzei, Frankliniella tritici, Frankliniella vaccinii, Frankliniella williamsi, Heliothrips spp., Hercinothrips femoralis, Rhipiphorothrips cruentatus, Scirtothrips spp., Taeniothrips cardamomi, Thrips spp., e.g. Thrips palmi, Thrips tabaci;

from the order of the Zygentoma (=Thysanura), e.g. Ctenolepisma spp., Lepisma saccharina, Lepismodes inquilinus, Thermobia domestica;

from the class of the Symphyla e.g. Scutigerella spp., e.g. Scutigerella immaculata;

pests from the phylum of the Mollusca, especially from the class of the Bivalvia, e.g. Dreissena spp.;

and from the class of the Gastropoda e.g. Arion spp., e.g. Arion ater rufus, Biomphalaria spp., Bulinus spp., Deroceras spp., e.g. Deroceras laeve, Galba spp., Lymnaea spp., Oncomelania spp., Pomacea spp., Succinea spp.;

animal and human parasites from the phyla of the Platyhelminthes and Nematoda, e.g. Aelurostrongylus spp., Amidostomum spp., Ancylostoma spp, Angiostrongylus spp., Anisakis spp., Anoplocephala spp., Ascaris spp., Ascaridia spp., Baylisascaris spp., Brugia spp., Bunostomum spp., Capillaria spp., Chabertia spp., Clonorchis spp., Cooperia spp., Crenosoma spp., Cyathostoma spp., Dicrocoelium spp., Dictyocaulus spp., Diphyllobothrium spp., Dipylidium spp., Dirofilaria spp., Dracunculus spp., Echinococcus spp., Echinostoma spp., Enterobius spp., Eucoleus spp., Fasciola spp., Fascioloides spp., Fasciolopsis spp., Filaroides spp., Gongylonema spp., Gyrodactylus spp., Habronema spp., Haemonchus spp., Heligmosomoides spp., Heterakis spp., Hymenolepis spp., Hyostrongylus spp., Litomosoides spp., Loa spp., Metastrongylus spp., Metorchis spp., Mesocestoides spp., Moniezia spp., Muellerius spp., Necator spp., Nematodirus spp., Nippostrongylus spp., Oesophagostomum spp., Ollulanus spp., Onchocerca spp, Opisthorchis spp., Oslerus spp., Ostertagia spp., Oxyuris spp., Paracapillaria spp., Parafilaria spp., Paragonimus spp., Paramphistomum spp., Paranoplocephala spp., Parascaris spp., Passalurus spp., Protostrongylus spp., Schistosoma spp., Setaria spp., Spirocerca spp., Stephanofilaria spp., Stephanurus spp., Strongyloides spp., Strongylus spp., Syngamus spp., Taenia spp., Teladorsagia spp., Thelazia spp., Toxascaris spp., Toxocara spp., Trichinella spp., Trichobilharzia spp., Trichostrongylus spp., Trichuris spp., Uncinaria spp., Wuchereria spp.;

plant pests from the phylum of the Nematoda, i.e. phytoparasitic nematodes, especially Aglenchus spp., e.g. Aglenchus agricola, Anguina spp., e.g. Anguina tritici, Aphelenchoides spp., e.g. Aphelenchoides arachidis, Aphelenchoides fragariae, Belonolaimus spp., e.g. Belonolaimus gracilis, Belonolaimus longicaudatus, Belonolaimus nortoni, Bursaphelenchus spp., e.g. Bursaphelenchus cocophilus, Bursaphelenchus eremus, Bursaphelenchus xylophilus, Cacopaurus spp., e.g. Cacopaurus pestis, Criconemella spp., e.g. Criconemella curvata, Criconemella onoensis, Criconemella omata, Criconemella rusium, Criconemella xenoplax (=Mesocriconema xenoplax), Criconemoides spp., e.g. Criconemoides femiae, Criconemoides onoense, Criconemoides omatum, Ditylenchus spp., e.g. Ditylenchus dipsaci, Dolichodorus spp., Globodera spp., e.g. Globodera pallida, Globodera rostochiensis, Helicotylenchus spp., e.g. Helicotylenchus dihystera, Hemicriconemoides spp., Hemicycliophora spp., Heterodera spp., e.g. Heterodera avenae, Heterodera glycines, Heterodera schachtii, Hoplolaimus spp., Longidorus spp., e.g. Longidorus africanus, Meloidogyne spp., e.g. Meloidogyne chitwoodi, Meloidogyne fallax, Meloidogyne hapla, Meloidogyne incognita, Meloinema spp., Nacobbus spp., Neotylenchus spp., Paraphelenchus spp., Paratrichodorus spp., e.g. Paratrichodorus minor, Pratylenchus spp., e.g. Pratylenchus penetrans, Pseudohalenchus spp., Psilenchus spp., Punctodera spp., Quinisulcius spp., Radopholus spp., e.g. Radopholus citrophilus, Radopholus similis, Rotylenchulus spp., Rotylenchus spp., Scutellonema spp., Subanguina spp., Trichodorus spp., e.g. Trichodorus obtusus, Trichodorus primitivus, Tylenchorhynchus spp., e.g. Tylenchorhynchus annulatus, Tylenchulus spp., e.g. Tylenchulus semipenetrans, Xiphinema spp., e.g. Xiphinema index.

In addition, it is possible to control, from the sub-kingdom of the Protozoa, the order of the Coccidia, for example Eimeria spp.

The compounds of the formula (I) can, as the case may be, at certain concentrations or application rates, also be used as herbicides, safeners, growth regulators or agents to improve plant properties, as microbicides or gametocides, for example as fungicides, antimycotics, bactericides, virucides (including agents against viroids) or as agents against MLO (mycoplasma-like organisms) and RLO (rickettsia-like organisms). They can, as the case may be, also be used as intermediates or precursors for the synthesis of other active ingredients.

### Formulations

The present invention further relates to formulations and use forms prepared therefrom as pesticides, for example drench, drip and spray liquors, comprising at least one compound of the formula (I). Optionally, the use forms comprise further pesticides and/or adjuvants which improve action, such as penetrants, e.g. vegetable oils, for example rapeseed oil, sunflower oil, mineral oils, for example paraffin oils, alkyl esters of vegetable fatty acids, for example rapeseed oil methyl ester or soya oil methyl ester, or alkanol alkoxylates and/or spreaders, for example alkylsiloxanes and/or salts, for example organic or inorganic ammonium or phosphonium salts, for example ammonium sulphate or diammonium hydrogenphosphate and/or retention promoters, for example dioctyl sulphosuccinate or hydroxypropylguar polymers and/or humectants, for example glycerol and/or fertilizers, for example ammonium-, potassium- or phosphorus-containing fertilizers.

Customary formulations are, for example, water-soluble liquids (SL), emulsion concentrates (EC), emulsions in water (EW), suspension concentrates (SC, SE, FS, OD), water-dispersible granules (WG), granules (GR) and capsule concentrates (CS); these and further possible formulation types are described, for example, by Crop Life International and in Pesticide Specifications, Manual on development and use of FAO and WHO specifications for pesticides, FAO Plant Production and Protection Papers—173, prepared by the FAO/WHO Joint Meeting on Pesticide Specifications, 2004, ISBN: 9251048576. The formulations, in addition to one or more compounds of the formula (I), optionally comprise further agrochemically active ingredients.

Preference is given to formulations or use forms comprising auxiliaries, for example extenders, solvents, spontaneity promoters, carriers, emulsifiers, dispersants, frost protection agents, biocides, thickeners and/or further auxiliaries, for example adjuvants. An adjuvant in this context is a component which enhances the biological effect of the formulation, without the component itself having any biological effect. Examples of adjuvants are agents which promote retention, spreading, attachment to the leaf surface or penetration.

These formulations are prepared in a known way, for example by mixing the compounds of the formula (I) with auxiliaries, for example extenders, solvents and/or solid carriers and/or other auxiliaries, for example surfactants. The formulations are produced either in suitable facilities or else before or during application.

The auxiliaries used may be substances suitable for imparting special properties, such as certain physical, technical and/or biological properties, to the formulation of the compounds of the formula (I), or to the use forms prepared from these formulations (for example ready-to-use pesticides such as spray liquors or seed dressing products).

Suitable extenders are, for example, water, polar and nonpolar organic chemical liquids, for example from the classes of the aromatic and non-aromatic hydrocarbons (such as paraffins, alkylbenzenes, alkylnaphthalenes, chlorobenzenes), the alcohols and polyols (which, if appropriate, may also be substituted, etherified and/or esterified), the ketones (such as acetone, cyclohexanone), esters (including fats and oils) and (poly)ethers, the simple and substituted amines, amides, lactams (such as N-alkylpyrrolidones) and lactones, the sulphones and sulphoxides (such as dimethyl sulphoxide).

If the extender utilized is water, it is also possible to use, for example, organic solvents as auxiliary solvents. Useful liquid solvents are essentially: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, and water.

In principle, it is possible to use all suitable solvents. Examples of suitable solvents are aromatic hydrocarbons, such as xylene, toluene or alkylnaphthalenes, chlorinated aromatic or aliphatic hydrocarbons, such as chlorobenzene, chloroethylene or methylene chloride, aliphatic hydrocarbons, such as cyclohexane, paraffins, mineral oil fractions, mineral and vegetable oils, alcohols, such as methanol, ethanol, isopropanol, butanol or glycol and their ethers and esters, ketones such as acetone, methyl ethyl ketone, methyl isobutyl ketone or cyclohexanone, strongly polar solvents, such as dimethyl sulphoxide, and also water.

In principle, it is possible to use all suitable carriers. Useful carriers especially include: for example ammonium salts and ground natural minerals such as kaolins, clays, talc, chalk, quartz, attapulgite, montmorillonite or diatomaceous earth, and ground synthetic minerals such as finely divided silica, alumina and natural or synthetic silicates, resins, waxes and/or solid fertilizers. It is likewise possible to use mixtures of such carriers. Useful carriers for granules include: for example crushed and fractionated natural rocks such as calcite, marble, pumice, sepiolite, dolomite, and synthetic granules of inorganic and organic flours, and also granules of organic material such as sawdust, paper, coconut shells, maize cobs and tobacco stalks.

It is also possible to use liquefied gaseous extenders or solvents. Especially suitable are those extenders or carriers which are gaseous at standard temperature and under atmospheric pressure, for example aerosol propellants such as halogenated hydrocarbons, and also butane, propane, nitrogen and carbon dioxide.

Examples of emulsifiers and/or foam formers, dispersants or wetting agents having ionic or nonionic properties or mixtures of these surface-active substances are salts of polyacrylic acid, salts of lignosulphonic acid, salts of phenolsulphonic acid or naphthalenesulphonic acid, polycondensates of ethylene oxide with fatty alcohols or with fatty acids or with fatty amines, with substituted phenols (preferably alkylphenols or arylphenols), salts of sulphosuccinic esters, taurine derivatives (preferably alkyl taurates), phosphoric esters of polyethoxylated alcohols or phenols, fatty acid esters of polyols, and derivatives of the compounds containing sulphates, sulphonates and phosphates, for example alkylaryl polyglycol ethers, alkylsulphonates, alkyl sulphates, arylsulphonates, protein hydrolysates, lignosulphite waste liquors and methylcellulose. The presence of a surfactant is advantageous if one of the compounds of the formula (I) and/or one of the inert carriers is insoluble in water and if the application takes place in water.

Further auxiliaries which may be present in the formulations and the use forms derived therefrom are dyes such as inorganic pigments, for example iron oxide, titanium oxide and Prussian Blue, and organic dyes such as alizarin dyes, azo dyes and metal phthalocyanine dyes, and nutrients and trace nutrients such as salts of iron, manganese, boron, copper, cobalt, molybdenum and zinc.

Additional components which may be present are stabilizers, such as cold stabilizers, preservatives, antioxidants, light stabilizers, or other agents which improve chemical and/or physical stability. Foam generators or antifoams may also be present.

In addition, the formulations and the use forms derived therefrom may also comprise, as additional auxiliaries, stickers such as carboxymethylcellulose and natural and synthetic polymers in the form of powders, granules or lattices, such as gum arabic, polyvinyl alcohol and polyvinyl acetate, or else natural phospholipids such as cephalins and lecithins and synthetic phospholipids. Further auxiliaries may be mineral and vegetable oils.

It is possible if appropriate for still further auxiliaries to be present in the formulations and the use forms derived therefrom. Examples of such additives are fragrances, protective colloids, binders, adhesives, thickeners, thixotropic agents, penetrants, retention promoters, stabilizers, sequestrants, complexing agents, humectants, spreaders. In general, the compounds of the formula (I) can be combined with any solid or liquid additive commonly used for formulation purposes.

Useful retention promoters include all those substances which reduce dynamic surface tension, for example dioctyl sulphosuccinate, or increase viscoelasticity, for example hydroxypropylguar polymers.

Useful penetrants in the present context are all those substances which are typically used to improve the penetration of active agrochemical ingredients into plants. Penetrants are defined in this context by their ability to penetrate from the (generally aqueous) application liquor and/or from the spray coating into the cuticle of the plant and hence increase the mobility of the active ingredients in the cuticle. The method described in the literature (Baur et al., 1997, Pesticide Science 51, 131-152) can be used for determining this property. Examples include alcohol alkoxylates such as coconut fatty ethoxylate (10) or isotridecyl ethoxylate (12), fatty acid esters, for example rapeseed oil methyl ester or soya oil methyl ester, fatty amine alkoxylates, for example tallowamine ethoxylate (15), or ammonium and/or phosphonium salts, for example ammonium sulphate or diammonium hydrogenphosphate.

The formulations preferably comprise between 0.00000001% and 98% by weight of the compound of the formula (I), more preferably between 0.01% and 95% by weight of the compound of the formula (I), most preferably between 0.5% and 90% by weight of the compound of the formula (I), based on the weight of the formulation.

The content of the compound of the formula (I) in the use forms prepared from the formulations (in particular pesticides) may vary within wide ranges. The concentration of the compound of the formula (I) in the use forms may typically be between 0.00000001% and 95% by weight of the compound of the formula (I), preferably between 0.00001% and 1% by weight, based on the weight of the use form. Application is accomplished in a customary manner appropriate for the use forms.

### Mixtures

The compounds of the formula (I) can also be used in a mixture with one or more suitable fungicides, bactericides, acaricides, molluscicides, nematicides, insecticides, microbiological agents, beneficial organisms, herbicides, fertilizers, bird repellents, phytotonics, sterilants, safeners, semiochemicals and/or plant growth regulators, in order thus, for example, to broaden the spectrum of action, prolong the period of action, enhance the rate of action, prevent repellency or prevent evolution of resistance. In addition, active ingredient combinations of this kind can improve plant growth and/or tolerance to abiotic factors, for example high or low temperatures, to drought or to elevated water content or soil salinity. It is also possible to improve flowering and fruiting performance, optimize germination capacity and root development, facilitate harvesting and improve yields, influence maturation, improve the quality and/or the nutritional value of the harvested products, prolong storage life and/or improve the processability of the harvested products.

In addition, the compounds of the formula (I) may be present in a mixture with other active ingredients or semiochemicals such as attractants and/or bird repellents and/or plant activators and/or growth regulators and/or fertilizers. Likewise, the compounds of the formula (I) can be used in mixtures with agents to improve plant properties, for example growth, yield and quality of the harvested material.

In a particular embodiment according to the invention, the compounds of the formula (I) are present in formulations or in the use forms prepared from these formulations in a mixture with further compounds, preferably those as described below.

If one of the compounds mentioned below can occur in different tautomeric forms, these forms are also included even if not explicitly mentioned in each case.

### Insecticides/Acaricides/Nematicides

The active ingredients specified here with their common names are known and are described for example in “The Pesticide Manual”, 16th ed., British Crop Protection Council 2012, or can be searched for on the Internet (e.g. http//www.alanwood.net/pesticides).

(1) Acetylcholinesterase (AChE) inhibitors, for example carbamates, e.g. alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or organophosphates, e.g. acephate, azamethiphos, azinphos-ethyl, azinphos-methyl, cadusafos, chlorethoxyfos, chlorfenvinphos, chlormephos, chloropyrifos, chloropyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-gated chloride channel antagonists, for example cyclodiene-organochlorines, e.g. chlordane and endosulfan or phenylpyrazoles (fiproles), e.g. ethiprole and fipronil.

(3) Sodium channel modulators/voltage-gated sodium channel blockers such as, for example, pyrethroids, e.g. acrinathrin, allethrin, d-cis-trans allethrin, d-trans allethrin, bifenthrin, bioallethrin, bioallethrin S-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans-isomer], deltamethrin, empenthrin [(EZ)-(1R)-isomer], esfenvalerate, etofenprox, fenpropathrin, fenvalerate, flucythrinate, flumethrin, tau-fluvalinate, halfenprox, imiprothrin, kadethrin, permethrin, phenothrin [(1R)-trans-isomer], prallethrin, pyrethrins (pyrethrum), resmethrin, silafluofen, tefluthrin, tetramethrin, tetramethrin [(1R)-isomer)], tralomethrin and transfluthrin or DDT or methoxychlor.

(4) Nicotinergic acetylcholine receptor (nAChR) agonists, for example neonicotinoids, e.g. acetamiprid, clothianidin, dinotefuran, imidacloprid, nitenpyram, thiacloprid and thiamethoxam or nicotine or sulfoxaflor or flupyradifurone.

(5) Nicotinergic acetylcholine receptor (nAChR) allosteric activators, for example spinosyns, e.g. spinetoram and spinosad.

(6) Chloride channel activators, for example avermectins/milbemycins, e.g. abamectin, emamectin benzoate, lepimectin and milbemectin.

(7) Juvenile hormone mimics, for example, juvenile hormone analogues, e.g. hydroprene, kinoprene and methoprene or fenoxycarb or pyriproxyfen.

(8) Active ingredients having unknown or nonspecific mechanisms of action, for example alkyl halides, e.g. methyl bromide and other alkyl halides; or chloropicrine or sulphuryl fluoride or borax or tartar emetic.

(9) Selective antifeedants, e.g. pymetrozine or flonicamid.

(10) Mite growth inhibitors, e.g. clofentezine, hexythiazox and diflovidazin or etoxazole.

(11) Microbial disruptors of insect midgut membranes, e.g. Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins: Cry1Ab, Cry1Ac, Cry1Fa, Cry2Ab, mCry3A, Cry3Ab, Cry3Bb, Cry34/35Ab1.

(12) Oxidative phosphorylation inhibitors, ATP disruptors, for example diafenthiuron or organotin compounds, e.g. azocyclotin, cyhexatin and fenbutatin oxide or propargite or tetradifon.

(13) Uncouplers of oxidative phosphorylation via disruption of the H proton gradient, for example chlorfenapyr, DNOC and sulfluramid.

(14) Nicotinic acetylcholine receptor antagonists, for example bensultap, cartap hydrochloride, thiocyclam, and thiosultap-sodium.

(15) Inhibitors of chitin biosynthesis, type 0, for example bistrifluron, chlorfluazuron, diflubenzuron, flucycloxuron, flufenoxuron, hexaflumuron, lufenuron, novaluron, noviflumuron, teflubenzuron and triflumuron.

(16) Inhibitors of chitin biosynthesis, type 1, for example buprofezin.

(17) Moulting disruptors (especially for Diptera, i.e. dipterans), for example cyromazine.

(18) Ecdysone receptor agonists, for example chromafenozide, halofenozide, methoxyfenozide and tebufenozide.

(19) Octopaminergic agonists, for example amitraz.

(20) Complex III electron transport inhibitors, for example hydramethylnon or acequinocyl or fluacrypyrim.

(21) Complex I electron transport inhibitors, for example METI acaricides, e.g. fenazaquin, fenpyroximate, pyrimidifen, pyridaben, tebufenpyrad and tolfenpyrad or rotenone (Derris).

(22) Voltage-gated sodium channel blockers, for example indoxacarb or metaflumizone.

(23) Inhibitors of acetyl-CoA carboxylase, for example tetronic and tetramic acid derivatives, e.g. spirodiclofen, spiromesifen and spirotetramat.

(24) Complex IV electron transport inhibitors, for example phosphines, e.g. aluminium phosphide, calcium phosphide, phosphine and zinc phosphide or cyanide.

(25) Complex II electron transport inhibitors, for example cyenopyrafen and cyflumetofen.

(28) Ryanodine receptor effectors, for example diamides, e.g. chlorantraniliprole, cyantraniliprole and flubendiamide.

Further active ingredients having an unknown or unclear mechanism of action, for example afidopyropen, afoxolaner, azadirachtin, benclothiaz, benzoximate, bifenazate, bromopropylate, chinomethionat, cryolite, cyclaniliprole, cycloxaprid, cyhalodiamide, dicloromezotiaz, dicofol, diflovidazin, flometoquin, fluensulfone, flufenerim, flufenoxystrobin, flufiprole, fluhexafon, fluopyram, fluralaner, fufenozide, guadipyr, heptafluthrin, imidaclothiz, iprodione, meperfluthrin, paichongding, pyflubumide, pyridalyl, pyrifluquinazon, pyriminostrobin, tetramethylfluthrin, tetraniliprole, tetrachlorantraniliprole, tioxazafen, triflumezopyrim and iodomethane; and additionally preparations based on Bacillus firmus (1-1582, BioNeem, Votivo), and the following known active compounds: 1-{2-fluoro-4-methyl-5-[(2,2,2-trifluoroethyl)sulphinyl]phenyl}-3-(trifluoromethyl)-1H-1,2,4-triazole-5-amine (known from WO2006/043635), {1′-[(2E)-3-(4-chlorophenyl)prop-2-en-1-yl]-5-fluorospiro[indole-3,4′-piperidin]-1(2H)-yl}(2-chloropyridin-4-yl)methanone (known from WO2003/106457), 2-chloro-N-[2-{1-[(2E)-3-(4-chlorophenyl)prop-2-en-1-yl]piperidin-4-yl}-4-(trifluoromethyl)phenyl]isonicotinamide (known from WO2006/003494), 3-(2,5-dimethylphenyl)-4-hydroxy-8-methoxy-1,8-diazaspiro[4.5]dec-3-en-2-one (known from WO2009/049851), 3-(2,5-dimethylphenyl)-8-methoxy-2-oxo-1,8-diazaspiro[4.5]dec-3-en-4-ylethyl carbonate (known from WO2009/049851), 4-(but-2-yn-1-yloxy)-6-(3,5-dimethylpiperidin-1-yl)-5-fluoropyrimidine (known from WO2004/099160), 4-(but-2-yn-1-yloxy)-6-(3-chlorophenyl)pyrimidine (known from WO2003/076415), PF1364 (CAS Reg. No. 1204776-60-2), methyl 2-[2-({[3-bromo-1-(3-chloropyridin-2-yl)-1H-pyrazol-5-yl]carbonyl}amino)-5-chloro-3-methylbenzoyl]-2-methylhydrazinecarboxylate (known from WO2005/085216), methyl 2-[2-({[3-bromo-1-(3-chloropyridin-2-yl)-1H-pyrazol-5-yl]carbonyl}amino)-5-cyano-3-methylbenzoyl]-2-ethylhydrazinecarboxylate (known from WO2005/085216), methyl 2-[2-{([3-bromo-1-(3-chloropyridin-2-yl)-1H-pyrazol-5-yl]carbonyl}amino)-5-cyano-3-methylbenzoyl]-2-methylhydrazinecarboxylate (known from WO2005/085216), methyl 2-[3,5-dibromo-2-({[3-bromo-1-(3-chloropyridin-2-yl)-1H-pyrazol-5-yl]carbonyl}amino)benzoyl]-2-ethylhydrazinecarboxylate (known from WO2005/085216), N-[2-(5-amino-1,3,4-thiadiazol-2-yl)-4-chloro-6-methylphenyl]-3-bromo-1-(3-chloropyridin-2-yl)-1H-pyrazole-5-carboxamiide (known from CN102057925), 8-chloro-N-[(2-chloro-5-methoxyphenyl)sulphonyl]-6-(trifluoromethyl)imidazo[1,2-a]pyridine-2-carboxamide (known from WO2010/129500), 4-[5-(3,5-dichlorophenyl)-5-(trifluoromethyl)-4,5-dihydro-1,2-oxazol-3-yl]-2-methyl-N-(1-oxidothietan-3-yl)benzamide (known from WO2009/080250), N-[(2E)-1-[(6-chloropyridin-3-yl)methyl]pyridin-2(1H)-ylidene]-2,2,2-trifluoroacetamide (known from WO2012/029672), 1-[(2-chloro-1,3-thiazol-5-yl)methyl]-4-oxo-3-phenyl-4H-pyrido[1,2-a]pyrimidin-1-ium-2-olate (known from WO2009/099929), 1-[(6-chloropyridin-3-yl)methyl]-4-oxo-3-phenyl-4H-pyrido[1,2-a]pyrimidin-1-ium-2-olate (known from WO2009/099929), 4-(3-{2,6-dichloro-4-[(3,3-dichloroprop-2-en-1-yl)oxy]phenoxy}propoxy)-2-methoxy-6-(trifluoromethyl)pyrimidine (known from CN101337940), N-[2-(tert-butylcarbamoyl)-4-chloro-6-methylphenyl]-1-(3-chloropyridin-2-yl)-3-(fluoromethoxy)-1H-pyrazole-5-carboxamide (known from WO2008/134969, 3-[benzoyl(methyl)amino]-N-[2-bromo-4-[1,2,2,2-tetrafluoro-1-(trifluoromethyl)ethyl]-6-(trifluoromethyl)phenyl]-2-fluorobenzamide (known from WO 2010018714), butyl [2-(2,4-dichlorophenyl)-3-oxo-4-oxaspiro[4.5]dec-1-en-1-yl]carbonate (known from CN102060818), 4-[5-(3,5-dichlorophenyl)-5-(trifluoromethyl)-4H-isoxazol-3-yl]-N—[(Z)-methoxyiminomethyl]-2-methylbenzamide (known from WO2007/026965), (3E)-3-[1-[(6-chloro-3-pyridyl)methyl]-2-pyridylidene]-1,1,1-trifluoropropan-2-one (known from WO2013/144213, N-(methylsulphonyl)-6-[2-(pyridin-3-yl)-1,3-thiazol-5-yl]pyridine-2-carboxamide (known from WO2012/000896), N-[3-(benzylcarbamoyl)-4-chlorophenyl]-1-methyl-3-(pentafluoroethyl)-4-(trifluoromethyl)-1H-pyrazole-5-carboxamide (known from WO2010/051926).

### Fungicides

The active ingredients specified herein by their common name are known and described, for example, in the “Pesticide Manual” or on the Internet (for example: http://www.alanwood.net/pesticides).

All the fungicidal mixing components listed in classes (1) to (15) may optionally form salts with corresponding bases or acids if suitable functional groups are present. In addition, the fungicidal mixing components listed in classes (1) to (15) also include tautomeric forms if tautomerism is possible.

1) ergosterol biosynthesis inhibitors, for example (1.01) aldimorph, (1.02) azaconazole, (1.03) bitertanol, (1.04) bromuconazole, (1.05) cyproconazole, (1.06) diclobutrazole, (1.07) difenoconazole, (1.08) diniconazole, (1.09) diniconazole-M, (1.10) dodemorph, (1.11) dodemorph acetate, (1.12) epoxiconazole, (1.13) etaconazole, (1.14) fenarimol, (1.15) fenbuconazole, (1.16) fenhexamide, (1.17) fenpropidin, (1.18) fenpropimorph, (1.19) fluquinconazole, (1.20) flurprimidol, (1.21) flusilazole, (1.22) flutriafol, (1.23) furconazole, (1.24) furconazole-cis, (1.25) hexaconazole, (1.26) imazalil, (1.27) imazalil sulphate, (1.28) imibenconazole, (1.29) ipconazole, (1.30) metconazole, (1.31) myclobutanil, (1.32) naftifine, (1.33) nuarimol, (1.34) oxpoconazole, (1.35) paclobutrazole, (1.36) pefurazoate, (1.37) penconazole, (1.38) piperalin, (1.39) prochloraz, (1.40) propiconazole, (1.41) prothioconazole, (1.42) pyributicarb, (1.43) pyrifenox, (1.44) quinconazole, (1.45) simeconazole, (1.46) spiroxamine, (1.47) tebuconazole, (1.48) terbinafin, (1.49) tetraconazole, (1.50) triadimefon, (1.51) triadimenol, (1.52) tridemorph, (1.53) triflumizole, (1.54) triforin, (1.55) triticonazole, (1.56) uniconazole, (1.57) uniconazole-p, (1.58) viniconazole, (1.59) voriconazole, (1.60) 1-(4-chlorophenyl)-2-(1H-1,2,4-triazol-1-yl)cycloheptanol, (1.61) methyl 1-(2,2-dimethyl-2,3-dihydro-1H-inden-1-yl)-1H-imidazole-5-carboxylate, (1.62) N′-{5-(difluoromethyl)-2-methyl-4-[3-(trimethylsilyl)propoxy]phenyl}-N-ethyl-N-methylimidoformamide, (1.63) N-ethyl-N-methyl-N′-{2-methyl-5-(trifluoromethyl)-4-[3-(trimethylsilyl)propoxy]phenyl}imidoformamide, (1.64) O-[1-(4-methoxyphenoxy)-3,3-dimethylbutan-2-yl]-1H-imidazole-1-carbothioate, (1.65) pyrisoxazole, (1.66) 2-{[3-(2-chlorophenyl)-2-(2,4-difluorophenyl)oxiran-2-yl]methyl}-2,4-dihydro-3H-1,2,4-triazole-3-thione, (1.67) 1-{[3-(2-chlorophenyl)-2-(2,4-difluorophenyl)oxiran-2-yl]methyl}-1H-1,2,4-triazol-5-ylthiocyanate, (1.68) 5-(allylsulphanyl)-1-{[3-(2-chlorophenyl)-2-(2,4-difluorophenyl)oxiran-2-yl]methyl}-1H-1,2,4-triazole, (1.69) 2-[1-(2,4-dichlorophenyl)-5-hydroxy-2,6,6-trimethylheptan-4-yl]-2,4-dihydro-3H-1,2,4-triazole-3-thione, (1.70) 2-{[rel(2R,3S)-3-(2-chorophenyl)-2-(2,4-difluorophenyl)oxiran-2-yl]methyl}-2,4-dihydro-3H-1,2,4-triazole-3-thione, (1.71) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.72) 1-{[rel(2R,3S)-3-(2-chlorophenyl)-2-(2,4-difluorophenyl)oxiran-2-yl]methyl}-1H-1,2,4-triazol-5-ylthiocyanate, (1.73) 1-{[rel(2R,3R)-3-(2-chlorophenyl)-2-(2,4-difluorophenyl)oxiran-2-yl]methyl}-1H-1,2,4-triazol-5-ylthiocyanate, (1.74) 5-(allylsulphanyl)-1-{[rel(2R,3S)-3-(2-chlorophenyl)-2-(2,4-difluorophenyl)oxiran-2-yl]methyl}-1H-1,2,4-triazole, (1.75) 5-(allylsuphanyl)-1-{[rel(2R,3R)-3-(2-chlorophenyl)-2-(2,4-difluorophenyl)oxiran-2-yl]methyl}-1H-1,2,4-triazole, (1.76) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.77) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.78) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.79) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.80) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.81) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.82) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.83) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.84) 2-[4-(4-chlorophenoxy)-2-(trifluoromethyl)phenyl]-1-(1H-1,2,4-triazol-1-yl)propan-2-ol, (1.85) 2-[4-(4-chlorophenoxy)-2-(trifluoromethyl)phenyl]-1-(1H-1,2,4-triazol-1-yl)butan-2-ol, (1.86) 2-[4-(4-chlorophenoxy)-2-(trifluoromethyl)phenyl]-1-(1H-1,2,4-triazol-1-yl)pentan-2-ol, (1.87) 2-[2-chloro-4-(4-chlorophenoxy)phenyl]-1-(1H-1,2,4-triazol-1-yl)butan-2-ol, (1.88) 2-[2-chloro-4-(2,4-dichlorophenoxy)phenyl]-1-(1H-1,2,4-triazol-1-yl)propan-2-ol, (1.89) (2R)-2-(1-chlorocyclopropyl)-4-[(1R)-2,2-dichlorocyclopropyl]-1-(1H-1,2,4-triazol-1-yl)butan-2-ol, (1.90) (2R)-2-(1-chlorocyclopropyl)-4-[(1S)-2,2-dichlorocyclopropyl]-1-(1H-1,2,4-triazol-1-yl)butan-2-ol, (1.91) (2S)-2-(1-chlorocyclopropyl)-4-[(1S)-2,2-dichlorocyclopropyl]-1-(1H-1,2,4-triazol-1-yl)butan-2-ol, (1.92) (2S)-2-(1-chlorocyclopropyl)-4-[(1R)-2,2-dichlorocyclopropyl]-1-(1H-1,2,4-triazol-1-yl)butan-2-ol, (1.93) (1 S,2R,5R)-5-(4-chlorobenzyl)-2-(chloromethyl)-2-methyl-1-(1H-1,2,4-triazol-1-ylmethyl)cyclopentanol, (1.94) (1R,2S,5S)-5-(4-chlorobenzyl)-2-(chloromethyl)-2-methyl-1-(1H-1,2,4-triazol-1-ylmethyl)cyclopentanol, (1.95) 5-(4-chlorobenzyl)-2-(chloromethyl)-2-methyl-1-(1H-1,2,4-triazol-1-ylmethyl)cyclopentanol.

2) Inhibitors of complex I or II of the respiratory chain, for example (2.01) bixafen, (2.02) boscalid, (2.03) carboxin, (2.04) diflumetorim, (2.05) fenfuram, (2.06) fluopyram, (2.07) flutolanil, (2.08) fluxapyroxad, (2.09) furametpyr, (2.10) furmecyclox, (2.11) isopyrazam (mixture of syn-epimeric racemate 1RS,4SR,9RS and anti-epimeric racemate 1RS,4SR,9SR), (2.12) isopyrazam (anti-epimeric racemate 1RS,4SR,9SR), (2.13) isopyrazam (anti-epimeric enantiomer 1R,4S,9S), (2.14) isopyrazam (anti-epimeric enantiomer 1S,4R,9R), (2.15) isopyrazam (syn-epimeric racemate 1RS,4SR,9RS), (2.16) isopyrazam (syn-epimeric enantiomer 1R,4S,9R), (2.17) isopyrazam (syn-epimeric enantiomer 1S,4R,9S), (2.18) mepronil, (2.19) oxycarboxin, (2.20) penflufen, (2.21) penthiopyrad, (2.22) sedaxane, (2.23) thifluzamide, (2.24) 1-methyl-N-[2-(1,1,2,2-tetrafluoroethoxy)phenyl]-3-(trifluoromethyl)-1H-pyrazole-4-carboxamide, (2.25) 3-(difluoromethyl)-1-methyl-N-[2-(1,1,2,2-tetrafluoroethoxy)phenyl]-1H-pyrazole-4-carboxamide, (2.26) 3-(difluoromethyl)-N-[4-fluoro-2-(1,1,2,3,3,3-hexafluoropropoxy)phenyl]-1-methyl-1H-pyrazole-4-carboxamide, (2.27) N-[1-(2,4-dichlorophenyl)-1-methoxypropan-2-yl]-3-(difluoromethyl)-1-methyl-1H-pyrazole-4-carboxamide, (2.28) 5,8-difluoro-N-[2-(2-fluoro-4-{[4-(trifluoromethyl)pyridin-2-yl]oxy}phenyl)ethyl]quinazolin-4-amine, (2.29) benzovindiflupyr, (2.30) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.31) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.32) 3-(difluoromethyl)-1-methyl-N-(1,1,3-trimethyl-2,3-dihydro-1H-inden-4-yl)-1H-pyrazole-4-carboxamide, (2.33) 1,3,5-trimethyl-N-(1,1,3-trimethyl-2,3-dihydro-1H-inden-4-yl)-1H-pyrazole-4-carboxamide, (2.34) 1-methyl-3-(trifluoromethyl)-N-(1,1,3-trimethyl-2,3-dihydro-1H-inden-4-yl)-1H-pyrazole-4-carboxamide, (2.35) 1-methyl-3-(trifluoromethyl)-N-[(3R)-1,1,3-trimethyl-2,3-dihydro-1H-inden-4-yl]-1H-pyrazole-4-carboxamide, (2.36) 1-methyl-3-(trifluoromethyl)-N-[(3S)-1,1,3-trimethyl-2,3-dihydro-1H-inden-4-yl]-1H-pyrazole-4-carboxamide, (2.37) 3-(difluoromethyl)-1-methyl-N-[(3S)-1,1,3-trimethyl-2,3-dihydro-1H-inden-4-yl]-1H-pyrazole-4-carboxamide, (2.38) 3-(difluoromethyl)-1-methyl-N-[(3R)-1,1,3-trimethyl-2,3-dihydro-1H-inden-4-yl]-1H-pyrazole-4-carboxamide, (2.39) 1,3,5-trimethyl-N-[(3R)-1,1,3-trimethyl-2,3-dihydro-1H-inden-4-yl]-1H-pyrazole-4-carboxamide, (2.40) 1,3,5-trimethyl-N-[(3S)-1,1,3-trimethyl-2,3-dihydro-1H-inden-4-yl]-1H-pyrazole-4-carboxamide, (2.41) benodanil, (2.42) 2-chloro-N-(1,1,3-trimethyl-2,3-dihydro-1H-inden-4-yl)pyridine-3-carboxamide, (2.43) isofetamide, (2.44) 1-methyl-3-(trifluoromethyl)-N-[2′-(trifluoromethyl)biphenyl-2-yl]-1H-pyrazole-4-carboxamide, (2.45) N-(4′-chlorobiphenyl-2-yl)-3-(difluoromethyl)-1-methyl-1H-pyrazole-4-carboxamide, (2.46) N-(2′,4′-dichlorobiphenyl-2-yl)-3-(difluoromethyl)-1-methyl-1H-pyrazole-4-carboxamide, (2.47) 3-(difluoromethyl)-1-methyl-N-[4′-(trifluoromethyl)biphenyl-2-yl]-1H-pyrazole-4-carboxamide, (2.48) N-(2′,5′-difluorobiphenyl-2-yl)-1-methyl-3-(trifluoromethyl)-1H-pyrazole-4-carboxamide, (2.49) 3-(difluoromethyl)-1-methyl-N-[4′-(prop-1-yn-1-yl)biphenyl-2-yl]-1H-pyrazole-4-carboxamide, (2.50) 5-fluoro-1,3-dimethyl-N-[4′-(prop-1-yn-1-yl)biphenyl-2-yl]-1H-pyrazole-4-carboxamide, (2.51) 2-chloro-N-[4′-(prop-1-yn-1-yl)biphenyl-2-yl]nicotinamide, (2.52) 3-(difluoromethyl)-N-[4′-(3,3-dimethylbut-1-yn-1-yl)biphenyl-2-yl]-1-methyl-1H-pyrazole-4-carboxamide, (2.53) N-[4′-(3,3-dimethylbut-1-yn-1-yl)biphenyl-2-yl]-5-fluoro-1,3-dimethyl-1H-pyrazole-4-carboxamide, (2.54) 3-(difluoromethyl)-N-(4′-ethynylbiphenyl-2-yl)-1-methyl-1H-pyrazole-4-carboxamide, (2.55) N-(4′-ethynylbiphenyl-2-yl)-5-fluoro-1,3-dimethyl-1H-pyrazole-4-carboxamide, (2.56) 2-chloro-N-(4′-ethynylbiphenyl-2-yl)nicotinamide, (2.57) 2-chloro-N-[4′-(3,3-dimethylbut-1-yn-1-yl)biphenyl-2-yl]nicotinamide, (2.58) 4-(difluoromethyl)-2-methyl-N-[4′-(trifluoromethyl)biphenyl-2-yl]-1,3-thiazole-5-carboxamide, (2.59) 5-fluoro-N-[4′-(3-hydroxy-3-methylbut-1-yn-1-yl)biphenyl-2-yl]-1,3-dimethyl-1H-pyrazole-4-carboxamide, (2.60) 2-chloro-N-[4′-(3-hydroxy-3-methylbut-1-yn-1-yl)biphenyl-2-yl]nicotinamide, (2.61) 3-(difluoromethyl)-N-[4′-(3-methoxy-3-methylbut-1-yn-1-yl)biphenyl-2-yl]-1-methyl-1H-pyrazole-4-carboxamide, (2.62) 5-fluoro-N-[4′-(3-methoxy-3-methylbut-1-yn-1-yl)biphenyl-2-yl]-1,3-dimethyl-1H-pyrazole-4-carboxamide, (2.63) 2-chloro-N-[4′-(3-methoxy-3-methylbut-1-yn-1-yl)biphenyl-2-yl]nicotinamide, (2.64) 1,3-dimethyl-N-(1,1,3-trimethyl-2,3-dihydro-1H-inden-4-yl)-1H-pyrazole-4-carboxamide, (2.65) 1,3-dimethyl-N-[(3R)-1,1,3-trimethyl-2,3-dihydro-1H-inden-4-yl]-1H-pyrazole-4-carboxamide, (2.66) 1,3-dimethyl-N-[(3S)-1,1,3-trimethyl-2,3-dihydro-1H-inden-4-yl]-1H-pyrazole-4-carboxamide, (2.67) 3-(difluoromethyl)-N-methoxy-1-methyl-N-[1-(2,4,6-trichlorophenyl)propan-2-yl]-1H-pyrazole-4-carboxamide, (2.68) 3-(difluoromethyl)-N-(7-fluoro-1,1,3-trimethyl-2,3-dihydro-1H-inden-4-yl)-1-methyl-1H-pyrazole-4-carboxamide, (2.69) 3-(difluoromethyl)-N-[(3R)-7-fluoro-1,1,3-trimethyl-2,3-dihydro-1H-inden-4-yl]-1-methyl-1H-pyrazole-4-carboxamide, (2.70) 3-(difluoromethyl)-N-[(3S)-7-fluoro-1,1,3-trimethyl-2,3-dihydro-1H-inden-4-yl]-1-methyl-1H-pyrazole-4-carboxamide.

3) Inhibitors of complex III of the respiratory chain, for example (3.01) ametoctradin, (3.02) amisulbrom, (3.03) azoxystrobin, (3.04) cyazofamide, (3.05) coumethoxystrobin, (3.06) coumoxystrobin, (3.07) dimoxystrobin, (3.08) enoxastrobin, (3.09) famoxadon, (3.10) fenamidon, (3.11) flufenoxystrobin, (3.12) fluoxastrobin, (3.13) kresoxim-methyl, (3.14) metominostrobin, (3.15) orysastrobin, (3.16) picoxystrobin, (3.17) pyraclostrobin, (3.18) pyrametostrobin, (3.19) pyraoxystrobin, (3.20) pyribencarb, (3.21) triclopyricarb, (3.22) trifloxystrobin, (3.23) (2E)-2-(2-{[6-(3-chloro-2-methylphenoxy)-5-fluoropyrimidin-4-yl]oxy}phenyl)-2-(methoxyimino)-N-methylacetamide, (3.24) (2E)-2-(methoxyimino)-N-methyl-2-(2-{[({(1E)-1-[3-(trifluoromethyl)phenyl]ethylidene}amino)oxy]methyl}phenyl)acetamide, (3.25) (2E)-2-(methoxyimino)-N-methyl-2-{2-[(E)-({1-[3-(trifluoromethyl)phenyl]ethoxy}imino)methyl]phenyl}acetamide, (3.26) (2E)-2-{2-[({[(1E)-1-(3-{[(E)-1-fluoro-2-phenylvinyl]oxy}phenyl)ethylidene]amino)}oxy)methyl]phenyl}-2-(methoxyimino)-N-methylacetamide, (3.27) fenaminostrobin, (3.28) 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, (3.29) methyl (2E)-2-{2-[({cyclopropyl[(4-methoxyphenyl)imino]methyl}sulphanyl)methyl]phenyl}-3-methoxyacrylate, (3.30) N-(3-ethyl-3,5,5-trimethylcyclohexyl)-3-formamido-2-hydroxybenzamide, (3.31) 2-{2-[(2,5-dimethylphenoxy)methyl]phenyl}-2-methoxy-N-methylacetamide, (3.32) 2-{2-[(2,5-dimethylphenoxy)methyl]phenyl}-2-methoxy-N-methylacetamide, (3.33) (2E,3Z)-5-{[1-(4-chlorophenyl)-1H-pyrazol-3-yl]oxy}-2-(methoxyimino)-N,3-dimethylpent-3-enamide.

4) Mitosis and cell division inhibitors, for example (4.01) benomyl, (4.02) carbendazim, (4.03) chlorfenazole, (4.04) diethofencarb, (4.05) ethaboxam, (4.06) fluopicolide, (4.07) fuberidazole, (4.08) pencycuron, (4.09) thiabendazole, (4.10) thiophanate-methyl, (4.11) thiophanate, (4.12) zoxamide, (4.13) 5-chloro-7-(4-methylpiperidin-1-yl)-6-(2,4,6-trifluorophenyl)[1,2,4]triazolo[1,5-a]pyrimidine, (4.14) 3-chloro-5-(6-chloropyridin-3-yl)-6-methyl-4-(2,4,6-trifluorophenyl)pyridazine.

5) Compounds capable of having multisite action, for example (5.01) Bordeaux mixture, (5.02) captafol, (5.03) captan, (5.04) chlorothalonil, (5.05) copper hydroxide, (5.06) copper naphthenate, (5.07) copper oxide, (5.08) copper oxychloride, (5.09) copper(2+) sulphate, (5.10) dichlofluanid, (5.11) dithianon, (5.12) dodine, (5.13) dodine free base, (5.14) ferbam, (5.15) fluorofolpet, (5.16) folpet, (5.17) guazatine, (5.18) guazatine acetate, (5.19) iminoctadine, (5.20) iminoctadine albesilate, (5.21) iminoctadine triacetate, (5.22) mancopper, (5.23) mancozeb, (5.24) maneb, (5.25) metiram, (5.26) metiram zinc, (5.27) oxine-copper, (5.28) propamidine, (5.29) propineb, (5.30) sulphur and sulphur preparations including calcium polysulphide, (5.31) thiram, (5.32) tolylfluanid, (5.33) zineb, (5.34) ziram, (5.35) anilazine.

6) Compounds capable of inducing host defence, for example (6.01) acibenzolar-S-methyl, (6.02) isotianil, (6.03) probenazole, (6.04) tiadinil, (6.05) laminarin.

7) Amino acid and/or protein biosynthesis inhibitors, for example (7.01) andoprim, (7.02) blasticidin-S, (7.03) cyprodinil, (7.04) kasugamycin, (7.05) kasugamycin hydrochloride hydrate, (7.06) mepanipyrim, (7.07) pyrimethanil, (7.08) 3-(5-fluoro-3,3,4,4-tetramethyl-3,4-dihydroisoquinolin-1-yl)quinoline, (7.09) oxytetracycline, (7.10) streptomycin.

8) ATP production inhibitors, for example (8.01) fentin acetate, (8.02) fentin chloride, (8.03) fentin hydroxide, (8.04) silthiofam.

9) Cell wall synthesis inhibitors, for example (9.01) benthiavalicarb, (9.02) dimethomorph, (9.03) flumorph, (9.04) iprovalicarb, (9.05) mandipropamide, (9.06) polyoxins, (9.07) polyoxorim, (9.08) validamycin A, (9.09) valifenalate, (9.10) polyoxin B, (9.11) (2E)-3-(4-tert-butylphenyl)-3-(2-chloropyridin-4-yl)-1-(morpholin-4-yl)prop-2-en-1-one, (9.12) (2Z)-3-(4-tert-butylphenyl)-3-(2-chloropyridin-4-yl)-1-(morpholin-4-yl)prop-2-en-1-one.

10) Lipid and membrane synthesis inhibitors, for example (10.01) biphenyl, (10.02) chloroneb, (10.03) dicloran, (10.04) edifenphos, (10.05) etridiazole, (10.06) iodocarb, (10.07) iprobenfos, (10.08) isoprothiolane, (10.09) propamocarb, (10.10) propamocarb hydrochloride, (10.11) prothiocarb, (10.12) pyrazophos, (10.13) quintozene, (10.14) tecnazene, (10.15) tolclofos-methyl.

11) Melanin biosynthesis inhibitors, for example (11.01) carpropamide, (11.02) diclocymet, (11.03) fenoxanil, (11.04) phthalide, (11.05) pyroquilon, (11.06) tricyclazole, (11.07) 2,2,2-trifluoroethyl (3-methyl-1-[(4-methylbenzoyl)amino]butan-2-yl carbamate.

12) Nucleic acid synthesis inhibitors, for example (12.01) benalaxyl, (12.02) benalaxyl-M (kiralaxyl), (12.03) bupirimate, (12.04) clozylacon, (12.05) dimethirimol, (12.06) ethirimol, (12.07) furalaxyl, (12.08) hymexazole, (12.09) metalaxyl, (12.10) metalaxyl-M (mefenoxam), (12.11) ofurace, (12.12) oxadixyl, (12.13) oxolinic acid, (12.14) octhilinone.

13) Signal transduction inhibitors, for example (13.01) chlozolinate, (13.02) fenpiclonil, (13.03) fludioxonil, (13.04) iprodione, (13.05) procymidone, (13.06) quinoxyfen, (13.07) vinclozolin, (13.08) proquinazid.

14) Compounds capable of acting as uncouplers, for example (14.01) binapacryl, (14.02) dinocap, (14.03) ferimzone, (14.04) fluazinam, (14.05) meptyldinocap.

15) Further compounds, for example (15.001) benthiazole, (15.002) bethoxazin, (15.003) capsimycin, (15.004) carvone, (15.005) quinomethionate, (15.006) pyriofenone (chlazafenone), (15.007) cufraneb, (15.008) cyflufenamide, (15.009) cymoxanil, (15.010) cyprosulfamide, (15.011) dazomet, (15.012) debacarb, (15.013) dichlorophen, (15.014) diclomezin, (15.015) difenzoquat, (15.016) difenzoquat metilsulfate, (15.017) diphenylamine, (15.018) Ecomate, (15.019) fenpyrazamine, (15.020) flumetover, (15.021) fluoroimide, (15.022) flusulfamide, (15.023) flutianil, (15.024) fosetyl-aluminium, (15.025) fosetyl-calcium, (15.026) fosetyl-sodium, (15.027) hexachlorobenzene, (15.028) irumamycin, (15.029) methasulfocarb, (15.030) methyl isothiocyanate, (15.031) metrafenone, (15.032) mildiomycin, (15.033) natamycin, (15.034) nickel dimethyldithiocarbamate, (15.035) nitrothal-isopropyl, (15.036) oxamocarb, (15.037) oxyfenthiin, (15.038) pentachlorophenol and salts, (15.039) phenothrin, (15.040) phosphorous acid and salts thereof, (15.041) propamocarb-fosetylate, (15.042) propanosin-sodium, (15.043) pyrimorph, (15.044) pyrrolnitrin, (15.045) tebufloquin, (15.046) tecloftalam, (15.047) tolnifanid, (15.048) triazoxide, (15.049) trichlamide, (15.050) zarilamide, (15.051) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl 2-methylpropanoate, (15.052) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.053) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.054) oxathiapiproline, (15.055) 1-(4-methoxyphenoxy)-3,3-dimethylbutan-2-yl 1H-imidazole-1-carboxylate, (15.056) 2,3,5,6-tetrachloro-4-(methylsulphonyl)pyridine, (15.057) 2,3-dibutyl-6-chlorothieno[2,3-d]pyrimidin-4(3H)-one, (15.058) 2,6-dimethyl-1H,5H-[1,4]dithiino[2,3-c:5,6-c′]dipyrrole-1,3,5,7(2H,6H)-tetrone, (15.059) 2-[5-methyl-3-(trifluoromethyl)-1H-pyrazol-1-yl]-1-(4-{4-[(5R)-5-phenyl-4,5-dihydro-1,2-oxazol-3-yl]-1,3-thiazol-2-yl}piperidin-1-yl)ethanone, (15.060) 2-[5-methyl-3-(trifluoromethyl)-1H-pyrazol-1-yl]-1-(4-{4-[(5S)-5-phenyl-4,5-dihydro-1,2-oxazol-3-yl]-1,3-thiazol-2-yl}piperidin-1-yl)ethanone, (15.061) 2-[5-methyl-3-(trifluoromethyl)-1H-pyrazol-1-yl]-1-{4-[4-(5-phenyl-4,5-dihydro-1,2-oxazol-3-yl)-1,3-thiazol-2-yl]piperidin-1-yl}ethanone, (15.062) 2-butoxy-6-iodo-3-propyl-4H-chromen-4-one, (15.063) 2-chloro-5-[2-chloro-1-(2,6-difluoro-4-methoxyphenyl)-4-methyl-1H-imidazol-5-yl]pyridine, (15.064) 2-phenylphenol and salts, (15.065) 3-(4,4,5-trifluoro-3,3-dimethyl-3,4-dihydroisoquinolin-1-yl)quinoline, (15.066) 3,4,5-trichloropyridine-2,6-dicarbonitrile, (15.067) 3-chloro-5-(4-chlorophenyl)-4-(2,6-difluorophenyl)-6-methylpyridazine, (15.068) 4-(4-chlorophenyl)-5-(2,6-difluorophenyl)-3,6-dimethylpyridazine, (15.069) 5-amino-1,3,4-thiadiazole-2-thiol, (15.070) 5-chloro-N′-phenyl-N-(prop-2-yn-1-yl)thiophene-2-sulphonohydrazide, (15.071) 5-fluoro-2-[(4-fluorobenzyl)oxy]pyrimidin-4-amine, (15.072) 5-fluoro-2-[(4-methylbenzyl)oxy]pyrimidin-4-amine, (15.073) 5-methyl-6-octyl[1,2,4]triazolo[1,5-a]pyrimidin-7-amine, (15.074) ethyl (2Z)-3-amino-2-cyano-3-phenylacrylate, (15.075) N′-(4-{[3-(4-chlorobenzyl)-1,2,4-thiadiazol-5-yl]oxy}-2,5-dimethylphenyl)-N-ethyl-N-methylimidoformamide, (15.076) N-(4-chlorobenzyl)-3-[3-methoxy-4-(prop-2-yn-1-yloxy)phenyl]propanamide, (15.077) N-[4 chlorophenyl)(cyano)methyl]-3-[3-methoxy-4-(prop-2-yn-1-yloxy)phenyl]propanamide, (15.078) N-[(5-bromo-3-chloropyridin-2-yl)methyl]-2,4-dichloronicotinamide, (15.079) N-[1-(5-brom)-3-chloropyridin-2-yl)ethyl]-2,4-dichloronicotinamide, (15.080) N-[1-(5-bromo-3-chloropyridin-2-yl)ethyl]-2-fluoro-4-iodonicotinamide, (15.081) N-{(E)-[(cyclopropylmethoxy)imino][6-(difluoromethoxy)-2,3-difluorophenyl]methyl}-2-phenylacetamide, (15.082) N—{(Z)-[(cyclopropylmethoxy)imino][6-(difluoromethoxy)-2,3-difluorophenyl]methyl}-2-phenylacetamide, (15.083) N′-{4-[(3-tert-butyl-4-cyano-1,2-thiazol-5-yl)oxy]-2-chloro-5-methylphenyl}-N-ethyl-N-methylimidoformamide, (15.084) N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, (15.085) N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide, (15.086) N-methyl-2-(1-{[5-methyl-3-(trifluoromethyl)-1H-pyrazol-1-yl]acetyl}piperidin-4-yl)-N-[(1S)-1,2,3,4-tetrahydronaphthalen-1-yl]-1,3-thiazole-4-carboxamide, (15.087) pentyl {6-[({[(1-methyl-1H-tetrazol-5-yl)(phenyl)methylene]amino}oxy)methyl]pyridin-2-yl}carbamate, (15.088) phenazine-1-carboxylic acid, (15.089) quinolin-8-ol, (15.090) quinolin-8-ol sulphate (2:1), (15.091) tert-butyl {6-[({[(1-methyl-1H-tetrazol-5-yl)(phenyl)methylene]amino}oxy)methyl]pyridin-2-yl}carbamate, (15.092) (5-bromo-2-methoxy-4-methylpyridin-3-yl)(2,3,4-trimethoxy-6-methylphenyl)methanone, (15.093) N-[2-(4-{[3-(4-chlorophenyl)prop-2-yn-1-yl]oxy}-3-methoxyphenyl)ethyl]-N2-(methylsulphonyl)valinamide, (15.094) 4-oxo-4-[(2-phenylethyl)amino]butanoic acid, (15.095) but-3-yn-1-yl {6-[({[(Z)-(1-methyl-1H-tetrazol-5-yl)(phenyl)methylene]amino}oxy)methyl]pyridin-2-yl}carbamate, (15.096) 4-amino-5-fluoropyrimidin-2-ol (tautomeric form: 4-amino-5-fluoropyrimidin-2(1H)-one), (15.097) propyl 3,4,5-trihydroxybenzoate, (15.098) [3-(4-chloro-2-fluorophenyl)-5-(2,4-difluorophenyl)-1,2-oxazol-4-yl](pyridin-3-yl)methanol, (15.099) (S)-[3-(4-chloro-2-fluorophenyl)-5-(2,4-difluorophenyl)-1,2-oxazol-4-yl](pyridin-3-yl)methanol, (15.100) (R)-[3-(4-chloro-2-fluorophenyl)-5-(2,4-difluorophenyl)-1,2-oxazol-4-yl](pyridin-3-yl)methanol, (15.101) 2-fluoro-6-(trifluoromethyl)-N-(1,1,3-trimethyl-2,3-dihydro-1H-inden-4-yl)benzamide, (15.102) 2-(6-benzylpyridin-2-yl)quinazoline, (15.103) 2-[6-(3-fluoro-4-methoxyphenyl)-5-methylpyridin-2-yl]quinazoline, (15.104) 3-(4,4-difluoro-3,3-dimethyl-3,4-dihydroisoquinolin-1-yl)quinoline, (15.105) abscisic acid, (15.106) N′-[5-bromo-6-(2,3-dihydro-1H-inden-2-yloxy)-2-methylpyridin-3-yl]-N-ethyl-N-methylimidoformamide, (15.107) N′-{5-bromo-6-[1-(3,5-difluorophenyl)ethoxy]-2-methylpyridin-3-yl}-N-ethyl-N-methylimidoformamide, (15.108) N′-{5-bromo-6-[(1R)-1-(3,5-difluorophenyl)ethoxy]-2-methylpyridin-3-yl}-N-ethyl-N-methylimidoformamide, (15.109) N′-{5-bromo-6-[(1S)-1-(3,5-difluorophenyl)ethoxy]-2-methylpyridin-3-yl}-N-ethyl-N-methylimidoformamide, (15.110) N′-{5-bromo-6-[(cis-4-isopropylcyclohexyl)oxy]-2-methylpyridin-3-yl}-N-ethyl-N-methylimidoformamide, (15.111) N-{5-bromo-6-[(trans-4-isopropylcyclohexyl)oxy]-2-methylpyridin-3-yl}-N-ethyl-N-methylimidoformamide, (15.112) N-cyclopropyl-3-(difluoromethyl)-5-fluoro-N-(2-isopropylbenzyl)-1-methyl-1H-pyrazole-4-carboxamiide, (15.113) N-cyclopropyl-N-(2-cyclopropylbenzyl)-3-(difluoromethyl)-5-fluoro-1-methyl-1H-pyrazole-4-carboxamide, (15.114) N-(2-tert-butylbenzyl)-N-cyclopropyl-3-(difluoromethyl)-5-fluoro-1-methyl-1H-pyrazole-4-carboxamide, (15.115) N-(5-chloro-2-ethylbenzyl)-N-cyclopropyl-3-(difluoromethyl)-5-fluoro-1-methyl-1H-pyrazole-4-carboxamide, (15.116) N-(5-chloro-2-isopropylbenzyl)-N-cyclopropyl-3-(difluoromethyl)-5-fluoro-1-methyl-1H-pyrazole-4-carboxamide, (15.117) N-cyclopropyl-3-(difluoromethyl)-N-(2-ethyl-5-fluorobenzyl)-5-fluoro-1-methyl-1H-pyrazole-4-carboxamide, (15.118) N-cyclopropyl-3-(difluoromethyl)-5-fluoro-N-(5-fluoro-2-isopropylbenzyl)-1-methyl-1H-pyrazole-4-carboxamide, (15.119) N-cyclopropyl-N-(2-cyclopropyl-5-fluorobenzyl)-3-(difluoromethyl)-5-fluoro-1-methyl-1H-pyrazole-4-carboxamide, (15.120) N-(2-cyclopentyl-5-fluorobenzyl)-N-cyclopropyl-3-(difluoromethyl)-5-fluoro-1-methyl-1H-pyrazole-4-carboxamide, (15.121) N-cyclopropyl-3-(difluoromethyl)-5-fluoro-N-(2-fluoro-6-isopropylbenzyl)-1-methyl-1H-pyrazole-4-carboxamide, (15.122) N-cyclopropyl-3-(difluoromethyl)-N-(2-ethyl-5-methylbenzyl)-5-fluoro-1-methyl-1H-pyrazole-4-carboxamiide, (15.123) N-cyclopropyl-3-(difluoromethyl)-5-fluoro-N-(2-isopropyl-5-methylbenzyl)-1-methyl-1H-pyrazole-4-carboxamiide, (15.124) N-cyclopropyl-N-(2-cyclopropyl-5-methylbenzyl)-3-(difluoromethyl)-5-fluoro-1-methyl-1H-pyrazole-4-carboxamide, (15.125) N-(2-tert-butyl-5-methylbenzyl)-N-cyclopropyl-3-(difluoromethyl)-5-fluoro-1-methyl-1H-pyrazole-4-carboxamide, (15.126) N-[5-chloro-2-(trifluoromethyl)benzyl]-N-cyclopropyl-3-(difluoromethyl)-5-fluoro-1-methyl-1H-pyrazole-4-carboxamide, (15.127) N-cyclopropyl-3-(difluoromethyl)-5-fluoro-1-methyl-N-[5-methyl-2-(trifluoromethyl)benzyl]-1H-pyrazole-4-carboxamide, (15.128) N-[2-chloro-6-(trifluoromethyl)benzyl]-N-cyclopropyl-3-(difluoromethyl)-5-fluoro-1-methyl-1H-pyrazole-4-carboxamide, (15.129) N-[3-chloro-2-fluoro-6-(trifluoromethyl)benzyl]-N-cyclopropyl-3-(difluoromethyl)-5-fluoro-1-methyl-1H-pyrazole-4-carboxamide, (15.130) N-cyclopropyl-3-(difluoromethyl)-N-(2-ethyl-4,5-dimethylbenzyl)-5-fluoro-1-methyl-1H-pyrazole-4-carboxamide, (15.131) N-cyclopropyl-3-(difluoromethyl)-5-fluoro-N-(2-isopropylbenzyl)-1-methyl-1H-pyrazole-4-carbothioamide, (15.132) N′-(2,5-dimethyl-4-phenoxyphenyl)-N-ethyl-N-methylimidoformamide, (15.133) N′-{4-[(4,5-dichloro-1,3-thiazol-2-yl)oxy]-2,5-dimethylphenyl}-N-ethyl-N-methylimidoformamide, (15.134) N-(4-chloro-2,6-difluorophenyl)-4(2-chloro-4-fluorophenyl)-1,3-dimethyl-1H-pyrazol-5-amine, (15.135) 9-fluoro-2,2-dimethyl-5-(quinolin-3-yl)-2,3-dihydro-1,4-benzoxazepine, (15.136) 2-{2-fluoro-6-[(8-fluoro-2-methylquinolin-3-yl)oxy]phenyl}propan-2-ol, (15.137) 2-{2-[(7,8-difluoro-2-methylquinolin-3-yl)oxy]-6-fluorophenyl}propan-2-ol, (15.138) 4-(2-chloro-4-fluorophenyl)-N-(2-fluorophenyl)-1,3-dimethyl-1H-pyrazol-5-amine, (15.139) 4-(2-chloro-4-fluorophenyl)-N-(2,6-difluorophenyl)-1,3-dimethyl-1H-pyrazol-5-amine, (15.140) 4-(2-chloro-4-fluorophenyl)-N-(2-chloro-6-fluorophenyl)-1,3-dimethyl-1H-pyrazol-5-amine, (15.141) 4-(2-bromo-4-fluorophenyl)-N-(2-chloro-6-fluorophenyl)-1,3-dimethyl-1H-pyrazol-5-amine, (15.142) N-(2-bromo-6-fluorophenyl)-4-(2-chloro-4-fluorophenyl)-1,3-dimethyl-1H-pyrazol-5-amine, (15.143) 4-(2-bromo-4-fluorophenyl)-N-(2-bromophenyl)-1,3-dimethyl-1H-pyrazol-5-amine, (15.144) 4-(2-bromo-4-fluorophenyl)-N-(2-bromo-6-fluorophenyl)-1,3-dimethyl-1H-pyrazol-5-amine, (15.145) 4-(2-bromo-4-fluorophenyl)-N-(2-chlorophenyl)-1,3-dimethyl-1H-pyrazol-5-amine, (15.146) N-(2-bromophenyl)-4-(2-chloro-4-fluorophenyl)-1,3-dimethyl-1H-pyrazol-5-amine, (15.147) 4-(2-chloro-4-fluorophenyl)-N-(2-chlorophenyl)-1,3-dimethyl-1H-pyrazol-5-amine, (15.148) 4-(2-bromo-4-fluorophenyl)-N-(2,6-difluorophenyl)-1,3-dimethyl-1H-pyrazol-5-amine, (15.149) 4-(2-bromo-4-fluorophenyl)-N-(2-fluorophenyl)-1,3-dimethyl-1H-pyrazol-5-amine, (15.150) N′-(4-{3-[(difluoromethyl)sulphanyl]phenoxy}-2,5-dimethylphenyl)-N-ethyl-N-methylimidoformamide, (15.151) N′-(2,5-dimethyl-4-{3-[(1,1,2,2-tetrafluoroethyl)sulphanyl]phenoxy}phenyl)-N-ethyl-N-methylimidoformamide, (15.152) N′-(2,5-dimethyl-4-{3-[(2,2,2-trifluoroethyl)sulphanyl]phenoxy}phenyl)-N-ethyl-N-methylimidoformamide, (15.153) N′-(2,5-dimethyl-4-{(3-[(2,2,3,3-tetrafluoropropyl)sulphanyl]phenoxy}phenyl)-N-ethyl-N-methylimidoformamide, (15.154) N′-(2,5-dimethyl-4-{3-[(pentafluoroethyl)sulphanyl]phenoxy}phenyl)-N-ethyl-N-methylimidoformamide, (15.155) N′-(4-{[3-(difluoromethoxy)phenyl]sulphanyl}-2,5-dimethylphenyl)-N-ethyl-N-methylimidoformamide, (15.156) N′-(2,5-dimethyl-4-{[3-(1,1,2,2-tetrafluoroethoxy)phenyl]sulphanyl}phenyl)-N-ethyl-N-methylimidoformamide, (15.157) N′-(2,5-dimethyl-4-{[3-(2,2,2-trifluoroethoxy)phenyl]sulphanyl}phenyl)-N-ethyl-N-methylimidoformamide, (15.158) N′-(2,5-dimethyl-4-{[3-(2,2,3,3-tetrafluoropropoxy)phenyl]sulphanyl}phenyl)-N-ethyl-N-methylimidoformamide, (15.159) N′-(2,5-dimethyl-4-{[3-(pentafluoroethoxy)phenyl]sulphanyl}phenyl)-N-ethyl-N-methylimidoformamide, (15.160) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.161) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.162) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.163) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulphonate, (15.164) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}I-3-chiorophenyl methanesulphonate, (15.165) 2-[3,5-bis(difluoromethyl)-1H-pyrazol-1-yl]-1-[4-(4-{(5S)-5-[2-(prop-2-yn-1-yloxy)phenyl]-4,5-dihydro-1,2-oxazol-3-yl}-1,3-thiazol-2-yl)piperidin-1-yl]ethanone, (15.166) 2-[3,5-bis(difluoromethyl)-1H-pyrazol-1-yl]-1-[4-(4-{(5R)-5-[2-(prop-2-yn-1-yloxy)phenyl]-4,5-dihydro-1,2-oxazol-3-yl}-1,3-thiazol-2-yl)piperidin-1-yl]ethanone, (15.167) 2-[3,5-bis(difluoro-methyl)-1H-pyrazol-1-yl]-1-[4-(4-{(5S)-5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.168) 2-[3,5-bis(difluoromethyl)-1H-pyrazol-1-yl]-1-[4-(4-{(5R)-5-[2-fluoro-6-(prop-2-yn-1-yloxy)phenyl]-4,5-dihydro-1,2-oxazol-3-yl}-1,3-thiazol-2-yl)piperidin-1-yl]ethanone, (15.169) 2-[3,5-bis(difluoromethyl)-1H-pyrazol-1-yl]-1-[4-(4-4(5S)-5-[2-chloro-6-(prop-2-yn-1-yloxy)phenyl]-4,5-dihydro-1,2-oxazol-3-yl)-1,3-thiazol-2-yl)piperidin-1-yl]ethanone, (15.170) 2-[3,5-bis(difluoromethyl)-1H-pyrazol-1-yl]-1-[4-(4-{(5R)-5-[2-chloro-6-(prop-2-yn-1-yloxy)phenyl]-4,5-dihydro-1,2-oxazol-3-yl}-1,3-thiazol-2-yl)piperidin-1-yl]ethanone, (15.171) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulphonate, (15.172) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulphonate, (15.173) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chiorophenyl methanesulphonate, (15.174) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulphonate.

### Biological Pesticides as Mixing Components

The compounds of the formula (I) can be combined with biological pesticides.

Biological pesticides especially include bacteria, fungi, yeasts, plant extracts and products formed by microorganisms, including proteins and secondary metabolites.

Biological pesticides include bacteria such as spore-forming bacteria, root-colonizing bacteria and bacteria which act as biological insecticides, fungicides or nematicides.

Examples of such bacteria which are used or can be used as biological pesticides are:

Bacillus amyloliquefaciens, strain FZB42 (DSM 231179), or Bacillus cereus, especially B. cereus strain CNCM 1-1562 or Bacillus firmus, strain 1-1582 (Accession number CNCM I-1582) or Bacillus pumilus, especially strain GB34 (Accession No. ATCC 700814) and strain QST2808 (Accession No. NRRL B-30087), or Bacillus subtilis, especially strain GB03 (Accession No. ATCC SD-1397), or Bacillus subtilis strain QST713 (Accession No. NRRL B-21661) or Bacillus subtilis strain OST 30002 (Accession No. NRRL B-50421) Bacillus thuringiensis, especially B. thuringiensis subspecies israelensis (serotype H-14), strain AM65-52 (Accession No. ATCC 1276), or B. thuringiensis subsp. aizawai, especially strain ABTS-1857 (SD-1372), or B. thuringiensis subsp. kurstaki strain HD-1, or B. thuringiensis subsp. tenebrionis strain NB 176 (SD-5428), Pasteuria penetrans, Pasteuria spp. (Rotylenchulus reniformis nematode)-PR3 (Accession Number ATCC SD-5834), Streptomyces microflavus strain AQ6121 (=QRD 31.013, NRRL B-50550), Streptomyces galbus strain AQ 6047 (Accession Number NRRL 30232).

Examples of fungi and yeasts which are used or can be used as biological pesticides are:

Beauveria bassiana, in particular strain ATCC 74040, Coniothyrium minitans, in particular strain CON/M/91-8 (Accession No. DSM-9660), Lecanicillium spp., in particular strain HRO LEC 12, Lecanicillium lecanii, (formerly known as Verticillium lecanii), in particular strain KV01, Metarhizium anisopliae, in particular strain F52 (DSM3884/ATCC 90448), Metschnikowia fructicola, in particular strain NRRL Y-30752, Paecilomyces fumosoroseus (new: Isaria fumosorosea), in particular strain IFPC 200613, or strain Apopka 97 (Accession No. ATCC 20874), Paecilomyces lilacinus, in particular P. lilacinus strain 251 (AGAL 89/030550), Talaromyces flavus, in particular strain V117b, Trichoderma atroviride, in particular strain SCI (Accession Number CBS 122089), Trichoderma harzianum, in particular T. harzianum rifai T39 (Accession Number CNCM 1-952).

Examples of viruses which are used or can be used as biological pesticides are:

Adoxophyes orana (summer fruit tortrix) granulosis virus (GV), Cydia pomonella (codling moth) granulosis virus (GV), Helicoverpa armigera (cotton bollworm) nuclear polyhedrosis virus (NPV), Spodoptera exigua (beet armyworm) mNPV, Spodoptera frugiperda (fall armyworm) mNPV, Spodoptera littoralis (African cotton leafworm) NPV.

Also included are bacteria and fungi which are added as ‘inoculant’ to plants or plant parts or plant organs and which, by virtue of their particular properties, promote plant growth and plant health. Examples include:

Agrobacterium spp., Azorhizobium caulinodans, Azospirillum spp., Azotobacter spp., Bradyrhizobium spp., Burkholderia spp., especially Burkholderia cepacia (formerly known as Pseudomonas cepacia), Gigaspora spp., or Gigaspora monosporum, Glomus spp., Laccaria spp., Lactobacillus buchneri, Paraglomus spp., Pisolithus tinctorus, Pseudomonas spp., Rhizobium spp., especially Rhizobium trifolii, Rhizopogon spp., Scleroderma spp., Suillus spp., Streptomyces spp.

Examples of plant extracts and products formed by microorganisms, including proteins and secondary metabolites, which are used or can be used as biological pesticides are:

Allium sativum, Artemisia absinthium, azadirachtin, Biokeeper WP, Cassia nigricans, Celastrus angulatus, Chenopodium anthelminticum, chitin, Armour-Zen, Dryopteris filix-mas, Equisetum arvense, Fortune Aza, Fungastop, Heads Up (Chenopodium quinoa saponin extract), pyrethrum/pyrethrins, Quassia amara, Quercus, Quillaja, Regalia, “Requiem™ Insecticide”, rotenone, ryania/ryanodine, Symphytum officinale, Tanacetum vulgare, thymol, Triact 70, TriCon, Tropaeulum majus, Urtica dioica, Veratrin, Viscum album, Brassicaceae extract, especially oilseed rape powder or mustard powder.

### Safeners as Mixing Components

The compounds of the formula (I) can be combined with safeners, for example benoxacor, cloquintocet (-mexyl), cyometrinil, cyprosulfamide, dichlormid, fenchlorazole (-ethyl), fenclorim, flurazole, fluxofenim, furilazole, isoxadifen (-ethyl), mefenpyr (-diethyl), naphthalic anhydride, oxabetrinil, 2-methoxy-N-({4-[(methylcarbamoyl)amino]phenyl}sulphonyl)benzamide (CAS 129531-12-0), 4-(dichloroacetyl)-1-oxa-4-azaspiro[4.5]decane (CAS 71526-07-3), 2,2,5-trimethyl-3-(dichloroacetyl)-1,3-oxazolidine (CAS 52836-31-4).

### Plants and Plant Parts

All plants and plant parts can be treated in accordance with the invention. Plants are understood here to mean all plants and populations of plants, such as desirable and undesirable wild plants or crop plants (including naturally occurring crop plants), for example cereals (wheat, rice, triticale, barley, rye, oats), maize, soya bean, potato, sugar beet, sugar cane, tomatoes, peas and other vegetable species, cotton, tobacco, oilseed rape, and also fruit plants (with the fruits apples, pears, citrus fruits and grapes). Crop plants may be plants which can be obtained by conventional breeding and optimization methods or by biotechnological and genetic engineering methods or combinations of these methods, including the transgenic plants and including the plant cultivars which are protectable or non-protectable by plant breeders' rights. Plant parts shall be understood to mean all parts and organs of the plants above and below ground, such as shoot, leaf, flower and root, examples given being leaves, needles, stalks, stems, flowers, fruit bodies, fruits and seeds, and also roots, tubers and rhizomes. Plant parts also include harvested material and vegetative and generative propagation material, for example cuttings, tubers, rhizomes, slips and seeds.

The inventive treatment of the plants and parts of plants with the compounds of the formula (I) is effected directly or by allowing them to act on the surroundings, habitat or storage space thereof by the customary treatment methods, for example by dipping, spraying, evaporating, fogging, scattering, painting on, injecting, and, in the case of propagation material, especially in the case of seeds, also by applying one or more coats.

As already mentioned above, it is possible to treat all plants and parts thereof in accordance with the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering methods, if appropriate in combination with conventional methods (genetically modified organisms), and parts thereof are treated. The term “parts” or “parts of plants” or “plant parts” has been explained above. Particular preference is given in accordance with the invention to treating plants of the respective commercially customary plant cultivars or those that are in use. Plant cultivars are understood to mean plants having new properties (“traits”) which have been grown by conventional breeding, by mutagenesis or by recombinant DNA techniques. They may be cultivars, varieties, biotypes or genotypes.

### Transgenic Plants, Seed Treatment and Integration Events

The preferred transgenic plants or plant cultivars (those obtained by genetic engineering) which are to be treated in accordance with the invention include all plants which, through the genetic modification, received genetic material which imparts particular advantageous useful properties (“traits”) to these plants. Examples of such properties are better plant growth, increased tolerance to high or low temperatures, increased tolerance to drought or to levels of water or soil salinity, enhanced flowering performance, easier harvesting, accelerated ripening, higher harvest yields, higher quality and/or higher nutritional value of the harvested products, better capability for storage and/or processability of the harvested products. Further and particularly emphasized examples of such properties are increased resistance of the plants against animal and microbial pests, such as insects, arachnids, nematodes, mites, slugs and snails, owing, for example, to toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof), and also increased resistance of the plants against phytopathogenic fungi, bacteria and/or viruses caused, for example, by systemic acquired resistance (SAR), systemin, phytoalexins, elicitors and resistance genes and correspondingly expressed proteins and toxins, and also increased tolerance of the plants to certain herbicidally active ingredients, for example imidazolinones, sulphonylureas, glyphosates or phosphinothricin (for example the “PAT” gene). The genes which impart the desired properties (“traits”) in question may also be present in combinations with one another in the transgenic plants. Examples of transgenic plants include the important crop plants, such as cereals (wheat, rice, triticale, barley, rye, oats), maize, soya beans, potatoes, sugar beet, sugar cane, tomatoes, peas and other types of vegetable, cotton, tobacco, oilseed rape and also fruit plants (with the fruits apples, pears, citrus fruits and grapes), particular emphasis being given to maize, soya beans, wheat, rice, potatoes, cotton, sugar cane, tobacco and oilseed rape. Properties (“traits”) which are particularly emphasized are the increased resistance of the plants to insects, arachnids, nematodes and slugs and snails.

### Crop Protection—Types of Treatment

The plants and plant parts are treated with the compounds of the formula (I) directly or by action on their surroundings, habitat or storage space using customary treatment methods, for example by dipping, spraying, atomizing, irrigating, evaporating, dusting, fogging, broadcasting, foaming, painting, spreading-on, injecting, watering (drenching), drip irrigating and, in the case of propagation material, in particular in the case of seed, additionally by dry seed treatment, liquid seed treatment, slurry treatment, by incrusting, by coating with one or more coats, etc. It is furthermore possible to apply the compounds of the formula (I) by the ultra-low volume method or to inject the application form or the compound of the formula (I) itself into the soil.

A preferred direct treatment of the plants is foliar application, i.e. compounds of the formula (I) are applied to the foliage, where treatment frequency and the application rate should be adjusted according to the level of infestation with the pest in question.

In the case of systemically active compounds, the compounds of the formula (I) also access the plants via the root system. The plants are then treated by the action of the compounds of the formula (I) on the habitat of the plant. This can be accomplished, for example, by drenching, or by mixing into the soil or the nutrient solution, meaning that the locus of the plant (e.g. soil or hydroponic systems) is impregnated with a liquid form of the compounds of the formula (I), or by soil application, meaning that the compounds of the formula (I) are introduced in solid form (e.g. in the form of granules) into the locus of the plants. In the case of paddy rice crops, this can also be accomplished by metering the compound of the formula (I) in a solid application form (for example as granules) into a flooded paddy field.

### Seed Treatment

The control of animal pests by the treatment of the seed of plants has long been known and is the subject of constant improvements. Nevertheless, the treatment of seed entails a series of problems which cannot always be solved in a satisfactory manner. Thus, it is desirable to develop methods for protecting the seed and the germinating plant which dispense with, or at least reduce considerably, the additional application of pesticides during storage, after sowing or after emergence of the plants. It is additionally desirable to optimize the amount of active ingredient used so as to provide optimum protection for the seed and the germinating plant from attack by animal pests, but without damage to the plant itself by the active ingredient used. In particular, methods for the treatment of seed should also take account of the intrinsic insecticidal or nematicidal properties of pest-resistant or -tolerant transgenic plants in order to achieve optimal protection of the seed and the germinating plant with a minimum expenditure on pesticides.

The present invention therefore in particular also relates to a method for the protection of seed and germinating plants from attack by pests, by treating the seed with one of the compounds of the formula (I). The method according to the invention for protecting seed and germinating plants against attack by pests further comprises a method in which the seed is treated simultaneously in one operation or sequentially with a compound of the formula (I) and a mixing component. It further also comprises a method where the seed is treated at different times with a compound of the formula (I) and a mixing component.

The invention also relates to the use of the compounds of the formula (I) for the treatment of seed for protecting the seed and the resulting plant from animal pests.

The invention further relates to seed which has been treated with a compound of the formula (I) for protection from animal pests. The invention also relates to seed which has been treated simultaneously with a compound of the formula (I) and a mixing component. The invention further relates to seed which has been treated at different times with a compound of the formula (I) and a mixing component. In the case of seed which has been treated at different times with a compound of the formula (I) and a mixing component, the individual substances may be present on the seed in different layers. In this case, the layers comprising a compound of the formula (I) and a mixing component may optionally be separated by an intermediate layer. The invention also relates to seed in which a compound of the formula (I) and a mixing component have been applied as part of a coating or as a further layer or further layers in addition to a coating.

The invention further relates to seed which, after the treatment with a compound of the formula (I), is subjected to a film-coating process to prevent dust abrasion on the seed.

One of the advantages encountered with a systemically acting compound of the formula (I) is the fact that, by treating the seed, not only the seed itself but also the plants resulting therefrom are, after emergence, protected against animal pests. In this way, the immediate treatment of the crop at the time of sowing or shortly thereafter can be dispensed with.

A further advantage is that the treatment of the seed with a compound of the formula (I) can enhance germination and emergence of the treated seed.

It is likewise considered to be advantageous that compounds of the formula (I) can especially also be used for transgenic seed.

Furthermore, compounds of the formula (I) can be employed in combination with compositions of signalling technology, leading to better colonization by symbionts such as, for example, rhizobia, mycorrhizae and/or endophytic bacteria or fungi, and/or to optimized nitrogen fixation.

The compounds of the formula (I) are suitable for protection of seed of any plant variety which is used in agriculture, in the greenhouse, in forests or in horticulture. More particularly, this includes seed of cereals (for example wheat, barley, rye, millet and oats), maize, cotton, soya beans, rice, potatoes, sunflowers, coffee, tobacco, canola, oilseed rape, beet (for example sugar beet and fodder beet), peanuts, vegetables (for example tomatoes, cucumbers, beans, cruciferous vegetables, onions and lettuce), fruit plants, lawns and ornamental plants. Of particular significance is the treatment of the seed of cereals (such as wheat, barley, rye and oats), maize, soya beans, cotton, canola, oilseed rape and rice.

As already mentioned above, the treatment of transgenic seed with a compound of the formula (I) is also of particular importance. This involves the seed of plants which generally contain at least one heterologous gene which controls the expression of a polypeptide having insecticidal and/or nematicidal properties in particular. The heterologous genes in transgenic seed may originate from microorganisms such as Bacillus, Rhizobium, Pseudomonas, Serratia, Trichoderma, Clavibacter, Glomus or Gliocladium. The present invention is particularly suitable for the treatment of transgenic seed containing at least one heterologous gene originating from Bacillus sp. The heterologous gene is more preferably derived from Bacillus thuringiensis.

In the context of the present invention, the compound of the formula (I) is applied to the seed. The seed is preferably treated in a state in which it is sufficiently stable for no damage to occur in the course of treatment. In general, the seed can be treated at any time between harvest and sowing. It is customary to use seed which has been separated from the plant and freed from cobs, shells, stalks, coats, hairs or the flesh of the fruits. For example, it is possible to use seed which has been harvested, cleaned and dried down to a moisture content which allows storage. Alternatively, it is also possible to use seed which, after drying, has been treated with, for example, water and then dried again, for example priming. In the case of rice seed, it is also possible to use seed which has been pre-swollen in water up to a certain stage (pigeon breast stage) for example, which leads to improved germination and more uniform emergence.

When treating the seed, care must generally be taken that the amount of the compound of the formula (I) applied to the seed and/or the amount of further additives is chosen in such a way that the germination of the seed is not adversely affected, or that the resulting plant is not damaged. This has to be ensured particularly in the case of active ingredients which can exhibit phytotoxic effects at certain application rates.

In general, the compounds of the formula (I) are applied to the seed in the form of a suitable formulation. Suitable formulations and processes for seed treatment are known to the person skilled in the art.

The compounds of the formula (I) can be converted to the customary seed-dressing formulations, such as solutions, emulsions, suspensions, powders, foams, slurries or other coating compositions for seed, and also ULV formulations.

These formulations are prepared in a known manner, by mixing compounds of the formula (I) with customary additives such as, for example, customary extenders and also solvents or diluents, dyes, wetting agents, dispersants, emulsifiers, antifoams, preservatives, secondary thickeners, adhesives, gibberellins and also water.

Dyes which may be present in the seed-dressing formulations usable in accordance with the invention are all dyes which are customary for such purposes. It is possible to use either pigments, which are sparingly soluble in water, or dyes, which are soluble in water. Examples include the dyes known by the names Rhodamine B, C.I. Pigment Red 112 and C.I. Solvent Red 1.

Useful wetting agents which may be present in the seed-dressing formulations usable in accordance with the invention are all substances which promote wetting and which are customary for the formulation of active agrochemical ingredients. Alkyl naphthalenesulphonates, such as diisopropyl or diisobutyl naphthalenesulphonates, can be used with preference.

Suitable dispersants and/or emulsifiers which may be present in the seed-dressing formulations usable in accordance with the invention are all nonionic, anionic and cationic dispersants customary for the formulation of active agrochemical ingredients. Nonionic or anionic dispersants or mixtures of nonionic or anionic dispersants can be used with preference. Suitable nonionic dispersants especially include ethylene oxide/propylene oxide block polymers, alkylphenol polyglycol ethers and tristyrylphenol polyglycol ethers, and the phosphated or sulphated derivatives thereof. Suitable anionic dispersants are especially lignosulphonates, polyacrylic acid salts and arylsulphonate-formaldehyde condensates.

Antifoams which may be present in the seed-dressing formulations usable in accordance with the invention are all foam-inhibiting substances customary for the formulation of active agrochemical ingredients. Silicone antifoams and magnesium stearate can be used with preference.

Preservatives which may be present in the seed-dressing formulations usable in accordance with the invention are all substances usable for such purposes in agrochemical compositions. Examples include dichlorophene and benzyl alcohol hemiformal.

Secondary thickeners which may be present in the seed-dressing formulations usable in accordance with the invention are all substances which can be used for such purposes in agrochemical compositions. Preferred examples include cellulose derivatives, acrylic acid derivatives, xanthan, modified clays and finely divided silica.

Useful stickers which may be present in the seed-dressing formulations usable in accordance with the invention are all customary binders usable in seed-dressing products. Preferred examples include polyvinylpyrrolidone, polyvinyl acetate, polyvinyl alcohol and tylose.

Gibberellins which may be present in the seed-dressing formulations usable in accordance with the invention are preferably the gibberellins A1, A3 (=gibberellic acid), A4 and A7; particular preference is given to using gibberellic acid. The gibberellins are known (cf. R. Wegler “Chemie der Pflanzenschutz-und Schädlingsbekämpfungsmittel”, vol. 2, Springer Verlag, 1970, pp. 401-412).

The seed-dressing formulations usable in accordance with the invention can be used to treat a wide variety of different kinds of seed, either directly or after prior dilution with water. For instance, the concentrates or the preparations obtainable therefrom by dilution with water can be used to dress the seed of cereals, such as wheat, barley, rye, oats and triticale, and also the seed of maize, rice, oilseed rape, peas, beans, cotton, sunflowers, soya beans and beets, or else a wide variety of different vegetable seed. The seed-dressing formulations usable in accordance with the invention, or the dilute use forms thereof, can also be used to dress seed of transgenic plants.

For the treatment of seed with the seed-dressing formulations usable in accordance with the invention, or use forms prepared therefrom, all mixing units usable customarily for the seed dressing are useful. Specifically, the procedure in seed dressing is to place the seed into a mixer in batchwise or continuous operation, to add the particular desired amount of seed-dressing formulations, either as such or after prior dilution with water, and to mix until the formulation is distributed homogeneously on the seed. If appropriate, this is followed by a drying operation.

The application rate of the seed dressing formulations usable in accordance with the invention can be varied within a relatively wide range. It is guided by the particular content of the compounds of the formula (I) in the formulations and by the seed. The application rates of the compound of the formula (I) are generally between 0.001 and 50 g per kilogram of seed, preferably between 0.01 and 15 g per kilogram of seed.

### Animal Health

In the animal health field, i.e. the field of veterinary medicine, the compounds of the formula (I) are active against animal parasites, in particular ectoparasites or endoparasites. The term “endoparasites” includes especially helminths and protozoa, such as coccidia. Ectoparasites are typically and preferably arthropods, especially insects and acarids.

In the field of veterinary medicine, the compounds of the formula (I) having favourable endotherm toxicity are suitable for controlling parasites which occur in animal breeding and animal husbandry in livestock, breeding animals, zoo animals, laboratory animals, experimental animals and domestic animals. They are active against all or specific stages of development of the parasites.

Agricultural livestock include, for example, mammals such as sheep, goats, horses, donkeys, camels, buffalo, rabbits, reindeer, fallow deer, and particularly cattle and pigs; poultry such as turkeys, ducks, geese, and particularly chickens; fish and crustaceans, for example in aquaculture, and also insects such as bees.

Domestic animals include, for example, mammals, such as hamsters, guinea pigs, rats, mice, chinchillas, ferrets, and particularly dogs, cats, caged birds, reptiles, amphibians and aquarium fish.

In a preferred embodiment, the compounds of the formula (I) are administered to mammals.

In another preferred embodiment, the compounds of the formula (I) are administered to birds, namely caged birds and particularly poultry.

Use of the compounds of the formula (I) for the control of animal parasites is intended to reduce or prevent illness, cases of death and reductions in performance (in the case of meat, milk, wool, hides, eggs, honey and the like), such that more economical and simpler animal husbandry is enabled and better animal well-being is achievable.

In relation to the field of animal health, the term “control” or “controlling” means that the compounds of the formula (I) are effective in reducing the incidence of the particular parasite in an animal infected with such parasites to an innocuous degree. More specifically, “controlling” in the present context means that the compound of the formula (I) can kill the respective parasite, inhibit its growth, or inhibit its proliferation.

Arthropods include:

from the order of Anoplurida, for example Haematopinus spp., Linognathus spp., Pediculus spp., Phtirus spp., Solenopotes spp.; from the order of Mallophagida and the suborders of Amblycerina and Ischnocerina, for example Trimenopon spp., Menopon spp., Trinoton spp., Bovicola spp., Wemeckiella spp., Lepikentron spp., Damalina spp., Trichodectes spp., Felicola spp.; from the order of Diptera and the suborders of Nematocerina and Brachycerina, for example Aedes spp., Anopheles spp., Culex spp., Simulium spp., Eusimulium spp., Phlebotomus spp., Lutzomyia spp., Culicoides spp., Chrysops spp., Odagmia spp., Wilhelmia spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp., Melophagus spp., Rhinoestrus spp., Tipula spp.; from the order of Siphonapterida, for example Pulex spp., Ctenocephalides spp., Tunga spp., Xenopsylla spp., Ceratophyllus spp.;

from the order of Heteropterida, for example Cimex spp., Triatoma spp., Rhodnius spp., Panstrongylus spp.; and pests and hygiene pests from the order of Blattarida.

Arthropods further include:

from the subclass of Acari (Acarina) and the order of Metastigmata, for example from the family of Argasidae, such as Argas spp., Ornithodorus spp., Otobius spp., from the family of Ixodidae, such as Ixodes spp., Amblyomma spp., Rhipicephalus (Boophilus) spp. Dermacentor spp., Haemophysalis spp., Hyalomma spp., Rhipicephalus spp. (the original genus of multi-host ticks); from the order of Mesostigmata, such as Dermanyssus spp., Omithonyssus spp., Pneumonyssus spp., Raillietia spp., Pneumonyssus spp., Stemostoma spp., Varroa spp., Acarapis spp.; from the order of Actinedida (Prostigmata), for example Acarapis spp., Cheyletiella spp., Ornithocheyletia spp., Myobia spp., Psorergates spp., Demodex spp., Trombicula spp., Neotrombiculla spp., Listrophorus spp.; and from the order of Acaridida (Astigmata), for example Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., Laminosioptes spp.

Parasitic protozoa include:

Mastigophora (Flagellata), for example Trypanosomatidae, for example Trypanosoma b. brucei, Trypanosoma b. gambiense, Trypanosoma b. rhodesiense, T. congolense, T. cruzi, T. evansi, T. equinum, T. lewisi, T. percae, T. simiae, T. vivax, Leishmania brasiliensis, L. donovani, L. tropica, for example Trichomonadidae, for example Giardia lamblia, G. canis;

Sarcomastigophora (Rhizopoda) such as Entamoebidae, for example Entamoeba histolytica, Hartmanellidae, for example Acanthamoeba sp., Harmanella sp.;

Apicomplexa (Sporozoa), such as Eimeridae, for example Eimeria acervulina, E. adenoides, E. alabamensis, E. anatis, E. anserina, E. arloingi, E. ashata, E. aubumensis, E. bovis, E. brunetti, E. canis, E. chinchillae, E. clupearum, E. columbae, E. contorta, E. crandalis, E. debliecki, E. dispersa, E. ellipsoidales, E. falciformis, E. faurei, E. flavescens, E. gallopavonis, E. hagani, E. intestinalis, E. iroquoina, E. irresidua, E. labbeana, E. leucarti, E. magna, E. maxima, E. media, E. meleagridis, E. meleagrimitis, E. mitis, E. necatrix, E. ninakohlyakimovae, E. ovis, E. parva, E. pavonis, E. perforans, E. phasani, E. piriformis, E. praecox, E. residua, E. scabra, E. spec., E. stiedai, E. suis, E. tenella, E. truncata, E. truttae, E. zuemii, Globidium spec., Isospora belli, I. canis, I. felis, I. ohioensis, I. rivolta, I. spec., I. suis, Cystisospora spec., Cryptosporidium spec., especially C. parvum such as Toxoplasmadidae, for example Toxoplasma gondii, Hammondia heydomii, Neospora caninum, Besnoitia besnoitii; such as Sarcocystidae, for example Sarcocystis bovicanis, S. bovihominis, S. ovicanis, S. ovifelis, S. neurona, S. spec., S. suihominis, such as Leucozoidae, for example Leucozytozoon simondi, such as Plasmodiidae, for example Plasmodium berghei, P. falciparum, P. malariae, P. ovale, P. vivax, P. spec., such as Piroplasmea, for example Babesia argentina, B. bovis, B. canis, B. spec., Theileria parva, Theileria spec., such as Adeleina, for example Hepatozoon canis, H. spec.

Pathogenic endoparasites which are helminths include Platyhelmintha (e.g. Monogenea, cestodes and trematodes), nematodes, Acanthocephala, and Pentastoma. These include:

Monogenea: e.g.: Gyrodactylus spp., Dactylogyrus spp., Polystoma spp.;

Cestodes: from the order of Pseudophyllidea, for example: Diphyllobothrium spp., Spirometra spp., Schistocephalus spp., Ligula spp., Bothridium spp., Diplogonoporus spp.

from the order of Cyclophyllida, for example: Mesocestoides spp., Anoplocephala spp., Paranoplocephala spp., Moniezia spp., Thysanosoma spp., Thysaniezia spp., Avitellina spp., Stilesia spp., Cittotaenia spp., Andyra spp., Bertiella spp., Taenia spp., Echinococcus spp., Hydatigera spp., Davainea spp., Raillietina spp., Hymenolepis spp., Echinolepis spp., Echinocotyle spp., Diorchis spp., Dipylidium spp., Joyeuxiella spp., Diplopylidium spp.;

Trematodes: from the class of Digenea, for example: Diplostomum spp., Posthodiplostomum spp., Schistosoma spp., Trichobilharzia spp., Ornithobilharzia spp., Austrobilharzia spp., Gigantobilharzia spp., Leucochloridium spp., Brachylaima spp., Echinostoma spp., Echinoparyphium spp., Echinochasmus spp., Hypoderaeum spp., Fasciola spp., Fascioloides spp., Fasciolopsis spp., Cyclocoelum spp., Typhlocoelum spp., Paramphistomum spp., Calicophoron spp., Cotylophoron spp., Gigantocotyle spp., Fischoederius spp., Gastrothylacus spp., Notocotylus spp., Catatropis spp., Plagiorchis spp., Prosthogonimus spp., Dicrocoelium spp., Eurytrema spp., Troglotrema spp., Paragonimus spp., Collyriclum spp., Nanophyetus spp., Opisthorchis spp., Clonorchis spp. Metorchis spp., Heterophyes spp., Metagonimus spp.;

Nematodes: Trichinellida, for example: Trichuris spp., Capillaria spp., Paracapillaria spp., Eucoleus spp., Trichomosoides spp., Trichinella spp.;

from the order of Tylenchida, for example: Micronema spp., Strongyloides spp.;

from the order of Rhabditida, for example: Strongylus spp., Triodontophorus spp., Oesophagodontus spp., Trichonema spp., Gyalocephalus spp., Cylindropharynx spp., Poteriostomum spp., Cyclococercus spp., Cylicostephanus spp., Oesophagostomum spp., Chabertia spp., Stephanurus spp., Ancylostoma spp., Uncinaria spp., Necator spp., Bunostomum spp., Globocephalus spp., Syngamus spp., Cyathostoma spp., Metastrongylus spp., Dictyocaulus spp., Muellerius spp., Protostrongylus spp., Neostrongylus spp., Cystocaulus spp., Pneumostrongylus spp., Spicocaulus spp., Elaphostrongylus spp. Parelaphostrongylus spp., Crenosoma spp., Paracrenosoma spp., Oslerus spp., Angiostrongylus spp., Aelurostrongylus spp., Filaroides spp., Parafilaroides spp., Trichostrongylus spp., Haemonchus spp., Ostertagia spp., Teladorsagia spp., Marshallagia spp., Cooperia spp., Nippostrongylus spp., Heligmosomoides spp., Nematodirus spp., Hyostrongylus spp., Obeliscoides spp., Amidostomum spp., Ollulanus spp.;

from the order of Spirurida, for example: Oxyuris spp., Enterobius spp., Passalurus spp., Syphacia spp., Aspiculuris spp., Heterakis spp.; Ascaris spp., Toxascaris spp., Toxocara spp., Baylisascaris spp., Parascaris spp., Anisakis spp., Ascaridia spp.; Gnathostoma spp., Physaloptera spp., Thelazia spp., Gongylonema spp., Habronema spp., Parabronema spp., Draschia spp., Dracunculus spp.; Stephanofilaria spp., Parafilaria spp., Setaria spp., Loa spp., Dirofilaria spp., Litomosoides spp., Brugia spp., Wuchereria spp., Onchocerca spp., Spirocerca spp.;

Acanthocephala: from the order of Oligacanthorhynchida, for example: Macracanthorhynchus spp., Prosthenorchis spp.; from the order of Polymorphida, for example: Filicollis spp.; from the order of Moniliformida, for example: Moniliformis spp.;

from the order of Echinorhynchida, for example: Acanthocephalus spp., Echinorhynchus spp., Leptorhynchoides spp.;

Pentastoma: from the order of Porocephalida, for example Linguatula spp.

In the veterinary field and in animal husbandry, the compounds of the formula (I) are administered by methods generally known in the art, such as via the enteral, parenteral, dermal or nasal route in the form of suitable preparations. Administration may be prophylactic or therapeutic.

Thus, one embodiment of the present invention refers to the use of a compound of the formula (I) as a medicament.

A further aspect refers to the use of a compound of the formula (I) as an antiendoparasitic agent, in particular a helminthicidal agent or antiprotozoic agent. Compounds of the formula (I) are suitable for use as an antiendoparasitic agent, especially as a helminthicidal agent or antiprotozoic agent, for example in animal breeding, in animal husbandry, in animal houses and in the hygiene sector.

A further aspect in turn relates to the use of a compound of the formula (I) as an antiectoparasitic agent, in particular an arthropodicide such as an insecticide or an acaricide. A further aspect relates to the use of a compound of the formula (I) as an antiectoparasitic agent, in particular an arthropodicide such as an insecticide or an acaricide, for example in animal husbandry, in animal breeding, in animal houses or in the hygiene sector.

### Vector Control

The compounds of the formula (I) can also be used in vector control. In the context of the present invention, a vector is an arthropod, especially an insect or arachnid, capable of transmitting pathogens, for example viruses, worms, single-cell organisms and bacteria, from a reservoir (plant, animal, human, etc.) to a host. The pathogens can be transmitted either mechanically (for example trachoma by non-stinging flies) to a host or after injection (for example malaria parasites by mosquitoes) into a host.

Examples of vectors and the diseases or pathogens they transmit are:

1) Mosquitoes
Anopheles: malaria, filariasis;
Culex: Japanese encephalitis, filariasis, other viral diseases, transmission of worms;
Aedes: yellow fever, dengue fever, filariasis, other viral diseases;
Simuliidae: transmission of worms, in particular Onchocerca volvulus;

2) Lice: skin infections, epidemic typhus;

3) Fleas: plague, endemic typhus;

4) Flies: sleeping sickness (trypanosomiasis); cholera, other bacterial diseases;

5) Mites: acariosis, epidemic typhus, rickettsialpox, tularaemia, Saint Louis encephalitis, tick-bome encephalitis (TBE), Crimean-Congo haemorrhagic fever, borreliosis;

6) Ticks: borellioses such as Borrelia duttoni, tick-bome encephalitis, Q fever (Coxiella bumetii), babesioses (Babesia canis canis).

Examples of vectors in the context of the present invention are insects, such as aphids, flies, leafhoppers or thrips, which can transmit plant viruses to plants. Other vectors capable of transmitting plant viruses are spider mites, lice, beetles and nematodes.

Further examples of vectors in the context of the present invention are insects and arachnids such as mosquitoes, especially of the genera Aedes, Anopheles, for example A. gambiae, A. arabiensis, A. funestus, A. dirus (malaria) and Culex, lice, fleas, flies, mites and ticks, which can transmit pathogens to animals and/or humans.

Vector control is also possible if the compounds of the formula (I) are resistance-breaking.

Compounds of the formula (I) are suitable for use in the prevention of diseases and/or pathogens transmitted by vectors. Thus, a further aspect of the present invention is the use of compounds of the formula (I) for vector control, for example in agriculture, in horticulture, in forests, in gardens and in leisure facilities, and also in the protection of materials and stored products.

### Protection of Industrial Materials

The compounds of the formula (I) are suitable for protecting industrial materials against attack or destruction by insects, for example from the orders Coleoptera, Hymenoptera, Isoptera, Lepidoptera, Psocoptera and Zygentoma.

Industrial materials in the present context are understood to mean inanimate materials, such as preferably plastics, adhesives, sizes, papers and cards, leather, wood, processed wood products and coating compositions. The use of the invention for protection of wood is particularly preferred.

In a further embodiment, the compounds of the formula (I) are used together with at least one further insecticide and/or at least one fungicide.

In a further embodiment, the compounds of the formula (I) are present as a ready-to-use pesticide, i.e. it can be applied to the material in question without further modifications. Suitable further insecticides or fungicides are in particular those mentioned above.

Surprisingly, it has also been found that the compounds of the formula (I) can be employed for protecting objects which come into contact with saltwater or brackish water, in particular hulls, screens, nets, buildings, moorings and signalling systems, against fouling. It is equally possible to use the compounds of the formula (I), alone or in combinations with other active ingredients, as antifouling agents.

### Control of Animal Pests in the Hygiene Sector

The compounds of the formula (I) are suitable for controlling animal pests in the hygiene sector. More particularly, the invention can be used in the domestic protection sector, in the hygiene protection sector and in the protection of stored products, particularly for control of insects, arachnids and mites encountered in enclosed spaces, for example dwellings, factory halls, offices, vehicle cabins. For controlling animal pests, the compounds of the formula (I) are used alone or in combination with other active ingredients and/or auxiliaries. They are preferably used in domestic insecticide products. The compounds of the formula (I) are effective against sensitive and resistant species, and against all developmental stages.

These pests include, for example, pests from the class Arachnida, from the orders Scorpiones, Araneae and Opiliones, from the classes Chilopoda and Diplopoda, from the class Insecta the order Blattodea, from the orders Coleoptera, Dermaptera, Diptera, Heteroptera, Hymenoptera, Isoptera, Lepidoptera, Phthiraptera, Psocoptera, Saltatoria or Orthoptera, Siphonaptera and Zygentoma and from the class Malacostraca the order Isopoda.

Application is carried out, for example, in aerosols, unpressurized spray products, for example pump and atomizer sprays, automatic fogging systems, foggers, foams, gels, evaporator products with evaporator tablets made of cellulose or plastic, liquid evaporators, gel and membrane evaporators, propeller-driven evaporators, energy-free, or passive, evaporation systems, moth papers, moth bags and moth gels, as granules or dusts, in baits for spreading or bait stations.

### DESCRIPTION OF THE PROCESSES AND INTERMEDIATES

The preparation and use examples which follow illustrate the invention without limiting it. The products were characterized by ¹H NMR spectroscopy and/or LC-MS (Liquid Chromatography Mass Spectrometry).

The log P values were determined in accordance with OECD Guideline 117 (EC Directive 92/69/EEC) by HPLC (high-performance liquid chromatography) using reversed-phase (RP) columns (C18), by the following methods:

[a] The LC-MS determination in the acidic range is carried out at pH 2.7 with 0.1% aqueous formic acid and acetonitrile (contains 0.1% formic acid) as eluents; linear gradient from 10% acetonitrile to 95% acetonitrile.

[b] LC-MS determination in the neutral range is carried out at pH 7.8 with 0.001 molar aqueous ammonium hydrogencarbonate solution and acetonitrile as eluents; linear gradient from 10% acetonitrile to 95% acetonitrile.

Calibration is effected using unbranched alkan-2-ones (having 3 to 16 carbon atoms) with known log P values (log P values determined on the basis of the retention times by linear interpolation between two successive alkanones).

The NMR spectra were determined using a Bruker Avance 400 fitted with a flow probe head (volume 60 μl). In individual cases, the NMR spectra were measured with an Avance DRX 500 or Bruker Avance II 600.

### NMR Data of Selected Examples

### NMR Peak List Method

The ¹H NMR data of selected examples are stated in the form of ¹H NMR peak lists. For each signal peak, first the δ value in ppm and then the signal intensity in round brackets are listed. The pairs of δ value-signal intensity numbers for different signal peaks are listed with separation from one another by semicolons.

The peak list for one example therefore takes the form of:

δ₁ (intensity₁); δ₂ (intensity₂); . . . ; δᵢ (intensityᵢ); . . . ; δₙ (intensityₙ)

The intensity of sharp signals correlates with the height of the signals in a printed example of an NMR spectrum in cm and shows the true ratios of the signal intensities. In the case of broad signals, several peaks or the middle of the signal and the relative intensity thereof may be shown in comparison to the most intense signal in the spectrum.

For calibration of the chemical shift of ¹H NMR spectra, we use tetramethylsilane and/or the chemical shift of the solvent, particularly in the case of spectra which are measured in DMSO. Therefore, the tetramethylsilane peak may but need not occur in NMR peak lists.

The lists of the 1H NMR peaks are similar to the conventional ¹H NMR printouts and thus usually contain all peaks listed in a conventional NMR interpretation.

In addition, like conventional ¹H NMR printouts, they may show solvent signals, signals of stereoisomers of the target compounds which are likewise provided by the invention, and/or peaks of impurities.

In the reporting of compound signals within the delta range of solvents and/or water, our lists of ¹H NMR peaks show the standard solvent peaks, for example peaks of DMSO in DMSO-D₆ and the peak of water, which usually have a high intensity on average.

The peaks of stereoisomers of the target compounds and/or peaks of impurities usually have a lower intensity on average than the peaks of the target compounds (for example with a purity of >90%).

Such stereoisomers and/or impurities may be typical of the particular preparation process. Their peaks can thus help in identifying reproduction of our preparation process with reference to “by-product fingerprints”.

An expert calculating the peaks of the target compounds by known methods (MestreC, ACD simulation, but also with empirically evaluated expected values) can, if required, isolate the peaks of the target compounds, optionally using additional intensity filters. This isolation would be similar to the relevant peak picking in conventional 1H NMR interpretation.

Further details of ¹H NMR peak lists can be found in the Research Disclosure Database Number 564025.

### Synthesis of Compounds of the Formula (I)

### Example 1: 1,4-Dimethyl-2-[2-(pyridin-3-yl)-2H-indazol-5-yl]-1,2,4-triazolidine-3,5-dione

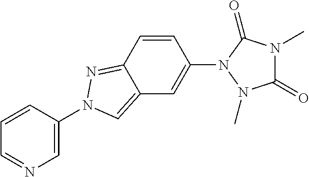 [SMILES: Cn1c(=O)n(C)n(-c2ccc3nn(-c4cccnc4)cc3c2)c1=O]

### Method A: Copper Catalysis

A microwave-suitable vessel was charged with 1.00 g (3.65 mmol) of 5-bromo-2-(pyridin-3-yl)-2H-indazole (for preparation cf. WO 2016/071499 A1 and WO 2016/087421 A1), 0.49 g (3.83 mmol) of 1,4-dimethyl-1,2,4-triazolidine-3,5-dione, 115 μl (0.10 g, 0.73 mmol) of trans-N,N′-dimethylcyclohexane-1,2-diamine, 0.07 g (0.36 mmol) of copper(I) iodide, 0.18 g (1.09 mmol) of potassium iodide and 1.51 g (10.94 mmol) of potassium carbonate, and 100 ml of toluene were added. The reaction mixture was stirred at 150° C. in an Anton Paar Monowave 400 microwave for 60 minutes, then cooled down and freed of the solvent under reduced pressure.

The reaction was repeated twice. The respective residues were combined, stirred with acetonitrile and filtered through Celite. The filtrate was freed of the solvent under reduced pressure, taken up in methanol and applied to Isolute. Purification by means of MPLC using RP-18 with water/acetonitrile/0.1% formic acid gave 1.18 g (100% purity by LC/MS, 33% of theory) of the title compound.

### Method B: Palladium Catalysis

A 50 ml round-bottom flask was charged with 100 mg (0.37 mmol) of 5-bromo-2-(pyridin-3-yl)-2H-indazole (for preparation cf. WO 2016/071499 A1 and WO 2016/087421 A1), 49 mg (0.38 mmol) of 1,4-dimethyl-1,2,4-triazolidine-3,5-dione, 21 mg (0.04 mmol) of tris(dibenzylideneacetone)dipalladium(0), 37 mg (0.07 mg) of 5-(di-tert-butylphosphino)-1,3,5-triphenyl-H-[1,4]-bipyrazole and 357 mg (1.09 mmol) of caesium carbonate, the flask was flushed with argon and 10 ml of degassed tert-amyl alcohol were added. The reaction mixture was stirred at 100° C. overnight, then cooled down and freed of the solvent under reduced pressure. The residue was taken up in acetonitrile and applied to Isolute. Purification by means of MPLC using RP-18 with water/acetonitrile/0.1% formic acid gave 69 mg (98% purity by LC/MS, 58% of theory) of the title compound.

log P(HCOOH) 1.24; log P(neutral) 1.31

¹H-NMR (400.0 MHz, d₆-DMSO): δ=9.35 (d, 1H), 9.29 (s, 1H), 8.69 (d, 1H), 8.49-8.52 (m, 1H), 7.87 (d, 1H), 7.78 (s, 1H), 7.69-7.66 (m, 1H), 7.39 (dd, 1H), 3.05 (s, 3H), 3.03 (s, 3H) ppm.

### Example 2: 4-Methyl-2-[2-(pyridin-3-yl)-2H-indazol-5-yl]-1,2,4-triazine-3,5(2H,4H)-dione

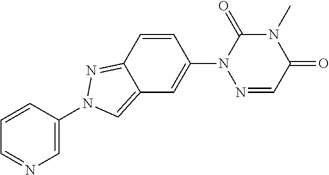 [SMILES: Cn1c(=O)cnn(-c2ccc3nn(-c4cccnc4)cc3c2)c1=O]

### Method A: Copper Catalysis

A 50 ml round-bottom flask was charged with 600 mg (2.19 mmol) of 5-bromo-2-(pyridin-3-yl)-2H-indazole (for preparation cf. WO 2016/071499 A1 and WO 2016/087421 A1), 292 mg (2.30 mmol) of 4-methyl-1,2,4-triazine-3,5(2H,4H)-dione, 70 μl (62 g, 0.44 mmol) of trans-N,N′-dimethylcyclohexane-1,2-diamine, 42 g (0.22 mmol) of copper(I) iodide, 109 g (0.66 mmol) of potassium iodide and 908 g (6.66 mmol) of potassium carbonate. The flask was flushed with argon, and 20 ml of toluene were added. The reaction mixture was stirred at reflux overnight, then cooled down and freed of the solvent under reduced pressure. The residue was taken up in acetonitrile and filtered through Celite, and the filtrate was freed of the solvent under reduced pressure. The crude mixture was suspended in acetonitrile and applied to Isolute. Purification by means of MPLC using RP-18 with water/acetonitrile/0.1% formic acid gave 30 mg (97% purity by LC/MS, 4% of theory) of the title compound.

log P(HCOOH) 1.38; log P(neutral) 1.47

¹H-NMR (400.0 MHz, d₆-DMSO): δ=9.50-9.34 (m, 2H), 8.72-8.65 (m, 1H), 8.52 (d, 1H), 7.92 (d, 1H), 7.84 (d, 1H), 7.76 (s, 1H), 7.74-7.65 (m, 1H), 7.43 (dd, 1H), 3.24 (s, 3H) ppm.

Further compounds of the formula (I) are listed in Table 1 below and corresponding analytical data in Table 2.

TABLE 1
Compounds of the formula (I)

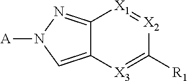

| Ex- | |
|---|---|
| am- | |
| ple | |
| No. | Structure |
| 3 | 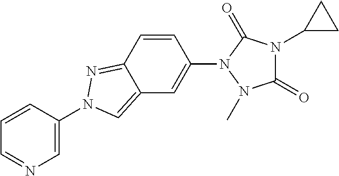 [SMILES: Cn1c(=O)n(C2CC2)c(=O)n1-c1ccc2nn(-c3cccnc3)cc2c1] |
| 4 | 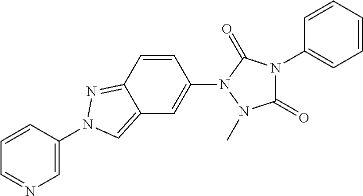 [SMILES: Cn1c(=O)n(-c2ccccc2)c(=O)n1-c1ccc2nn(-c3cccnc3)cc2c1] |
| 5 | 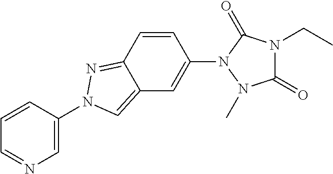 [SMILES: CCn1c(=O)n(C)n(-c2ccc3nn(-c4cccnc4)cc3c2)c1=O] |
| 6 | 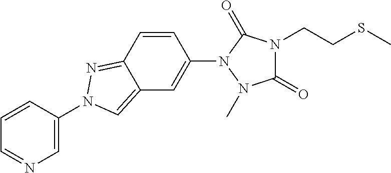 [SMILES: CSCCn1c(=O)n(C)n(-c2ccc3nn(-c4cccnc4)cc3c2)c1=O] |
| 7 | 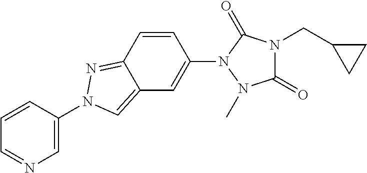 [SMILES: Cn1c(=O)n(CC2CC2)c(=O)n1-c1ccc2nn(-c3cccnc3)cc2c1] |
| 8 | 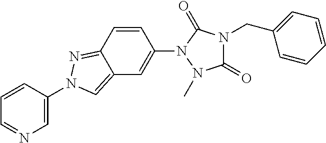 [SMILES: Cn1c(=O)n(Cc2ccccc2)c(=O)n1-c1ccc2nn(-c3cccnc3)cc2c1] |
| 9 | 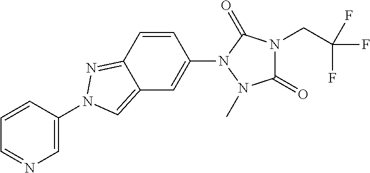 [SMILES: Cn1c(=O)n(CC(F)(F)F)c(=O)n1-c1ccc2nn(-c3cccnc3)cc2c1] |
| 10 | 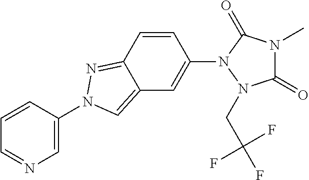 [SMILES: Cn1c(=O)n(CC(F)(F)F)n(-c2ccc3nn(-c4cccnc4)cc3c2)c1=O] |
| 11 | 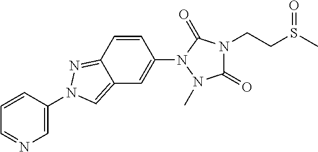 [SMILES: Cn1c(=O)n(CCS(C)=O)c(=O)n1-c1ccc2nn(-c3cccnc3)cc2c1] |
| 12 | 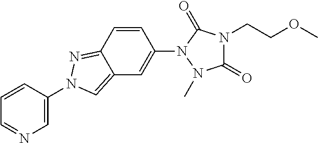 [SMILES: COCCn1c(=O)n(C)n(-c2ccc3nn(-c4cccnc4)cc3c2)c1=O] |
| 13 | 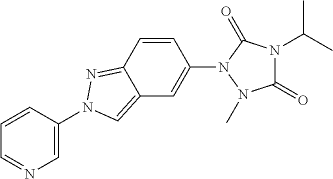 [SMILES: CC(C)n1c(=O)n(C)n(-c2ccc3nn(-c4cccnc4)cc3c2)c1=O] |
| 14 | 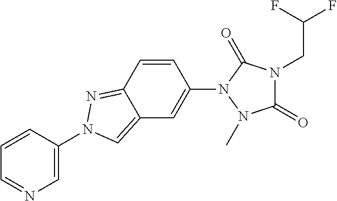 [SMILES: Cn1c(=O)n(CC(F)F)c(=O)n1-c1ccc2nn(-c3cccnc3)cc2c1] |
| 15 | 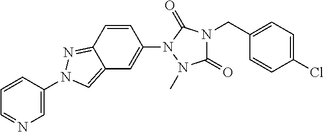 [SMILES: Cn1c(=O)n(Cc2ccc(Cl)cc2)c(=O)n1-c1ccc2nn(-c3cccnc3)cc2c1] |
| 16 | 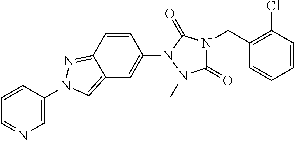 [SMILES: Cn1c(=O)n(Cc2ccccc2Cl)c(=O)n1-c1ccc2nn(-c3cccnc3)cc2c1] |
| 17 | 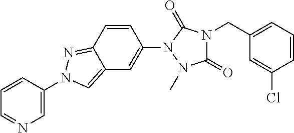 [SMILES: Cn1c(=O)n(Cc2cccc(Cl)c2)c(=O)n1-c1ccc2nn(-c3cccnc3)cc2c1] |
| 18 | 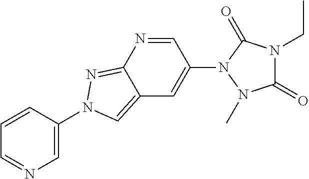 [SMILES: CCn1c(=O)n(C)n(-c2cnc3nn(-c4cccnc4)cc3c2)c1=O] |
| 19 | 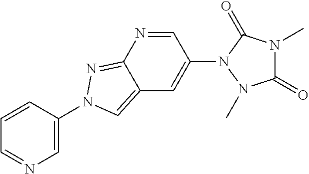 [SMILES: Cn1c(=O)n(C)n(-c2cnc3nn(-c4cccnc4)cc3c2)c1=O] |
| 20 | 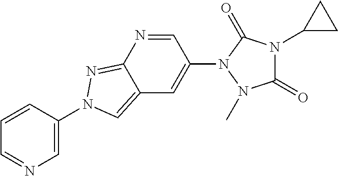 [SMILES: Cn1c(=O)n(C2CC2)c(=O)n1-c1cnc2nn(-c3cccnc3)cc2c1] |
| 21 | 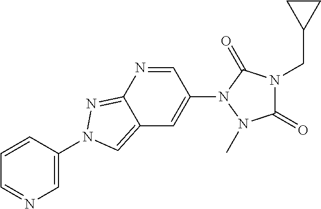 [SMILES: Cn1c(=O)n(CC2CC2)c(=O)n1-c1cnc2nn(-c3cccnc3)cc2c1] |
| 22 | 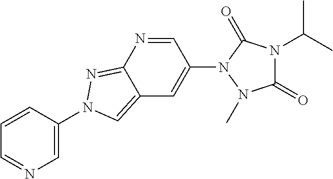 [SMILES: CC(C)n1c(=O)n(C)n(-c2cnc3nn(-c4cccnc4)cc3c2)c1=O] |
| 23 | 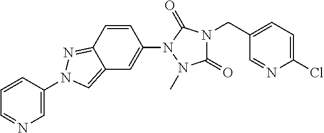 [SMILES: Cn1c(=O)n(Cc2ccc(Cl)nc2)c(=O)n1-c1ccc2nn(-c3cccnc3)cc2c1] |
| 24 | 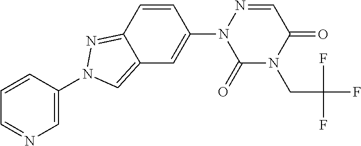 [SMILES: O=c1cnn(-c2ccc3nn(-c4cccnc4)cc3c2)c(=O)n1CC(F)(F)F] |
| 25 | 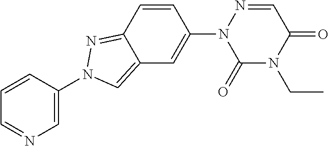 [SMILES: CCn1c(=O)cnn(-c2ccc3nn(-c4cccnc4)cc3c2)c1=O] |
| 26 | 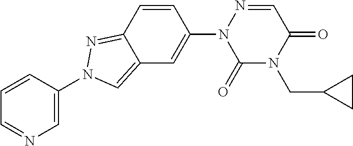 [SMILES: O=c1cnn(-c2ccc3nn(-c4cccnc4)cc3c2)c(=O)n1CC1CC1] |
| 27 | 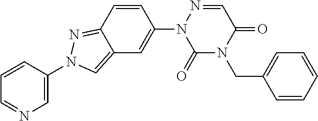 [SMILES: O=c1cnn(-c2ccc3nn(-c4cccnc4)cc3c2)c(=O)n1Cc1ccccc1] |
| 28 | 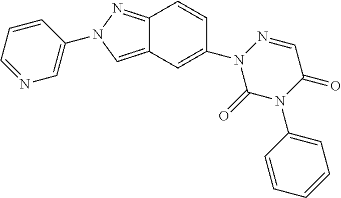 [SMILES: O=c1cnn(-c2ccc3nn(-c4cccnc4)cc3c2)c(=O)n1-c1ccccc1] |
| 29 | 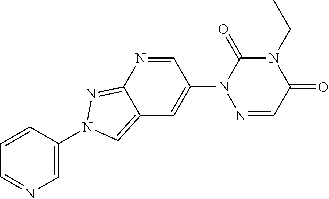 [SMILES: CCn1c(=O)cnn(-c2cnc3nn(-c4cccnc4)cc3c2)c1=O] |

TABLE 2
¹H NMR data of compounds 3 to 29

| Example | |
|---|---|
| No. | ¹H NMR data [σ (ppm)]^{a} |
| 3 | 9.3431 (2.4); 9.3366 (2.4); 9.2801 (4.3); 8.6871 (1.6); 8.6843 (1.7); |
| | 8.6754 (1.7); 8.6725 (1.7); 8.5167 (0.9); 8.5109 (1.0); 8.5070 (0.9); |
| | 8.4957 (1.0); 8.4899 (1.1); 8.4863 (0.9); 7.8693 (2.0); 7.8461 (2.1); |
| | 7.7585 (2.6); 7.7542 (2.6); 7.6836 (1.3); 7.6717 (1.3); 7.6628 (1.3); |
| | 7.6508 (1.2); 7.3856 (1.7); 7.3808 (1.6); 7.3625 (1.6); 7.3576 (1.5); |
| | 3.3191 (21.4); 3.0081 (16.0); 2.7360 (0.3); 2.7265 (0.7); 2.7187 (0.8); |
| | 2.7154 (0.7); 2.7094 (1.3); 2.7000 (1.0); 2.6920 (0.8); 2.6814 (0.5); |
| | 2.6705 (0.6); 2.6667 (0.5); 2.5058 (82.9); 2.5016 (108.7); 2.4973 |
| | (79.3); 2.3326 (0.5); 2.3282 (0.6); 0.9520 (0.4); 0.9308 (2.8); 0.9209 |
| | (1.7); 0.9120 (1.4); 0.9054 (1.6); 0.8953 (2.0); 0.8873 (1.5); 0.8817 |
| | (1.6); 0.8630 (0.4); 0.1458 (0.3); 0.0075 (2.8); −0.0002 (69.8); −0.0079 |
| | (3.0); −0.1496 (0.4) |
| 4 | 9.3575 (2.6); 9.3515 (2.7); 9.3252 (4.5); 8.6931 (1.9); 8.6842 (1.9); |
| | 8.6813 (1.9); 8.5281 (1.2); 8.5256 (1.2); 8.5072 (1.2); 8.5044 (1.3); |
| | 7.9203 (2.2); 7.9095 (2.9); 7.9050 |
| | (3.2); 7.8976 (2.6); 7.6927 (1.4); 7.6803 (1.4); 7.6718 (1.4); 7.6599 |
| | (1.3); 7.5701 (0.8); 7.5553 (10.1); 7.5495 (5.9); 7.5401 (4.5); 7.5193 |
| | (1.0); 7.5095 (1.9); 7.5050 (1.8); 7.4861 (1.6); 7.4815 (1.8); 7.4738 |
| | (0.9); 7.4676 (1.2); 7.4597 (1.1); 7.4521 (1.2); 7.4375 |
| | (0.6); 7.4309 (0.4); 3.3224 (69.9); 3.1446 (16.0); 2.6702 (0.7); 2.5056 |
| | (87.9); 2.5015 |
| | (114.2); 2.4974 (90.6); 2.3285 (0.7); 0.1456 (0.4); −0.0004 (77.5); −0.1499 |
| | (0.4) ppm |
| 5 | 9.3770 (2.1); 9.3709 (2.2); 9.3037 (4.0); 8.7094 (1.6); 8.7002 (1.6); |
| | 8.6975 (1.6); 8.5765 (1.0); 8.5740 (1.0); 8.5528 (1.0); 7.8826 (1.9); |
| | 7.8596 (2.1); 7.7937 (2.5); 7.7902 |
| | (2.7); 7.7326 (1.2); 7.7207 (1.1); 7.7119 (1.1); 7.6999 (1.1); 7.4037 |
| | (1.7); 7.3988 (1.7); 7.3806 (1.5); 7.3757 (1.6); 4.3450 (2.0); 3.5749 |
| | (0.9); 3.5568 (3.1); 3.5388 (3.2); 3.5208 (1.0); 3.0511 (16.0); 2.6762 |
| | (0.4); 2.6716 (0.5); 2.6673 (0.4); 2.5436 (1.0); 2.5295 (2.4); 2.5070 |
| | (78.2); 2.5026 (102.5); 2.4983 (77.9); 2.3339 (0.4); 2.3295 (0.6); 1.2210 |
| | (3.4); 1.2031 (7.4); 1.1851 (3.3); 0.0078 (1.9); −0.0001 (49.1); −0.0080 |
| | (2.5) |
| 6 | 9.3465 (2.3); 9.3404 (2.5); 9.2927 (3.8); 9.2099 (0.6); 8.6879 (1.7); |
| | 8.6763 (1.6); 8.6608 (0.3); 8.5182 (1.0); 8.4945 (1.1); 8.3152 (0.3); |
| | 7.8920 (1.8); 7.8688 (2.0); 7.8071 (2.6); 7.8038 (2.6); 7.7876 (0.3); |
| | 7.7488 (0.3); 7.6864 (1.2); 7.6747 (1.2); 7.6665 (1.4); 7.6540 (1.3); |
| | 7.3845 (1.6); 7.3799 (1.6); 7.3616 (1.5); 7.3565 (1.5); 5.7559 (0.5); |
| | 3.8127 (0.3); 3.7400 (1.7); 3.7230 (3.7); 3.7061 (1.8); 3.3203 (285.5); |
| | 3.0593 (14.1); 2.8084 |
| | (1.9); 2.7915 (3.8); 2.7747 (1.7); 2.6703 (2.5); 2.5056 (325.2); 2.5013 |
| | (425.6); 2.4971 (327.5); 2.3282 (2.6); 2.0991 (16.0); 0.1458 (0.6); |
| | 0.0076 (5.3); −0.0001 (128.0); |
| | −0.1499 (0.6) |
| 7 | 9.3487 (2.2); 9.3425 (2.2); 9.2901 (3.7); 9.2884 (3.8); 8.6906 (1.6); |
| | 8.6872 (1.7); 8.6788 (1.6); 8.6754 (1.7); 8.5234 (0.9); 8.5199 (1.0); |
| | 8.5170 (1.0); 8.5133 (0.9); 8.5026 (1.0); 8.4990 (1.0); 8.4961 (1.1); |
| | 8.4925 (0.9); 7.8867 (1.9); 7.8636 (2.1); 7.8102 (2.4); 7.8070 (2.4); |
| | 7.6855 (1.2); 7.6737 (1.2); 7.6656 (1.1); 7.6528 (1.1); 7.4003 (1.8); |
| | 7.3953 (1.7); 7.3773 (1.6); 7.3722 (1.6); 3.3953 (3.7); 3.3774 (3.8); |
| | 3.3216 (44.8); 3.0674 (16.0); 2.6711 (0.4); 2.5242 (1.6); 2.5109 (25.5); |
| | 2.5065 (50.1); 2.5020 (65.6); 2.4975 (48.2); 2.4931 (23.9); 2.3289 |
| | (0.4); 1.1614 (0.5); 1.1542 (0.5); 1.1509 (0.4); 1.1423 (0.8); 1.1306 |
| | (0.5); 1.1228 (0.5); 0.5272 (0.6); 0.5161 (1.8); 0.5117 (2.0); 0.5013 |
| | (1.0); 0.4960 (1.8); 0.4916 (1.8); 0.4815 (0.7); 0.3591 (0.8); 0.3482 |
| | (2.3); 0.3371 (2.0); 0.3332 (2.3); 0.3217 (0.5); 0.0079 (1.6); −0.0002 |
| | (38.8); −0.0084 (1.6) |
| 8 | 9.3466 (2.3); 9.3403 (2.3); 9.2920 (4.1); 8.6895 (1.6); 8.6867 (1.7); |
| | 8.6780 (1.7); 8.6748 (1.7); 8.5209 (0.9); 8.5175 (1.1); 8.5146 (1.1); |
| | 8.5111 (0.9); 8.5002 (1.1); 8.4967 (1.2); 8.4939 (1.2); 8.4903 (1.0); |
| | 8.1362 (0.7); 7.8874 (2.0); 7.8643 (2.3); 7.8253 (2.6); 7.8218 (2.8); |
| | 7.6843 (1.3); 7.6726 (1.3); 7.6633 (1.3); 7.6519 (1.3); 7.4059 (2.2); |
| | 7.4013 (2.3); 7.3832 (4.0); 7.3782 (2.6); 7.3671 (7.9); 7.3636 (7.0); |
| | 7.3476 (1.4); 7.3383 (1.2); 7.3340 (1.0); 7.3250 (0.8); 7.3168 (1.3); |
| | 7.3078 (0.5); 7.3010 (0.5); 4.7050 (7.2); 3.3242 (24.1); 3.0828 (16.0); |
| | 2.6715 (0.3); 2.5069 (43.4); 2.5026 (56.5); 2.4982 (41.8); 2.3293 |
| | (0.3); 2.0751 (1.4); 0.0079 (0.9); −0.0001 (19.3) |
| 9 | 9.3130 (3.6); 8.5397 (1.4); 8.5196 (1.5); 7.9084 (2.1); 7.8847 (2.6); |
| | 7.8782 (3.5); 7.8750 (3.5); 7.7823 (0.4); 7.4064 (1.6); 7.4018 (1.8); |
| | 7.3832 (1.5); 7.3788 (1.6); 5.7562 (1.5); 4.4198 (0.9); 4.3964 (2.9); |
| | 4.3733 (3.0); 4.3501 (1.0); 3.3223 (44.9); 3.0903 (16.0); 2.6721 (0.8); |
| | 2.5030 (148.1); 2.3295 (0.8); −0.0003 (37.5) |
| 10 | 9.3478 (1.9); 9.3421 (1.9); 9.3306 (4.6); 8.6940 (1.4); 8.6830 (1.4); |
| | 8.5223 (0.9); 8.5190 (1.1); 8.5163 (1.1); 8.5129 (1.0); 8.5016 (1.0); |
| | 8.4980 (1.1); 8.4953 (1.2); 8.4919 (1.0); 7.8898 (2.8); 7.8857 (2.8); |
| | 7.8736 (2.1); 7.8505 (2.2); 7.6899 (1.2); 7.6781 (1.2); 7.6692 (1.2); |
| | 7.6574 (1.1); 7.3689 (1.7); 7.3641 (1.7); 7.3460 (1.6); 7.3410 (1.6); |
| | 5.7558 (0.9); 4.4471 (0.8); 4.4244 (2.4); 4.4016 (2.5); 4.3786 (0.8); |
| | 3.3208 (71.5); 3.0663 (16.0); 2.6748 (0.6); 2.6707 (0.8); 2.6662 (0.6); |
| | 2.5059 (100.5); 2.5016 (131.6); 2.4972 (97.0); 2.3329 (0.6); 2.3283 |
| | (0.7); 2.3240 (0.6); 0.0077 (2.7); −0.0003 (66.6); |
| | −0.0083 (3.0) |
| 11 | 9.3478 (2.5); 9.3416 (2.6); 9.2985 (4.4); 8.6901 (1.8); 8.6878 (1.8); |
| | 8.6786 (1.8); 8.6760 (1.8); 8.5173 (1.1); 8.5000 (1.0); 8.4945 (1.2); |
| | 7.8859 (2.0); 7.8627 (2.2); 7.8055 (2.8); 7.8015 (2.8); 7.6861 (1.3); |
| | 7.6742 (1.3); 7.6653 (1.3); 7.6534 (1.2); 7.4017 (1.7); 7.3969 (1.7); |
| | 7.3785 (1.6); 7.3737 (1.6); 5.7547 (5.6); 3.9529 (1.0); 3.9362 (2.2); |
| | 3.9259 (2.2); 3.9201 (1.3); 3.9094 (1.0); 3.3231 (4.0); 3.2075 (0.5); |
| | 3.1911 (1.0); 3.1743 (1.1); 3.1577 (1.4); 3.1414 (0.6); 3.0487 (15.4); |
| | 3.0208 (1.5); 3.0042 (1.1); 2.9874 (1.0); 2.9710 (0.4); 2.6720 (0.4); |
| | 2.6176 (16.0); 2.5069 (49.0); 2.5027 (61.4); 2.4987 (46.7); 2.3295 |
| | (0.4); −0.0002 (56.3) |
| 12 | 9.3481 (2.3); 9.3417 (2.3); 9.2892 (4.2); 8.6897 (1.6); 8.6870 (1.6); |
| | 8.6780 (1.7); 8.6752 (1.6); 8.5217 (0.9); 8.5183 (1.1); 8.5155 (1.0); |
| | 8.5123 (0.8); 8.5011 (1.0); 8.4975 (1.1); 8.4947 (1.1); 8.4913 (0.8); |
| | 8.1664 (1.2); 7.8860 (2.0); 7.8628 (2.2); 7.8000 (2.6); 7.7958 (2.6); |
| | 7.6852 (1.2); 7.6734 (1.2); 7.6644 (1.2); 7.6526 (1.2); 7.3853 (1.7); |
| | 7.3803 (1.6); 7.3622 (1.6); 7.3572 (1.5); 3.7011 (1.4); 3.6870 (3.6); |
| | 3.6733 (2.4); 3.5890 (2.6); 3.5754 (4.0); 3.5614 (1.5); 3.3343 (0.7); |
| | 3.3097 (0.7); 3.3026 (0.6); 3.2682 (19.6); 3.2315 (0.3); 3.0568 (16.0); |
| | 2.5073 (33.9); 2.5030 (43.4); 2.4986 (31.8); −0.0002 (0.6) |
| 13 | 9.3481 (2.7); 9.3425 (2.8); 9.2839 (4.5); 9.2111 (0.4); 8.6865 (1.9); |
| | 8.6765 (2.0); 8.5182 (1.2); 8.5155 (1.2); 8.4972 (1.4); 8.1786 (0.8); |
| | 7.8768 (2.2); 7.8538 (2.4); 7.7794 (3.1); 7.7767 (3.1); 7.6842 (1.3); |
| | 7.6725 (1.4); 7.6638 (1.4); 7.6520 (1.3); 7.3867 (1.8); 7.3821 (1.7); |
| | 7.3637 (1.7); 7.3589 (1.6); 4.2839 (0.4); 4.2670 (1.0); 4.2497 (1.4); |
| | 4.2324 (1.1); 4.2156 (0.4); 3.3441 (0.4); 3.3362 (0.4); 3.3185 (0.4); |
| | 3.3104 (0.4); 3.0336 (16.0); 2.5030 (50.2); 1.4144 (14.3); 1.3971 (14.2); |
| | −0.0002 (0.8) |
| 14 | 9.3498 (2.2); 9.3434 (2.2); 9.3061 (3.9); 8.6933 (1.5); 8.6902 (1.6); |
| | 8.6817 (1.6); 8.6784 (1.6); 8.5245 (0.8); 8.5209 (1.0); 8.5181 (0.9); |
| | 8.5145 (0.8); 8.5036 (0.9); 8.5001 (1.0); 8.4973 (1.0); 8.4937 (0.9); |
| | 7.9012 (1.8); 7.8780 (2.0); 7.8419 (2.4); 7.8380 (2.4); 7.6877 (1.2); |
| | 7.6760 (1.2); 7.6669 (1.2); 7.6550 (1.1); 7.4015 (1.7); 7.3965 (1.6); |
| | 7.3785 (1.5); 7.3734 (1.5); 6.4264 (0.6); 6.2983 (0.6); 6.2895 (1.2); |
| | 6.2808 (0.6); 6.1526 (0.6); 3.9948 (0.8); 3.9861 (0.9); 3.9563 (1.9); |
| | 3.9476 (1.9); 3.9177 (1.0); 3.9089 (0.9); 3.3219 (10.2); 3.0800 (16.0); |
| | 2.5245 (0.9); 2.5112 (18.0); 2.5069 (35.6); 2.5024 (46.6); 2.4980 |
| | (34.2); 2.4937 (17.0); 2.0864 (0.3); −0.0002 (0.9) |
| 15 | 9.3463 (2.4); 9.3400 (2.4); 9.2932 (4.2); 8.6898 (1.7); 8.6866 (1.7); |
| | 8.6781 (1.7); 8.6748 (1.7); 8.5204 (0.9); 8.5169 (1.1); 8.5139 (1.0); |
| | 8.5105 (0.9); 8.4996 (1.0); 8.4961 (1.1); 8.4931 (1.2); 8.4896 (1.0); |
| | 7.8859 (2.0); 7.8628 (2.2); 7.8227 (2.6); 7.8192 (2.7); 7.6846 (1.3); |
| | 7.6726 (1.3); 7.6636 (1.3); 7.6518 (1.2); 7.4578 (2.8); 7.4529 (1.1); |
| | 7.4415 (1.6); 7.4365 (6.1); 7.4012 (6.4); 7.3795 (4.1); 7.3746 (2.1); |
| | 4.6988 (6.7); 3.3218 (35.0); 3.0778 (16.0); 2.6756 (0.3); 2.6717 (0.4); |
| | 2.6668 (0.3); 2.5245 (1.6); 2.5110 (29.4); 2.5069 (56.6); 2.5024 |
| | (72.9); 2.4980 (53.6); 2.4940 (27.0); 2.3338 (0.3); 2.3292 (0.4); 2.3248 |
| | (0.3); −0.0002 (6.8) |
| 16 | 9.3508 (2.4); 9.3444 (2.5); 9.3045 (4.2); 8.6922 (1.7); 8.6891 (1.8); |
| | 8.6806 (1.8); 8.6773 (1.8); 8.5248 (1.0); 8.5212 (1.1); 8.5184 (1.0); |
| | 8.5150 (0.9); 8.5040 (1.0); 8.5004 (1.1); 8.4976 (1.1); 8.4942 (0.9); |
| | 7.9017 (2.0); 7.8786 (2.3); 7.8565 (2.6); 7.8523 (2.7); 7.6873 (1.3); |
| | 7.6755 (1.3); 7.6665 (1.3); 7.6547 (1.3); 7.5196 (0.8); 7.5148 (1.1); |
| | 7.5099 (1.0); 7.5027 (1.4); 7.4956 (1.4); 7.4374 (1.9); 7.4325 (1.8); |
| | 7.4143 (1.7); 7.4094 (1.7); 7.3741 (6.9); 7.3673 (4.7); 4.7906 (7.2); |
| | 3.3225 (31.6); 3.1073 (16.0); 2.6759 (0.3); 2.6713 (0.4); 2.6671 (0.3); |
| | 2.5108 (28.6); 2.5067 (54.1); 2.5023 (69.5); 2.4979 (51.4); 2.3292 |
| | (0.4); 1.3975 (5.9); 1.2346 (0.9); −0.0002 (6.5) |
| 17 | 9.3436 (1.9); 9.3393 (1.9); 9.2901 (3.5); 9.2888 (3.5); 8.6861 (1.4); |
| | 8.6839 (1.4); 8.6783 (1.4); 8.6760 (1.4); 8.5134 (0.8); 8.5111 (0.9); |
| | 8.5091 (0.9); 8.5067 (0.8); 8.4996 (0.9); 8.4972 (0.9); 8.4953 (1.0); |
| | 8.4928 (0.9); 7.8828 (1.7); 7.8675 (1.9); 7.8336 (2.0); 7.8314 (2.1); |
| | 7.6762 (1.0); 7.6685 (1.0); 7.6624 (1.0); 7.6546 (1.0); 7.4400 (2.0); |
| | 7.4321 (0.7); 7.4190 (1.8); 7.4074 (3.1); 7.4046 (2.0); 7.4022 (1.3); |
| | 7.3992 (2.0); 7.3963 (1.3); 7.3926 (1.7); 7.3892 (2.0); 7.3857 (0.6); |
| | 7.3320 (1.4); 7.3200 (1.0); 5.7502 (5.5); 4.7157 (5.8); 3.3066 (33.7); |
| | 3.0859 (16.0); 2.6128 (0.4); 2.5220 (0.7); 2.5189 (0.8); 2.5158 (0.8); |
| | 2.5070 (20.1); 2.5040 (44.0); 2.5010 (62.0); 2.4980 (44.4); 2.4949 |
| | (20.4); 2.3851 (0.4); 1.3980 (1.2); 1.2346 (0.5); −0.0002 (4.6) |
| 18 | 9.3781 (1.7); 9.3718 (1.8); 9.3493 (5.6); 8.7786 (2.9); 8.7723 (3.0); |
| | 8.7257 (1.3); 8.7164 (1.3); 8.7140 (1.3); 8.5643 (0.8); 8.5609 (0.9); |
| | 8.5579 (0.9); 8.5543 (0.8); 8.5435 (0.9); 8.5400 (1.0); 8.5370 (1.0); |
| | 8.5334 (0.8); 8.3283 (3.0); 8.3220 (3.0); 7.7146 (1.1); 7.7029 (1.1); |
| | 7.6939 (1.1); 7.6820 (1.0); 3.5888 (0.9); 3.5708 (3.0); 3.5528 (3.1); |
| | 3.5348 (1.0); 3.3224 (5.5); 3.0792 (16.0); 2.5252 (0.5); 2.5114 (13.8); |
| | 2.5072 (28.6); 2.5028 |
| | (38.3); 2.4983 (27.6); 2.4940 (13.3); 1.2341 (3.4); 1.2161 (7.4); 1.1981 |
| | (3.2); −0.0002 (9.5); −0.0084 (0.4) |
| 19 | 9.4006 (1.9); 9.3613 (5.2); 8.7822 (3.3); 8.7760 (3.3); 8.7458 (1.4); |
| | 8.7343 (1.4); 8.5985 (0.9); 8.5791 (0.9); 8.3216 (3.4); 8.3154 (3.2); |
| | 8.1367 (0.4); 7.7491 (0.9); 7.7371 (1.0); 7.7281 (0.9); 7.7160 (0.8); |
| | 4.6244 (0.7); 3.0751 (16.0); 3.0338 (14.9); 2.6714 (0.5); 2.5065 (75.0); |
| | 2.5026 (93.0); 2.4989 (68.2); 2.3291 (0.5); −0.0001 (34.9) |
| 20 | 9.3739 (1.8); 9.3678 (1.9); 9.3422 (5.6); 8.7597 (3.1); 8.7534 (3.2); |
| | 8.7236 (1.4); 8.7117 (1.4); 8.5598 (0.8); 8.5563 (1.0); 8.5534 (1.0); |
| | 8.5499 (0.8); 8.5389 (0.9); 8.5354 (1.0); 8.5326 (1.0); 8.5290 (0.9); |
| | 8.2906 (3.3); 8.2843 (3.2); 7.7133 (1.2); 7.7014 (1.1); 7.6923 (1.1); |
| | 7.6807 (1.1); 3.3224 (6.2); 3.0370 (16.0); 2.7459 (0.3); 2.7363 (0.7); |
| | 2.7285 (0.8); 2.7239 (0.7); 2.7191 (1.2); 2.7098 (1.0); 2.7017 (0.7); |
| | 2.6919 (0.4); 2.5247 (0.7); 2.5070 (34.1); 2.5026 (45.2); 2.4982 (32.6); |
| | 0.9648 (0.5); 0.9490 (2.2); 0.9439 (2.8); 0.9335 (1.6); 0.9210 (1.4); |
| | 0.9142 (1.5); 0.9060 (2.1); 0.8960 (1.4); 0.8915 (1.5); 0.8737 (0.4); |
| | 0.0077 (0.6); −0.0002 (18.7); −0.0083 (0.7) |
| 21 | 9.3799 (2.2); 9.3736 (2.3); 9.3518 (5.7); 8.7839 (3.1); 8.7777 (3.2); |
| | 8.7265 (1.6); 8.7175 (1.6); 8.7148 (1.6); 8.5663 (0.9); 8.5630 (1.0); |
| | 8.5573 (0.9); 8.5455 (1.0); 8.5420 (1.1); 8.5397 (1.1); 8.5362 (0.9); |
| | 8.3532 (3.2); 8.3469 (3.1); 7.7158 (1.3); 7.7039 (1.3); 7.6950 (1.2); |
| | 7.6830 (1.2); 3.4093 (4.0); 3.3914 (4.1); 3.3227 (15.8); 3.0980 (16.0); |
| | 2.5069 (39.9); 2.5027 (51.9); 2.4985 (37.8); 1.1692 (0.5); 1.1620 |
| | (0.5); 1.1502 (0.8); 1.1382 (0.5); 1.1311 (0.6); 0.5354 (0.6); 0.5240 |
| | (2.0); 0.5199 (2.2); 0.5094 (1.1); 0.5041 (2.0); 0.4999 (2.0); 0.4898 |
| | (0.8); 0.3697 (0.8); 0.3585 (2.6); 0.3440 (2.5); 0.3324 (0.6); −0.0002 |
| | (1.0) |
| 22 | 9.3459 (5.3); 8.7703 (2.2); 8.7650 (2.2); 8.5620 (1.2); 8.5421 (1.3); |
| | 8.3167 (3.3); 8.3105 (3.1); 7.7072 (0.7); 4.2926 (0.4); 4.2755 (1.0); |
| | 4.2583 (1.4); 4.2410 (1.1); 4.2238 (0.4); 3.3241 (27.6); 3.0622 (16.0); |
| | 2.6713 (0.4); 2.5069 (49.6); 2.5028 (62.6); 2.4987 (46.4); 2.3291 |
| | (0.3); 1.4223 (14.1); 1.4050 (13.9); −0.0001 (44.2) |
| 23 | 9.3454 (2.2); 9.3392 (2.2); 9.2960 (4.1); 8.6903 (1.6); 8.6875 (1.6); |
| | 8.6785 (1.6); 8.6757 (1.6); 8.5202 (0.9); 8.5167 (1.0); 8.5142 (1.0); |
| | 8.5104 (0.9); 8.4991 (1.0); 8.4928 (1.1); 8.4533 (2.3); 8.4473 (2.2); |
| | 8.1388 (0.7); 7.9528 (0.7); 7.8854 (2.0); 7.8778 (1.4); 7.8716 (1.4); |
| | 7.8623 (2.3); 7.8574 (1.8); 7.8509 (1.4); 7.8247 (2.6); 7.8204 (2.6); |
| | 7.6855 (1.3); 7.6734 (1.3); 7.6647 (1.3); 7.6530 (1.2); 7.5590 (2.7); |
| | 7.5385 (2.4); 7.4104 (1.8); 7.4055 (1.6); 7.3874 (1.6); 7.3823 (1.6); |
| | 4.7578 (6.6); 3.3218 (60.7); 3.0712 (16.0); 2.9792 (0.3); 2.8905 (4.7); |
| | 2.7310 (4.2); 2.6893 (16.0); 2.6752 (0.9); 2.6706 (1.2); 2.6663 (0.8); |
| | 2.5239 (2.8); 2.5102 (73.7); 2.5061 (150.5); 2.5017 (199.4); 2.4972 |
| | (142.8); 2.4931 (68.5); 2.4450 (0.3); 2.3325 (0.8); 2.3282 (1.1); |
| | 2.3240 (0.8); 1.2349 (0.4); −0.0002 (2.2) |
| 24 | 9.3511 (15.4); 8.6937 (4.0); 8.6907 (4.4); 8.6820 (4.2); 8.6789 (4.4); |
| | 8.5299 (2.3); 8.5264 (2.7); 8.5235 (2.7); 8.5201 (2.4); 8.5091 (2.5); |
| | 8.5055 (2.8); 8.5027 (2.9); 8.4992 (2.4); 7.9599 (6.6); 7.9563 (6.7); |
| | 7.8980 (16.0); 7.8723 (5.0); 7.8492 (5.6); 7.6900 (3.2); 7.6782 (3.2); |
| | 7.6693 (3.2); 7.6574 (3.0); 7.4423 (4.5); 7.4374 (4.5); 7.4192 (4.0); |
| | 7.4143 (4.1); 5.7560 (1.7); 4.7396 (1.9); 4.7171 (6.1); 4.6944 (6.4); |
| | 4.6717 (2.2); 3.3221 (44.3); 2.6758 (0.5); 2.6716 (0.6); 2.6673 (0.5); |
| | 2.5069 (80.6); 2.5025 (105.0); 2.4981 (79.5); 2.3336 (0.4); 2.3293 |
| | (0.6); 2.3249 (0.5); 2.0864 (0.4); 2.0749 (0.4); 1.2324 (0.4); −0.0002 |
| | (1.8) |
| 25 | 9.3594 (4.4); 9.3535 (4.5); 9.3381 (9.8); 9.2109 (0.5); 8.6891 (3.3); |
| | 8.6775 (3.2); 8.5296 (2.0); 8.5261 (2.4); 8.5233 (2.3); 8.5200 (2.0); |
| | 8.5088 (2.3); 8.5052 (2.6); 8.5025 (2.6); 8.4991 (2.1); 7.9435 (5.9); |
| | 7.9399 (6.1); 7.8493 (4.5); 7.8262 (5.1); 7.7541 (14.6); 7.6878 (2.7); |
| | 7.6760 (2.7); 7.6670 (2.8); 7.6552 (2.7); 7.4528 (4.2); 7.4479 (4.1); |
| | 7.4297 (3.7); 7.4248 (3.8); 3.9177 (1.9); 3.9001 (6.3); 3.8823 (6.4); |
| | 3.8647 (2.0); 3.3244 (9.2); 2.6729 (0.4); 2.5079 (48.9); 2.5035 (63.0); |
| | 2.4991 (47.1); 2.3303 (0.4); 1.2298 (0.4); 1.2151 (7.2); 1.1974 (16.0); |
| | 1.1796 (7.0); 1.1103 (0.4); −0.0002 (0.6) |
| 26 | 9.3588 (6.3); 9.3525 (6.3); 9.3396 (10.5); 8.6906 (4.3); 8.6875 (4.5); |
| | 8.6789 (4.5); 8.6757 (4.5); 8.5312 (2.4); 8.5277 (2.8); 8.5249 (2.7); |
| | 8.5213 (2.4); 8.5104 (2.6); 8.5068 (2.8); 8.5039 (2.9); 8.5004 (2.4); |
| | 7.9611 (6.7); 7.9578 (6.6); 7.8531 (5.1); 7.8300 (5.7); 7.7854 (16.0); |
| | 7.6878 (3.3); 7.6760 (3.2); 7.6670 (3.2); 7.6551 (3.1); 7.4599 (4.7); |
| | 7.4550 (4.6); 7.4368 (4.2); 7.4319 (4.2); 3.7598 (9.0); 3.7421 (9.0); |
| | 3.3237 (48.2); 2.6763 (0.4); 2.6719 (0.6); 2.6672 (0.4); 2.5072 (69.4); |
| | 2.5028 (88.5); 2.4984 (65.3); 2.3335 (0.4); 2.3296 (0.5); 2.3251 |
| | (0.4); 2.0750 (1.0); 1.2394 (0.4); 1.2331 (0.7); 1.2208 (1.3); 1.2136 |
| | (1.3); 1.2019 (2.1); 1.1901 (1.3); 1.1825 (1.4); 1.1708 (0.7); 1.1644 |
| | (0.5); 0.5188 (1.5); 0.5073 (4.7); 0.5029 (5.5); 0.4929 (3.1); 0.4873 |
| | (4.8); 0.4829 (5.0); 0.4731 (2.1); 0.4361 (0.3); 0.3948 (2.2); 0.3831 |
| | (6.3); 0.3731 (5.5); 0.3691 (5.8); 0.3574 (1.4); 0.0076 (0.7); −0.0002 |
| | (15.4); −0.0083 (0.6) |
| 27 | 9.3535 (5.2); 9.3472 (5.4); 9.3354 (9.8); 9.3343 (9.7); 8.6881 (3.6); |
| | 8.6851 (3.8); 8.6764 (3.8); 8.6733 (3.8); 8.5260 (2.1); 8.5224 (2.5); |
| | 8.5195 (2.4); 8.5160 (2.2); 8.5052 (2.4); 8.5016 (2.6); 8.4986 (2.7); |
| | 8.4951 (2.2); 7.9608 (6.1); 7.9574 (6.0); 7.8489 (4.7); 7.8347 (16.0); |
| | 7.8258 (5.5); 7.6849 (2.9); 7.6730 (2.9); 7.6640 (2.9); 7.6522 (2.8); |
| | 7.4603 (4.3); 7.4553 (4.2); 7.4372 (3.9); 7.4322 (4.0); 7.4168 (4.8); |
| | 7.3991 (8.6); 7.3670 (4.3); 7.3622 (1.6); 7.3495 (8.6); 7.3306 (4.6); |
| | 7.3082 (3.5); 7.2969 (1.2); 7.2905 (3.7); 7.2835 (0.8); 7.2727 (1.0); |
| | 5.0441 (14.3); 3.3208 (59.9); 2.6753 (0.7); 2.6709 (1.0); 2.6665 (0.7); |
| | 2.5239 (3.2); 2.5063 (123.6); 2.5018 (160.6); 2.4974 (119.3); 2.3331 |
| | (0.7); 2.3286 (1.0); 2.3242 (0.8); 2.0858 (0.4); 1.3974 (2.4); 1.2335 |
| | (1.0); 0.0079 (0.6); −0.0002 (15.7) |
| 28 | 9.4821 (0.4); 9.4684 (0.4); 9.4625 (0.4); 9.3422 (11.2); 8.8049 (0.4); |
| | 8.7954 (0.4); 8.7146 (0.6); 8.5232 (4.6); 8.5031 (4.7); 8.3154 (0.5); |
| | 7.9790 (9.8); 7.9546 (0.8); 7.9054 |
| | (16.0); 7.8818 (1.9); 7.8634 (6.5); 7.8404 (7.0); 7.6857 (2.7); 7.6358 |
| | (0.7); 7.6084 (1.1); 7.5509 (4.6); 7.5331 (11.7); 7.5140 (11.3); 7.5027 |
| | (8.6); 7.4803 (10.2); 7.4659 (7.2); 7.4469 (3.9); 7.4294 (13.4); 7.4105 |
| | (10.5); 7.3311 (1.0); 7.3123 (0.9); 7.2653 (0.4); 7.2447 (0.4); |
| | 7.2344 (0.4); 3.6078 (0.3); 3.5910 (0.3); 3.4585 (0.8); 3.3507 (1.7); |
| | 3.2142 (0.7); 3.1180 (0.4); 3.1064 (0.3); 2.9816 (0.5); 2.9638 (0.5); |
| | 2.9183 (0.5); 2.8902 (1.6); 2.7317 (1.6); 2.6707 (1.6); 2.5019 (249.1); |
| | 2.4064 (0.7); 2.3287 (1.6); 2.0736 (0.8); 1.5439 (0.4); 1.2584 (0.4); |
| | 1.2362 (0.4); 0.9812 (0.4); 0.9627 (0.6); 0.9467 (0.4); 0.1453 (0.3); |
| | −0.0003 (59.4); −0.1498 (0.3) |
| 29 | 9.8282 (3.3); 9.4005 (12.8); 9.3761 (3.1); 8.7994 (6.1); 8.7933 (6.3); |
| | 8.7290 (2.6); 8.7179 (2.6); 8.5591 (2.5); 8.5390 (2.6); 8.4646 (7.8); |
| | 8.4584 (7.4); 8.3188 (1.4); 8.3126 |
| | (1.6); 8.2483 (1.6); 8.2420 (1.4); 7.8293 (14.1); 7.7188 (2.6); 7.7073 |
| | (2.9); 7.6985 (3.2); 7.6868 (3.3); 5.7571 (2.5); 3.9255 (2.0); 3.9078 |
| | (6.3); 3.8900 (6.4); 3.8716 (2.0); 3.3214 (119.4); 2.6742 (1.7); 2.6706 |
| | (2.2); 2.5799 (0.5); 2.5628 (0.5); 2.5058 (292.1); 2.5016 (374.0); |
| | 2.4973 (271.4); 2.3286 (2.1); 2.3244 (1.6); 1.2220 (7.2); 1.2042 (16.0); |
| | 1.1866 (7.1); 1.1709 (0.3); −0.0002 (10.8) |

^{a}¹H NMR (400.0 MHz, d₆-DMSO) for Examples 3-16 and 18-29.
¹H NMR (601.6 MHz, d₆-DMSO) for Example 17.

### Synthesis of Compounds of the Formula (B′-1)

### (B′-1)-1

### 4-(Cyclopropylmethyl)-1-methyl-1,2,4-triazolidine-3,5-dione

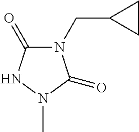

### Reaction Step 1 ethyl 1-methylhydrazinecarboxylate

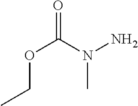

200 ml of a 50% aqueous methylhydrazine solution were cooled to −10° C. To this was added a solution of 62.6 g (577 mmol) of ethyl carbonochloridate in 200 ml of dichloromethane in portions, in such a way that the temperature was kept below 0° C. The reaction mixture was stirred at room temperature overnight, then saturated sodium chloride solution was added and the mixture was extracted with dichloromethane (3×200 ml). The organic phases were combined, dried over sodium sulphate, filtered and freed of the solvent under reduced pressure.

After distillation under reduced pressure, 60.0 g (80% of theory) of the title compound were isolated.

### Reaction Step 2 4-(Cyclopropylmethyl)-1-methyl-1,2,4-triazolidine-3,5-dione

To a solution of 6.08 g (51.5 mmol) of ethyl 1-methylhydrazinecarboxylate (cf. reaction step 1) in 150 ml of dichloromethane were added 5.00 g (51.5 mmol) of (isocyanatomethyl)cyclopropane and the reaction mixture was stirred at room temperature overnight. All the volatile constituents were removed under reduced pressure. To the residue was added a saturated methanolic sodium methoxide solution (prepared from 2.37 g of sodium and 100 ml of methanol), and the mixture was heated under reflux for 6 hours. After cooling, at room temperature, 12 ml of concentrated hydrochloric acid were added. The solution was freed of the solvent under reduced pressure. The residue was taken up in ethyl acetate and heated up to reflux temperature. The suspension was hot-filtered and then the solvent was removed from the filtrate under reduced pressure. The resulting residue was chromatographed using silica gel, and 4.80 g (55% of theory after 2 reaction steps) of the title compound were obtained.

¹H-NMR (400.0 MHz, d₆-DMSO): δ=10.40 (bs, 1H), 3.28-3.15 (bd, 2H), 3.05 (bs, 3H), 1.10-0.98 (m, 1H), 0.50-0.40 (m, 2H), 0.30-0.20 (m, 2H) ppm.

### (B′-1)-2

### 1-Methyl-4-(2,2,2-trifluoroethyl)-1,2,4-triazolidine-3,5-dione

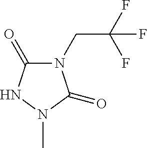

A mixture of 5.00 g (42.3 mmol) of ethyl 1-methylhydrazinecarboxylate, 9.53 g (42.3 mmol) of 2,2,2-trifluoroethyl (2,2,2-trifluoroethyl)carbamate and 50 ml of N,N-diisopropylethylamine (Hünig's base) was heated under reflux for 48 hours and then freed of volatile constituents under reduced pressure. To the residue was added a methanolic sodium methoxide solution (prepared from 1.95 g of sodium and 100 ml of methanol), and the mixture was heated under reflux for 6 hours. After cooling, 10 ml of concentrated hydrochloric acid were added at room temperature. The solution was freed of the solvent under reduced pressure. The residue was taken up in ethyl acetate and heated up to reflux temperature. The suspension was hot-filtered and then the solvent was removed from the filtrate under reduced pressure. The resulting residue was chromatographed using silica gel. 5.20 g (62% of theory after 2 reaction steps) of the title compound were isolated.

¹H-NMR (500.0 MHz, d₆-DMSO): δ=10.80 (bs, 1H), 4.18 (q, 2H), 3.05 (s, 3H) ppm.

### (B′-1)-3

### 4-Methyl-1-(2,2,2-trifluoroethyl)-1,2,4-triazolidine-3,5-dione

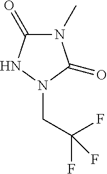

To a suspension of 15.5 g (134 mmol) of 4-methyl-1,2,4-triazolidine-3,5-dione in 150 ml of tetrahydrofuran were added 28.1 ml (202 mmol) of triethylamine and 33.4 g (161 mmol) of 2,2,2-trifluoroethyl trifluoromethanesulphonate, and the resulting mixture was stirred at room temperature for 48 hours. Then it was diluted with 300 ml of chloroform and filtered. The filtrate was freed of the solvent under reduced pressure. The residue was chromatographed using silica gel. 2.20 g (8% of theory) of the title compound were isolated.

¹H-NMR (500.0 MHz, CDCl₃): δ=7.98 (bs, 1H), 4.12 (q, 2H), 3.13 (s, 3H) ppm.

### (B′-1)-4

### 1-Methyl-4-(2,2-difluoroethyl)-1,2,4-triazolidine-3,5-dione

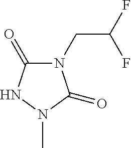

To a solution, cooled to −25° C., of 10.0 g (123 mmol) of 2,2-difluoroethanamine and 52 ml (373 mmol) of triethylamine in 100 ml of dichloromethane were added 33.5 g (148 mmol) of bis(2,2,2-trifluoroethyl) carbonate. The resulting mixture was stirred at room temperature overnight. The volatile constituents were then removed under reduced pressure. To the remaining residue were added 50 ml of N,N-diisopropylethylamine (Hünig's base) and 14.6 g (124 mmol) of ethyl 1-methylhydrazinecarboxylate, and the mixture was stirred under reflux for 48 hours. After cooling, all the volatile constituents were removed under reduced pressure. To the residue was added a methanolic sodium methoxide solution (prepared from 7.00 g of sodium and 100 ml of methanol), and the mixture was heated under reflux for 4 hours. After cooling, the pH of the mixture was acidified with concentrated hydrochloric acid. The solution was freed of solvent under reduced pressure, and the remaining residue was taken up in ethyl acetate and heated up to reflux temperature. The suspension was hot-filtered and then the solvent was removed from the filtrate under reduced pressure. The resulting residue was chromatographed using silica gel, and 5.30 g (24% of theory after 2 steps) of the title compound were obtained.

¹H-NMR (400.0 MHz, d₆-DMSO): δ=8.62 (bs, 1H), 6.03 (ttd, 1H), 3.89 (ttd, 2H) ppm, 3.22 (s, 3H) ppm.

In analogy to the syntheses described further up, the compounds of the formulae (B′-1)-5 to (B′-1)-10 were prepared:

### (B′-1)-5

### 4-(2-Methoxyethyl)-1-methyl-1,2,4-triazolidine-3,5-dione

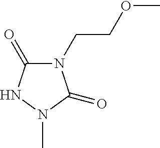

¹H-NMR (400.0 MHz, d₆-DMSO): δ=10.42 (s, 1H), 3.55-3.45 (m, 4H), 3.21 (s, 3H), 3.00 (s, 3H) ppm.

### (B′-1)-6

### 4-(4-Chlorobenzyl)-1-methyl-1,2,4-triazolidine-3,5-dione

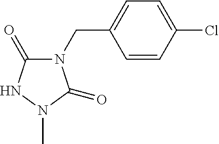 [SMILES: Cn1[nH]c(=O)n(Cc2ccc(Cl)cc2)c1=O]

¹H-NMR (400.0 MHz, d₆-DMSO): δ=10.61 (s, 1H), 7.40 (d, 2H), 7.29 (d, 2H), 4.55 (s, 2H), 3.04 (s, 3H) ppm.

### (B′-1)-7

### 4-(3-Chlorobenzyl)-1-methyl-1,2,4-triazolidine-3,5-dione

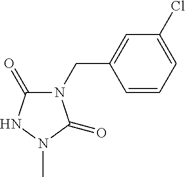 [SMILES: Cn1[nH]c(=O)n(Cc2cccc(Cl)c2)c1=O]

¹H-NMR (400.0 MHz, d₆-DMSO): δ=10.63 (bs, 1H), 7.40-7.20 (m, 4H), 4.56 (s, 2H), 3.04 (s, 3H) ppm.

### (B′-1)-8

### 4-(2-Chlorobenzyl)-1-methyl-1,2,4-triazolidine-3,5-dione

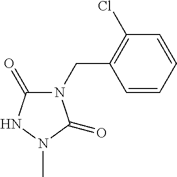 [SMILES: Cn1[nH]c(=O)n(Cc2ccccc2Cl)c1=O]

¹H-NMR (400.0 MHz, d₆-DMSO): δ=10.68 (bs, 1H), 7.50-7.44 (m, 1H), 7.37-7.30 (m, 2H), 7.20-7.14 (m, 1H), 4.63 (s, 2H), 3.06 (s, 3H) ppm.

### (B′-1)-9

### 4-Benzyl-1-methyl-1,2,4-triazolidine-3,5-dione

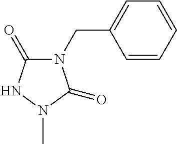

¹H-NMR (400.0 MHz, d₆-DMSO): δ=10.55 (bs, 1H), 7.40-7.20 (m, 5H), 4.55 (s, 2H), 3.04 (s, 3H) ppm.

### (B′-1)-10

### 1-Methyl-4-[2-(methylsulphanyl)ethyl]-1,2,4-triazolidine-3,5-dione

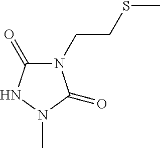

¹H-NMR (400.0 MHz, d₆-DMSO): δ=8.53 (bs, 1H), 3.70 (t, 2H), 3.19 (t, 3H), 2.78 (t, 2H), 2.15 (s, 3H) ppm.

### Synthesis of Compounds of the Formula (B′-2)

### (B′-2)-1

### 4-(2,2,2-Trifluoroethyl)-1,2,4-triazine-3,5(2H,4H)-dione

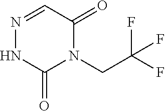 [SMILES: O=c1cn[nH]c(=O)n1CC(F)(F)F]

To a solution of 5.00 g (32.2 mmol) of 2-acetyl-1,2,4-triazine-3,5(2H,4H)-dione in 30 ml of N,N-dimethylformamide (DMF) were added 1.42 g (35.5 mmol) of 60% sodium hydride in mineral oil in portions. The reaction mixture was stirred at room temperature for 30 minutes and then cooled to 0° C. Thereafter, 7.85 g (33.8 mmol) of trifluoroethyl triflate in 5 ml of DMF were added dropwise and the reaction mixture was stirred at room temperature overnight.

Subsequently, the solvent was removed under reduced pressure, and the remaining residue was taken up in ethanol, 0.56 g (3.22 mmol) of para-toluenesulphonic acid was added and the mixture was heated under reflux for 2 hours. After the solvent had been removed under reduced pressure, the crude mixture was chromatographed using silica gel, giving 2.14 g (95% purity, 34% of theory) of the title compound.

¹H-NMR (400.0 MHz, d₆-DMSO): δ=12.75 (s, 1H), 7.45 (s, 1H), 4.53 (q, 2H) ppm.

### (B′-1)-2

### 4-(2,2,2-Trifluoroethyl)-1,2,4-triazine-3,5(2H,4H)-dione

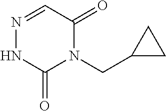 [SMILES: O=c1cn[nH]c(=O)n1CC1CC1]

Analogously to the synthesis described further up, 5.00 g (32.2 mmol) of 2-acetyl-1,2,4-triazine-3,5(2H,4H)-dione were used to isolate 2.83 g (95% purity, 50% of theory) of the title compound.

¹H-NMR (400.0 MHz, d₆-DMSO): δ=12.53 (s, 1H), 7.38 (s, 1H), 3.65 (d, 2H), 1.21-1.12 (m, 1H), 0.50-0.30 (m, 4H) ppm.

### Biological Examples

Meloidogyne incognita Test

Solvent: 125.0 parts by weight of acetone

To produce a suitable active ingredient formulation, 1 part by weight of active ingredient is mixed with the stated amount of solvent and the concentrate is diluted to the desired concentration with water.

Vessels are filled with sand, active ingredient solution, an egg/larvae suspension of the southern root-knot nematode (Meloidogyne incognita) and lettuce seeds. The lettuce seeds germinate and the plants develop. The galls develop on the roots.

After 14 days, the nematicidal efficacy in % is determined by the formation of galls. 100% means that no galls were found; 0% means that the number of galls on the treated plants corresponds to the untreated control.

In this test, for example, the following compounds from the preparation examples showed an efficacy of 90% at an application rate of 20 ppm: 1.

Myzus persicae—Oral Test

Solvent: 100 parts by weight of acetone

To produce a suitable active ingredient formulation, 1 part by weight of active ingredient is dissolved with the stated parts by weight of solvent and made up to the desired concentration with water.

50 μl of the active ingredient formulation are transferred into microtitre plates and made up to a final volume of 200 μl with 150 μl of IPL41 insect medium (33%+15% sugar). Subsequently, the plates are sealed with parafilm, which a mixed population of green peach aphids (Myzus persicae) within a second microtitre plate is able to puncture and imbibe the solution.

After 5 days, the efficacy in % is determined. 100% means that all the aphids have been killed; 0% means that no aphids have been killed.

In this test, for example, the following compounds from the preparation examples showed an efficacy of 100% at an application rate of 4 ppm: 1, 2, 3, 4, 5, 7, 8, 9, 10, 11, 12, 14, 15, 17, 18, 20, 21, 22, 23, 24, 25, 26, 27.

In this test, for example, the following compounds from the preparation examples showed an efficacy of 90% at an application rate of 4 ppm: 6, 13, 16, 19, 28.

Myzus persicae—Spray Test

Solvent: 78 parts by weight of acetone
1.5 parts by weight of dimethylformamide

Emulsifier: alkylaryl polyglycol ether

To produce a suitable active ingredient formulation, 1 part by weight of active ingredient is dissolved with the specified parts by weight of solvent and made up to the desired concentration with water containing an emulsifier concentration of 1000 ppm. To produce further test concentrations, the formulation is diluted with emulsifier-containing water.

Discs of Chinese cabbage leaves (Brassica pekinensis) infested by all stages of the green peach aphid (Myzus persicae) are sprayed with an active ingredient formulation of the desired concentration.

After 5-6 days, the efficacy in % is determined. 100% means that all the aphids have been killed; 0% means that no aphids have been killed.

In this test, for example, the following compounds from the preparation examples showed an efficacy of 100% at an application rate of 500 g/ha: 3, 6, 8, 18, 19, 21, 23, 25.

In this test, for example, the following compounds from the preparation examples showed an efficacy of 90% at an application rate of 500 g/ha: 1, 2, 4, 5, 7, 9, 11, 12, 14, 20, 26, 27.

Phaedon cochleariae—Spray Test

Solvent: 78.0 parts by weight of acetone
1.5 parts by weight of dimethylformamide

Emulsifier: alkylaryl polyglycol ether

To produce a suitable active ingredient formulation, 1 part by weight of active ingredient is dissolved with the specified parts by weight of solvent and made up to the desired concentration with water containing an emulsifier concentration of 1000 ppm. To produce further test concentrations, the formulation is diluted with emulsifier-containing water.

Discs of Chinese cabbage leaves (Brassica pekinensis) are sprayed with an active compound formulation of the desired concentration and, after drying, populated with larvae of the mustard beetle (Phaedon cochleariae).

After 7 days, the efficacy in % is determined. 100% means that all the beetle larvae have been killed; 0% means that no beetle larvae have been killed.

In this test, for example, the following compounds from the preparation examples showed an efficacy of 83% at an application rate of 500 g/ha: 4, 25.

1. Compound of formula (I) 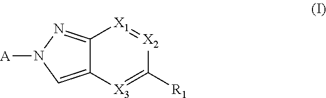
in which
A is an A radical from the group of (A-b) to (A-f) 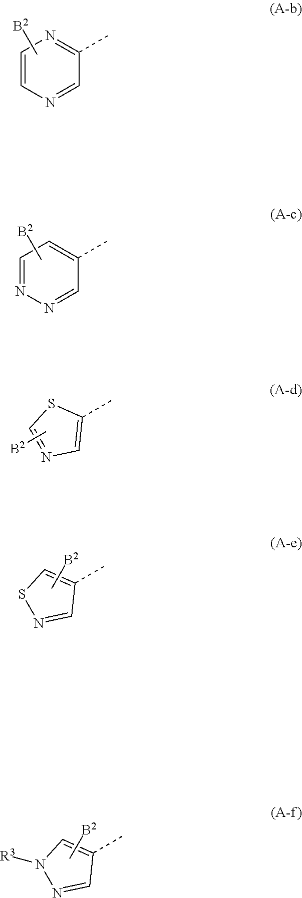
in which the broken line denotes the bond to the carbon atom of the bicyclic system of the formula (I) and
B² is a radical from the group of hydrogen, halogen, cyano, nitro, alkyl, haloalkyl, alkoxy, haloalkoxy and in each case optionally substituted cycloalkyl and cycloalkenyl,
X₁ is nitrogen (N) or CH,
X₂ is nitrogen or CH,
X₃ is nitrogen or CH, where either none or only one of the variables X₁, X₂ and X₃ is nitrogen,
R₁ is a B radical from the group of 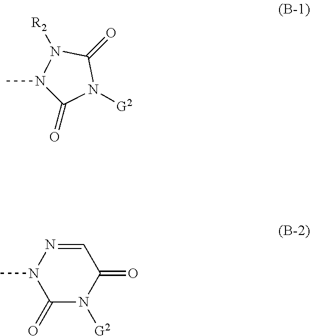
in which the broken line denotes the bond to the carbon atom of the bicyclic system of the formula (I),
R₂ is a radical from the group of hydrogen, alkyl, haloalkyl, alkenyl, alkynyl, alkoxyalkyl, alkyl-S-alkyl, alkyl-S(O)-alkyl, alkyl-S(O)₂-alkyl, cycloalkyl, halocycloalkyl and cycloalkenyl,
G² is a radical from the group of hydrogen, alkyl, haloalkyl, alkenyl, alkynyl, alkoxyalkyl, alkyl-S-alkyl, alkyl-S(O)-alkyl, alkyl-S(O)₂-alkyl, cycloalkyl, halocycloalkyl, cycloalkenyl, halocycloalkenyl, cycloalkylalkyl, cycloalkenylalkyl, halocycloalkenylalkyl and in each case optionally substituted aryl, arylalkyl, pyridyl and pyridylalkyl,
And/or a compound of formula (I) in which
A is the radical (A-a) 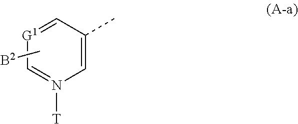
in which the broken line denotes the bond to the carbon atom of the bicyclic system of the formula (I) and
G¹ is N or C—B¹,
B¹ is a radical from the group of hydrogen, halogen, cyano, nitro, alkyl, haloalkyl, alkoxy, haloalkoxy and in each case optionally substituted cycloalkyl and cycloalkenyl,
B² is a radical from the group of hydrogen, halogen, cyano, nitro, alkyl, haloalkyl, alkoxy, haloalkoxy and in each case optionally substituted cycloalkyl and cycloalkenyl,
T is oxygen or an electron pair,
X₁ is nitrogen or CH,
X₂ is nitrogen or CH,
X₃ is nitrogen or CH, where either none or only one of the variables X₁, X₂ and X₃ is nitrogen,
R₁ is one of the following B radicals: 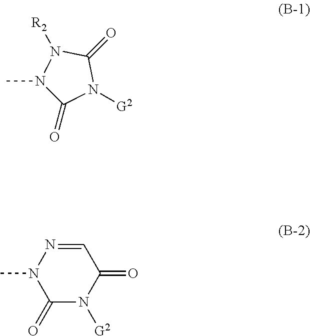
in which the broken line denotes the bond to the carbon atom of the bicyclic system of the formula (I) in which
R₂ is a radical from the group of hydrogen, alkyl, haloalkyl, alkenyl, alkynyl, alkoxyalkyl, alkyl-S-alkyl, alkyl-S(O)-alkyl, alkyl-S(O)₂-alkyl, cycloalkyl, halocycloalkyl and cycloalkenyl,
G² is a radical from the group of hydrogen, alkyl, haloalkyl, alkenyl, alkynyl, alkoxyalkyl, alkyl-S-alkyl, alkyl-S(O)-alkyl, alkyl-S(O)₂-alkyl, cycloalkyl, halocycloalkyl, cycloalkenyl, halocycloalkenyl, cycloalkylalkyl, cycloalkenylalkyl, halocycloalkenylalkyl and in each case optionally substituted aryl, arylalkyl, pyridyl and pyridylalkyl.

2. Compound of formula (I) according to claim 1 in which
A is one of the following A radicals: 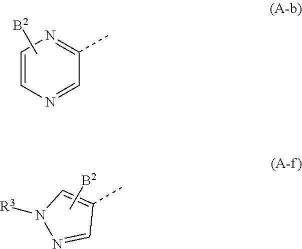
in which the broken line denotes the bond to the carbon atom of the bicyclic system of the formula (I), and
B² is a radical from the group of hydrogen, halogen, C₁-C₆-alkyl and C₁-C₄-haloalkyl,
X₁ is CH,
X₂ is CH,
X₃ is CH,
R₁ is one of the following B radicals: 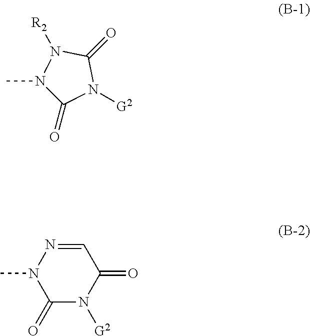
in which the broken line denotes the bond to the carbon atom of the bicyclic system of the formula (I) in which
R₂ is hydrogen or C₁-C₆-alkyl,
G² is a radical from the group of hydrogen, C₁-C₆-alkyl, halo-C₁-C₆-alkyl, C₃-C₆-cycloalkyl, halo-C₃-C₆-cycloalkyl, C₃-C₆-cycloalkenyl, halo-C₃-C₆-cycloalkenyl, phenyl or benzyl (where phenyl and benzyl themselves may in turn be substituted by halogen, cyano, nitro, C₁-C₆-alkyl, halo-C₁-C₆-alkyl and C₃-C₆-cycloalkyl), pyridyl or pyridylmethyl (where pyridyl and pyridylmethyl themselves may in turn be substituted by halogen, cyano, nitro, C₁-C₆-alkyl, halo-C₁-C₆-alkyl and C₃-C₆-cycloalkyl), and/or a
compound of formula (I) in which
A is the following A radical: 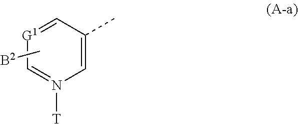
in which the broken line denotes the bond to the carbon atom of the bicyclic system of the formula (I), and
G¹ is N or C—B¹,
B¹ is a radical from the group of hydrogen, halogen, C₁-C₆-alkyl and C₁-C₄-haloalkyl,
B² is a radical from the group of hydrogen, halogen, C₁-C₆-alkyl and C₁-C₄-haloalkyl,
T is oxygen or an electron pair,
X₁ is CH,
X₂ is CH,
X₃ is CH,
R₁ is one of the following B radicals: 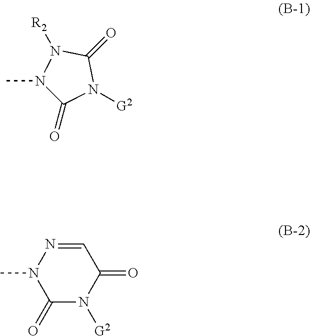
where the broken line denotes the bond to the carbon atom of the bicyclic system of the formula (I), where
R₂ is hydrogen or C₁-C₆-alkyl,
G² is a radical from the group of hydrogen, C₁-C₆-alkyl, halo-C₁-C₆-alkyl, C₃-C₆-cycloalkyl, halo-C₃-C₆-cycloalkyl, C₃-C₆-cycloalkenyl, halo-C₃-C₆-cycloalkenyl, phenyl or benzyl (which themselves may in turn be substituted by halogen, cyano, nitro, C₁-C₆-alkyl, halo-C₁-C₆-alkyl and C₃-C₆-cycloalkyl), pyridyl or pyridylmethyl (which themselves may in turn be substituted by halogen, cyano, nitro, C₁-C₆-alkyl, halo-C₁-C₆-alkyl and C₃-C₆-cycloalkyl).

3. Compound of formula (I) according to claim 2 in which
A is an A radical from the group of (A-b) and (A-f) 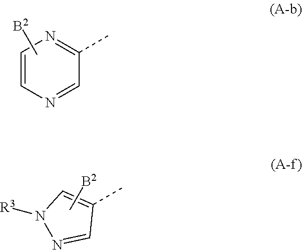
in which the broken line denotes the bond to the carbon atom of the bicyclic system of the formula (I),
B² is a radical from the group of hydrogen, halogen, C₁-C₆-alkyl and C₁-C₄-haloalkyl,
X₁ is CH,
X₂ is CH,
X₃ is CH,
R₁ is a B radical from the group of 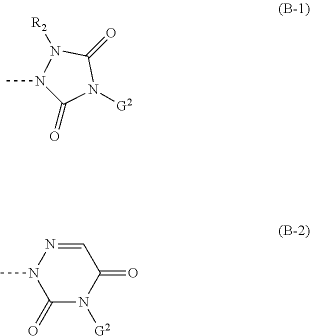
in which the broken line denotes the bond to the carbon atom of the bicyclic system of the formula (I) in which
R₂ is hydrogen or C₁-C₆-alkyl,
G² is a radical from the group of hydrogen, C₁-C₆-alkyl, halo-C₁-C₆-alkyl, C₃-C₆-cycloalkyl, halo-C₃-C₆-cycloalkyl, C₃-C₆-cycloalkenyl and halo-C₃-C₆-cycloalkenyl, and/or a
Compound of formula (I) in which
A is the A radical 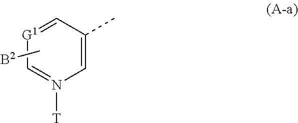
in which the broken line denotes the bond to the carbon atom of the bicyclic system of the formula (I),
G¹ is N or C—B¹,
B¹ is a radical from the group of hydrogen, halogen, C₁-C₆-alkyl and C₁-C₄-haloalkyl,
B² is a radical from the group of hydrogen, halogen, C₁-C₆-alkyl and C₁-C₄-haloalkyl,
T is oxygen or an electron pair,
X₁ is CH,
X₂ is CH,
X₃ is CH,
R₁ is a B radical from the group of 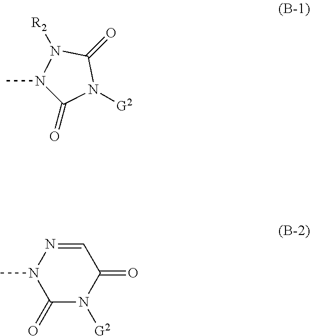
where the broken line denotes the bond to the carbon atom of the bicyclic system of the formula (I), where
R₂ is hydrogen or C₁-C₆-alkyl,
G² is a radical from the group of hydrogen, C₁-C₆-alkyl, halo-C₁-C₆-alkyl, C₃-C₆-cycloalkyl, halo-C₃-C₆-cycloalkyl, C₃-C₆-cycloalkenyl and halo-C₃-C₆-cycloalkenyl.

4. Compound of formula (I) according to claim 1 in which
A is one of the following A radicals: 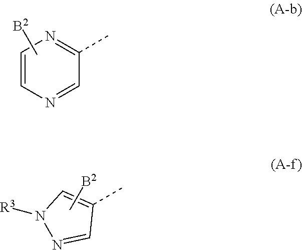
in which the broken line denotes the bond to the carbon atom of the bicyclic system of the formula (I),
B² is hydrogen,
X₁ is CH,
X₂ is CH,
X₃ is CH,
R₁ is a B radical from the group of 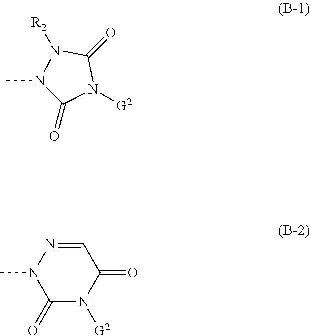
in which the broken line denotes the bond to the carbon atom of the bicyclic system of the formula (I) in which
R₂ is hydrogen or C₁-C₆-alkyl,
G² is a radical from the group of hydrogen, C₁-C₆-alkyl, halo-C₁-C₆-alkyl and C₃-C₆-cycloalkyl, and
compound of formula (I) in which
A is the A radical 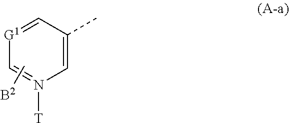
in which the broken line denotes the bond to the carbon atom of the bicyclic system of the formula (I),
G¹ is N or C—B¹,
B¹ is a radical from the group of hydrogen and fluorine,
B² is hydrogen,
T is oxygen or an electron pair,
X₁ is CH,
X₂ is CH,
X₃ is CH,
R₁ is a B radical from the group of 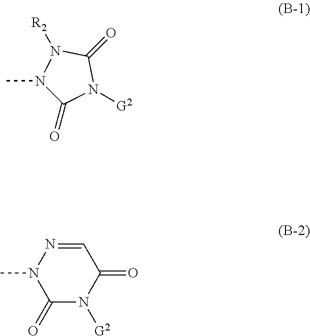
where the broken line denotes the bond to the carbon atom of the bicyclic system of the formula (I), where
R₂ is hydrogen or C₁-C₆-alkyl,
G² is a radical from the group of hydrogen, C₁-C₆-alkyl, halo-C₁-C₆-alkyl and C₃-C₆-cycloalkyl.

5. Compound of formula (I) according to claim 1 in which
A is 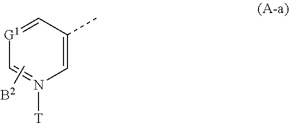
in which the broken line denotes the bond to the carbon atom of the bicyclic system of the formula (I),
G¹ is C—B¹,
B¹ is hydrogen or fluorine,
B² is hydrogen,
T is an electron pair,
X₁ is CH,
X₂ is CH,
X₃ is CH,
R₁ is the (B-1) radical 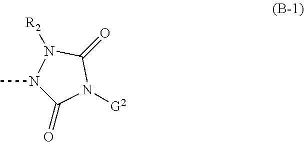
in which the broken line denotes the bond to the carbon atom of the bicyclic system of the formula (I) in which
R₂ is hydrogen or C₁-C₆-alkyl and
G² is a radical from the group of hydrogen, C₁-C₆-alkyl, halo-C₁-C₆-alkyl and C₃-C₆-cycloalkyl.

6. Compound of formula (I) according to claim 1 in which
A is the A radical 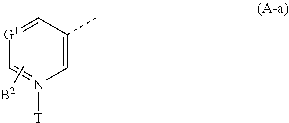
in which the broken line denotes the bond to the carbon atom of the bicyclic system of the formula (I),
G¹ is N or C—B¹,
B¹ is hydrogen or fluorine,
B² is hydrogen,
T is an electron pair,
X₁ is CH,
X₂ is CH,
X₃ is CH,
R₁ is the (B-2) radical 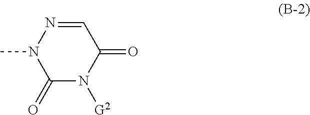
where the broken line denotes the bond to the carbon atom of the bicyclic system of the formula (I), where
G² is a radical from the group of hydrogen, C₁-C₆-alkyl, halo-C₁-C₆-alkyl and C₃-C₆-cycloalkyl.

7. Compound of formula (I) according to claim 1 in which
A is one of the following A radicals: 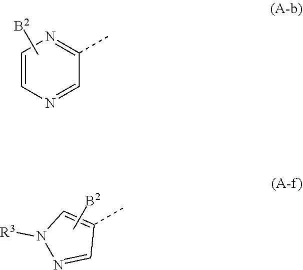
in which the broken line denotes the bond to the carbon atom of the bicyclic system of the formula (I), and
B² is a radical from the group of hydrogen, halogen, C₁-C₆-alkyl and C₁-C₄-haloalkyl,
X₁ is CH,
X₂ is CH,
X₃ is CH,
R₁ is one of the following B radicals: 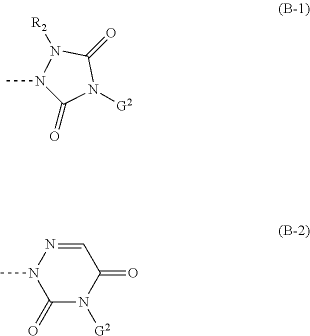
where the broken line denotes the bond to the carbon atom of the bicyclic system of the formula (I), where
R₂ is hydrogen or C₁-C₆-alkyl,
G² is a radical from the group of hydrogen, C₁-C₆-alkyl, halo-C₁-C₆-alkyl, C₃-C₆-cycloalkyl, halo-C₃-C₆-cycloalkyl, C₃-C₆-cycloalkenyl, halo-C₃-C₆-cycloalkenyl, phenyl or benzyl (where phenyl and benzyl themselves may in turn be substituted by halogen, cyano, nitro, C₁-C₆-alkyl, halo-C₁-C₆-alkyl and C₃-C₆-cycloalkyl), pyridyl or pyridylmethyl (where pyridyl and pyridylmethyl themselves may in turn be substituted by halogen, cyano, nitro, C₁-C₆-alkyl, halo-C₁-C₆-alkyl and C₃-C₆-cycloalkyl), and/or a
compound of formula (I) in which
A is the following A radical: 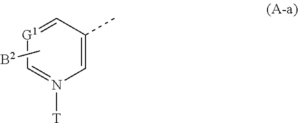
in which the broken line denotes the bond to the carbon atom of the bicyclic system of the formula (I), and
G¹ is N or C—B¹,
B¹ is a radical from the group of hydrogen, halogen, C₁-C₆-alkyl and C₁-C₄-haloalkyl,
B² is a radical from the group of hydrogen, halogen, C₁-C₆-alkyl and C₁-C₄-haloalkyl,
T is oxygen or an electron pair,
X₁ is Nor CH,
X₂ is CH,
X₃ is CH,
R₁ is one of the following B radicals: 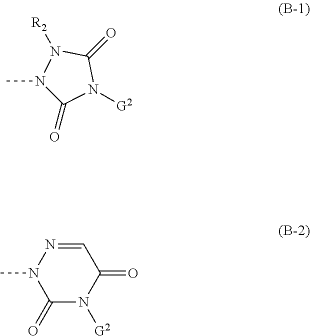
where the broken line denotes the bond to the carbon atom of the bicyclic system of the formula (I), where
R₂ is hydrogen, C₁-C₆-alkyl or halo-C₁-C₆-alkyl, and
G² is a radical from the group of hydrogen, C₁-C₆-alkyl, halo-C₁-C₆-alkyl, C₁-C₆-alkoxy-C₁-C₆-alkyl, C₁-C₆-alkyl-S—C₁-C₆-alkyl, C₁-C₆-alkyl-S(O)—C₁-C₆-alkyl, C₁-C₆-alkyl-S(O₂)—C₁-C₆-alkyl, C₃-C₆-cycloalkyl, C₃-C₆-cycloalkyl-C₁-C₆-alkyl, halo-C₃-C₆-cycloalkyl, C₃-C₆-cycloalkenyl, halo-C₃-C₆-cycloalkenyl, phenyl or benzyl (where phenyl and benzyl themselves may in turn be substituted by halogen, cyano, nitro, C₁-C₆-alkyl, halo-C₁-C₆-alkyl and C₃-C₆-cycloalkyl), pyridyl or pyridylmethyl (where pyridyl and pyridylmethyl themselves may in turn be substituted by halogen, cyano, nitro, C₁-C₆-alkyl, halo-C₁-C₆-alkyl and C₃-C₆-cycloalkyl).

8. Compound of formula (I) according to claim 1 in which
A is an A radical from the group of (A-b) and (A-f) 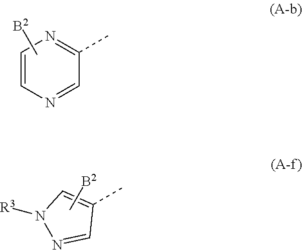
in which the broken line denotes the bond to the carbon atom of the bicyclic system of the formula (I),
B² is a radical from the group of hydrogen, halogen, C₁-C₆-alkyl and C₁-C₄-haloalkyl,
X₁ is CH,
X₂ is CH,
X₃ is CH,
R₁ is a B radical from the group of 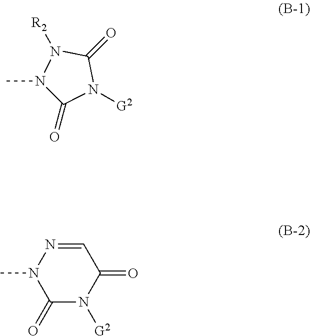
where the broken line denotes the bond to the carbon atom of the bicyclic system of the formula (I), where
R₂ is hydrogen or C₁-C₆-alkyl,
G² is a radical from the group of hydrogen, C₁-C₆-alkyl, halo-C₁-C₆-alkyl, C₃-C₆-cycloalkyl, halo-C₃-C₆-cycloalkyl, C₃-C₆-cycloalkenyl and halo-C₃-C₆-cycloalkenyl, and/or a
compound of formula (I) in which
A is the A radical 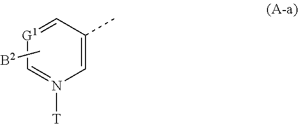
in which the broken line denotes the bond to the carbon atom of the bicyclic system of the formula (I),
G¹ is N or C—B¹,
B¹ is a radical from the group of hydrogen, halogen, C₁-C₆-alkyl and C₁-C₄-haloalkyl,
B² is a radical from the group of hydrogen, halogen, C₁-C₆-alkyl and C₁-C₄-haloalkyl,
T is oxygen or an electron pair,
X₁ is Nor CH,
X₂ is CH,
X₃ is CH,
R₁ is a B radical from the group of 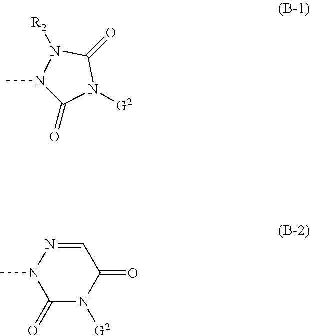
where the broken line denotes the bond to the carbon atom of the bicyclic system of the formula (I), where
R₂ is hydrogen, C₁-C₆-alkyl or halo-C₁-C₆-alkyl,
G² is a radical from the group of hydrogen, C₁-C₆-alkyl, halo-C₁-C₆-alkyl, C₁-C₆-alkoxy-C₁-C₆-alkyl, C₁-C₆-alkyl-S—C₁-C₆-alkyl, C₁-C₆-alkyl-S(O)—C₁-C₆-alkyl, C₁-C₆-alkyl-S(O₂)—C₁-C₆-alkyl, C₃-C₆-cycloalkyl, C₃-C₆-cycloalkyl-C₁-C₆-alkyl, phenyl or benzyl (where phenyl and benzyl themselves may in turn be substituted by halogen, cyano, nitro, C₁-C₆-alkyl, halo-C₁-C₆-alkyl and C₃-C₆-cycloalkyl), pyridylmethyl which may be substituted by halogen, and halo-C₃-C₆-cycloalkyl, C₃-C₆-cycloalkenyl and halo-C₃-C₆-cycloalkenyl.

9. Compound of formula (I) according to claim 1 in which
A is one of the following A radicals: 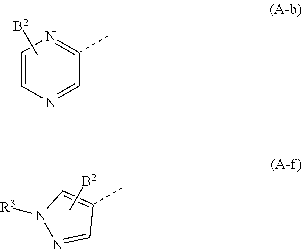
in which the broken line denotes the bond to the carbon atom of the bicyclic system of the formula (I),
B² is hydrogen,
X₁ is CH,
X₂ is CH,
X₃ is CH,
R₁ is a B radical from the group of 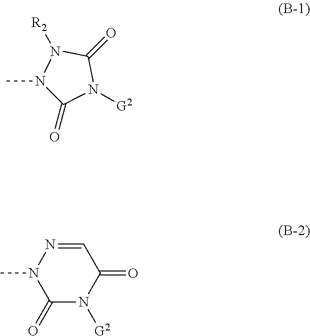
where the broken line denotes the bond to the carbon atom of the bicyclic system of the formula (I), where
R₂ is hydrogen or C₁-C₆-alkyl,
G² is a radical from the group of hydrogen, C₁-C₆-alkyl, halo-C₁-C₆-alkyl and C₃-C₆-cycloalkyl, and/or a
Compound of formula (I) in which
A is the A radical 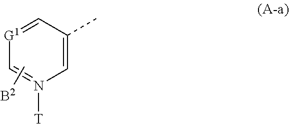
in which the broken line denotes the bond to the carbon atom of the bicyclic system of the formula (I),
G¹ is N or C—B¹,
B¹ is a radical from the group of hydrogen and fluorine,
B² is hydrogen,
T is oxygen or an electron pair,
X₁ is N or CH,
X₂ is CH,
X₃ is CH,
R₁ is a B radical from the group of 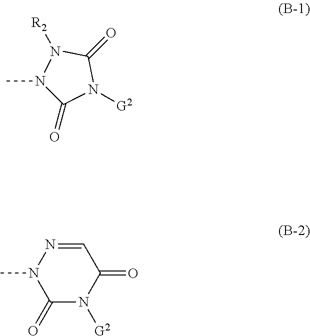
where the broken line denotes the bond to the carbon atom of the bicyclic system of the formula (I), where
R₂ is hydrogen, C₁-C₆-alkyl or halo-C₁-C₆-alkyl,
G² is a radical from the group of C₁-C₄-alkyl, halo-C₁-C₄-alkyl, C₁-C₄-alkoxy-C₁-C₄-alkyl, C₁-C₄-alkyl-S—C₁-C₄-alkyl, C₁-C₄-alkyl-S(O)—C₁-C₄-alkyl, C₁-C₄-alkyl-S(O₂)—C₁-C₄-alkyl, C₃-C₆-cycloalkyl, C₃-C₆-cycloalkyl-C₁-C₄-alkyl, phenyl or benzyl (where phenyl and benzyl themselves may in turn be substituted by halogen and cyano), pyridylmethyl which may be substituted by halogen.

10. Compound of formula (I) according to claim 1 in which
A is 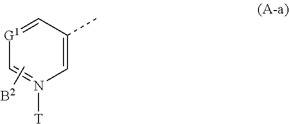
in which the broken line denotes the bond to the carbon atom of the bicyclic system of the formula (I),
G¹ is C—B¹,
B¹ is hydrogen,
B² is hydrogen,
T is an electron pair,
X₁ is Nor CH,
X₂ is CH,
X₃ is CH,
R₁ is the (B-1) radical 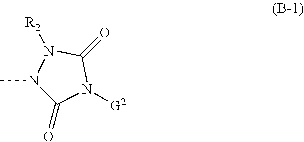
where the broken line denotes the bond to the carbon atom of the bicyclic system of the formula (I), where
R₂ is hydrogen, C₁-C₄-alkyl or halo-C₁-C₄-alkyl and
G² is a radical from the group of C₁-C₄-alkyl, halo-C₁-C₄-alkyl, C₁-C₄-alkoxy-C₁-C₄-alkyl, C₁-C₄-alkyl-S—C₁-C₄-alkyl, C₁-C₄-alkyl-S(O)—C₁-C₄-alkyl, C₃-C₆-cycloalkyl, C₃-C₆-cycloalkyl-C₁-C₄-alkyl, phenyl, benzyl and pyridylmethyl, where phenyl, benzyl and pyridylmethyl themselves may in turn be substituted by halogen.

11. Compound of formula (I) according to claim 1 in which
A is the A radical 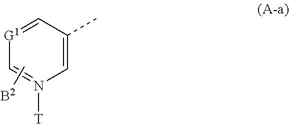
in which the broken line denotes the bond to the carbon atom of the bicyclic system of the formula (I),
G¹ is C—B¹,
B¹ is hydrogen,
B² is hydrogen,
T is an electron pair,
X₁ is Nor CH,
X₂ is CH,
X₃ is CH,
R₁ is the (B-2) radical 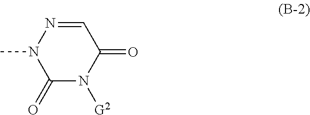
where the broken line denotes the bond to the carbon atom of the bicyclic system of the formula (I), where
G² is a radical from the group of C₁-C₄-alkyl, halo-C₁-C₄-alkyl, C₃-C₆-cycloalkyl-C₁-C₄-alkyl, phenyl or benzyl (where phenyl and benzyl themselves may in turn be substituted by halogen).

12. Compound according to claim 1, comprising the compound of formula

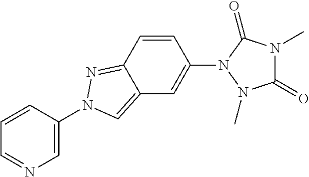 [SMILES: Cn1c(=O)n(C)n(-c2ccc3nn(-c4cccnc4)cc3c2)c1=O]

13. Compound according to claim 1, comprising the compound of formula

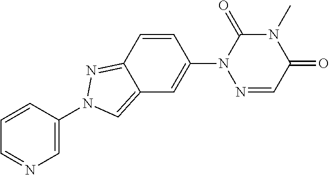 [SMILES: Cn1c(=O)cnn(-c2ccc3nn(-c4cccnc4)cc3c2)c1=O]

14. Composition, comprising a content of at least one compound of formula (I) according to claim 1 and one or more customary extenders and/or surfactants.

15. A compound of formula (I) according to claim 1 and/or composition thereof for controlling pests.
